(19) United States
(12) Patent Application Publication
(10) Pub. No.: US 2017/0142589 A1
(43) Pub. Date: May 18, 2017

(54) METHOD FOR ADJUSTING USAGE POLICY AND ELECTRONIC DEVICE FOR SUPPORTING THE SAME

(71) Applicant: Samsung Electronics Co., Ltd, Gyeonggi-do (KR)

(72) Inventors: Ji Yoon Park, Gyeonggi-do (KR); Jung Eun Lee, Gyeonggi-do (KR); Sae Mee Yim, Gyeonggi-do (KR); Cheol Ho Cheong, Seoul (KR)

(21) Appl. No.: 15/356,499

(22) Filed: Nov. 18, 2016

(30) Foreign Application Priority Data
Nov. 18, 2015 (KR) 10-2015-0162161
Aug. 29, 2016 (KR) 10-2016-0110321

(51) Int. Cl. H04W 12/08; H04W 8/18; H04W 4/00

(52) U.S. Cl. CPC H04W 12/08; H04W 4/001; H04W 8/18

(57) ABSTRACT

An electronic device is provided. The electronic device includes a memory configured to store a usage policy associated with the electronic device or a first user related to the electronic device with respect to at least one of resources of the electronic device, a communication circuit configured to communicate with an external electronic device and a processor implemented with a processor, wherein the module is configured to receive user information about a second user corresponding to the external electronic device from the external electronic device using the communication circuit, change at least part of the usage policy based on at least part of the receiving of the user information and adjust a use level of the electronic device or the first user with respect to the at least one resource based on the at least changed part of the usage policy.

### CROSS-REFERENCE TO RELATED APPLICATION(S) AND CLAIM OF PRIORITY

The present application is related to and claims the benefit under 35 U.S.C. §119(a) of a Korean patent application filed on Nov. 18, 2015 in the Korean Intellectual Property Office and assigned Serial number 10-2015-0162161, and a Korean patent application filed on Aug. 29, 2016 in the Korean Intellectual Property Office and assigned Serial number 10-2016-0110321, the entire disclosure of which is hereby incorporated by reference.

### TECHNICAL FIELD

The present disclosure relates to adjusting a usage policy of an electronic device.

### BACKGROUND

Recently, an electronic device may provide a variety of user functions and may store user data and the like associated with the user functions. The electronic device may control the electronic device's function based on detected ambient environments.

Further, as a user has various tastes, the growing trend is for one user to use a plurality of electronic devices.

The conventional electronic device may provide a function of allowing a user authenticated through user authentication to unlock and operate the electronic device. In this process, if an authentication level is raised, the electronic device may make the electronic device's security higher. However, an authentication process (or an unlock process) is complicated, thus resulting in an inconvenience to the user. If an authentication level is lowered, the electronic device may easily obtain authentication, thus making security lower.

Further, if one user users a plurality of electronic devices, since he or she should repeat authentication operations whenever he or she uses each electronic device, he or she should repeat a complicated operation.

### SUMMARY

To address the above-discussed deficiencies, it is a primary object to provide a method for adjusting a usage policy to provide a stable security function through an adaptive change in usage policy based on situations and minimize inconvenience of a user and the electronic device for supporting the same.

In accordance with an aspect of the present disclosure, an electronic device is provided. The electronic device may include a memory configured to store a usage policy associated with the electronic device or a first user related to the electronic device with respect to at least one of resources of the electronic device, a communication circuit configured to communicate with an external electronic device and a resource management module implemented with a processor (or a resource management processor), wherein the resource management module is configured to: receive user information about a second user corresponding to the external electronic device from the external electronic device using the communication circuit, change at least part of the usage policy based on at least part of the receiving of the user information and adjust a use level of the electronic device or the first user with respect to the at least one resource, based on the at least changed part of the usage policy.

In accordance with another aspect of the present disclosure, an electronic device is provided. The electronic device may include at least one sensor, a communication circuit and a resource management module implemented with a processor, wherein the resource management module is configured to: obtain context information corresponding to a user corresponding to the electronic device using the at least one sensor and determine a usage right associated with the electronic device or the user with respect to at least one of resources of an external electronic device, based on at least part of the context information.

Other aspects and salient features of the disclosure will become apparent to those skilled in the art from the following detailed description, which, taken in conjunction with the annexed drawings, discloses various embodiments of the present disclosure.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1A is a drawing illustrating an example of a usage policy adjustment environment according to an embodiment;

FIG. 1B is a drawing illustrating another example of a usage policy adjustment environment according to an embodiment;

FIG. 2A is a block diagram illustrating an example of a first electronic device according to an embodiment;

FIG. 2B is a block diagram illustrating an example of a second electronic device according to an embodiment;

FIG. 3 is a flowchart illustrating a method for adjusting a usage policy according to an embodiment;

FIG. 4 is a flowchart illustrating a method for adjusting an authentication policy of an electronic device according to an embodiment;

FIG. 5 is a drawing illustrating an example of a screen interface associated with adjusting an authentication level according to an embodiment;

FIG. 6 is a flowchart illustrating a method for obtaining a usage right of a second electronic device according to an embodiment;

FIG. 7 is a drawing illustrating an example of a screen interface associated with obtaining a usage right of a second electronic device according to an embodiment;

FIG. 8 is a flowchart illustrating a method for adjusting a content policy of an electronic device according to an embodiment;

FIG. 9A is a drawing illustrating an example of a screen interface associated with adjusting an authentication level according to an embodiment;

FIG. 9B is a drawing illustrating an example of a screen interface associated with a second authentication policy according to an embodiment;

FIG. 10 is a flowchart illustrating a method for adjusting a usage policy based on biometric persistent information according to an embodiment;

FIG. 11 is a drawing illustrating an example of a screen interface associated with adjusting an authentication level according to an embodiment;

FIG. 12 is a flowchart illustrating a method for changing a time-based usage policy application condition according to an embodiment;

FIG. 13 is a flowchart illustrating a method for operating a usage policy based on a device type according to an embodiment;

FIG. 14 is a drawing illustrating an example of a system for operating a usage policy for each external electronic device according to an embodiment;

FIG. 15 is a flowchart illustrating an example of a method for performing an authentication policy according to an embodiment;

FIG. 16 is a flowchart illustrating an example of a method for changing a usage policy according to an embodiment;

FIG. 17 is a flowchart illustrating an example of a method for applying a location-based usage policy according to an embodiment;

FIG. 18 is a flowchart illustrating a method for applying a usage policy associated with a content policy according to an embodiment;

FIG. 19 is a flowchart illustrating a method for applying a usage policy associated with changing an authentication level according to an embodiment; and

FIG. 20 is a drawing illustrating an example of an operation of changing a usage policy according to an embodiment.

FIG. 21 is a block diagram illustrating a configuration of an electronic device in a network environment according to an embodiment.

FIG. 22 is a block diagram illustrating a configuration of an electronic device according to various embodiments.

FIG. 23 is a block diagram illustrating a configuration of a program module according to various embodiments.

Throughout the drawings, it should be noted that like reference numbers are used to depict the same or similar elements, features, and structures.

### DETAILED DESCRIPTION

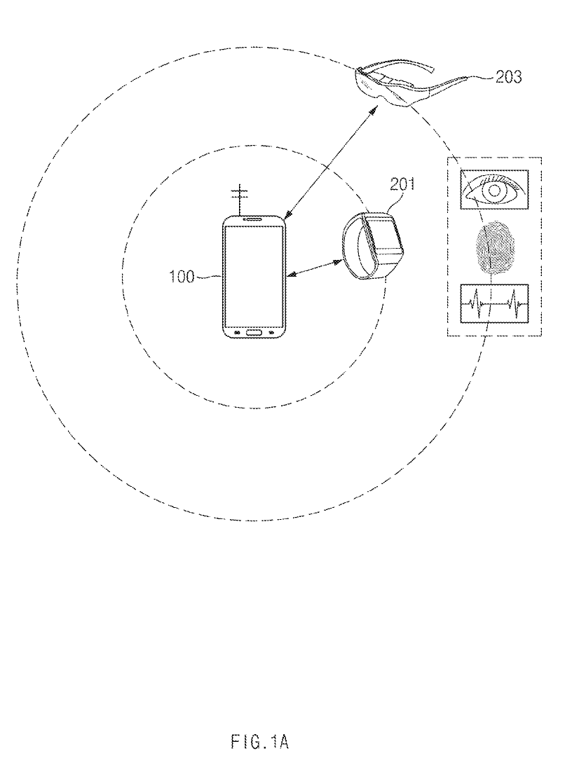

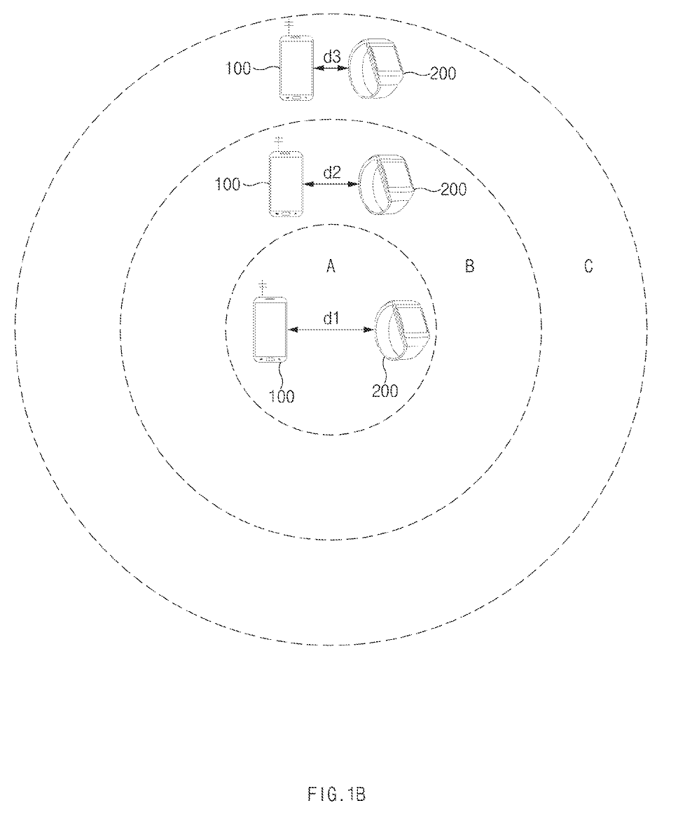

FIGS. 1A through 23, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Various embodiments of the present disclosure may be described with reference to accompanying drawings. Accordingly, those of ordinary skill in the art will recognize that modification, equivalent, and/or alternative on the various embodiments described herein can be variously made without departing from the scope and spirit of the present disclosure. With regard to description of drawings, similar elements may be marked by similar reference numerals.

In the disclosure disclosed herein, the expressions “have”, “may have”, “include” and “comprise”, or “may include” and “may comprise” used herein indicate existence of corresponding features (e.g., elements such as numeric values, functions, operations, or components) but do not exclude presence of additional features.

In the disclosure disclosed herein, the expressions “A or B”, “at least one of A or/and B”, or “one or more of A or/and B”, and the like used herein may include any and all combinations of one or more of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included.

The terms, such as “first”, “second”, and the like used herein may refer to various elements of various embodiments, but do not limit the elements. Furthermore, such terms may be used to distinguish one element from another element. For example, “a first user device” and “a second user device” may indicate different user devices regardless of the order or priority thereof. For example, “a first user device” and “a second user device” indicate different user devices.

It will be understood that when an element (e.g., a first element) is referred to as being “(operatively or communicatively) coupled with/to” or “connected to” another element (e.g., a second element), it may be directly coupled with/to or connected to the other element or an intervening element (e.g., a third element) may be present. In contrast, when an element (e.g., a first element) is referred to as being “directly coupled with/to” or “directly connected to” another element (e.g., a second element), it should be understood that there are no intervening element (e.g., a third element).

According to the situation, the expression “configured to” used herein may be used as, for example, the expression “suitable for”, “having the capacity to”, “designed to”, “adapted to”, “made to”, or “capable of”. The term “configured to” does not mean only “specifically designed to” in hardware. Instead, the expression “a device configured to” may mean that the device is “capable of” operating together with another device or other components. CPU, for example, a “processor configured to perform A, B, and C” may mean a dedicated processor (e.g., an embedded processor) for performing a corresponding operation or a generic-purpose processor (e.g., a central processing unit (CPU) or an application processor) which may perform corresponding operations by executing one or more software programs which are stored in a memory device.

Terms used in the present disclosure are used to describe specified embodiments and are not intended to limit the scope of the present disclosure. The terms of a singular form may include plural forms unless otherwise specified. Unless otherwise defined herein, all the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal detect unless expressly so defined herein in various embodiments of the present disclosure. In some cases, even if terms are terms which are defined in the specification, they may not be interpreted to exclude embodiments of the present disclosure.

An electronic device according to various embodiments of the present disclosure may include at least one of smartphones, tablet personal computers (PCs), mobile phones, video telephones, e-book readers, desktop PCs, laptop PCs, netbook computers, workstations, servers, personal digital assistants (PDAs), portable multimedia players (PMPs), Motion Picture Experts Group (MPEG-1 or MPEG-2) Audio Layer 3 (MP3) players, mobile medical devices, cameras, wearable devices (e.g., head-mounted-devices (HMDs), such as electronic glasses), an electronic apparel, electronic bracelets, electronic necklaces, electronic appcessories, electronic tattoos, smart watches, and the like.

According to another embodiment, the electronic devices may be home appliances. The home appliances may include at least one of, for example, televisions (TVs), digital versatile disc (DVD) players, audios, refrigerators, air conditioners, cleaners, ovens, microwave ovens, washing machines, air cleaners, set-top boxes, home automation control panels, security control panels, TV boxes (e.g., Samsung HomeSync™, Apple TV™, or Google TV™), game consoles (e.g., Xbox™ or PlayStation™), electronic dictionaries, electronic keys, camcorders, electronic picture frames, or the like.

According to another embodiment, the photographing apparatus may include at least one of medical devices (e.g., various portable medical measurement devices (e.g., a blood glucose monitoring device, a heartbeat measuring device, a blood pressure measuring device, a body temperature measuring device, and the like)), a magnetic resonance angiography (MRA), a magnetic resonance imaging (MRI), a computed tomography (CT), scanners, and ultrasonic devices), navigation devices, global positioning system (GPS) receivers, event data recorders (EDRs), flight data recorders (FDRs), vehicle infotainment devices, electronic equipment for vessels (e.g., navigation systems and gyrocompasses), avionics, security devices, head units for vehicles, industrial or home robots, automatic teller's machines (ATMs), points of sales (POSs), or internet of things (e.g., light bulbs, various sensors, electric or gas meters, sprinkler devices, fire alarms, thermostats, street lamps, toasters, exercise equipment, hot water tanks, heaters, boilers, and the like).

According to another embodiment, the electronic devices may include at least one of parts of furniture or buildings/structures, electronic boards, electronic signature receiving devices, projectors, or various measuring instruments (e.g., water meters, electricity meters, gas meters, or wave meters, and the like). In the various embodiments, the electronic device may be one of the above-described various devices or a combination thereof. An electronic device according to an embodiment may be a flexible device. Furthermore, an electronic device according to an embodiment may not be limited to the above-described electronic devices and may include other electronic devices and new electronic devices according to the development of technologies.

Hereinafter, an electronic device according to the various embodiments may be described with reference to the accompanying drawings. The term “user” used herein may refer to a person who uses an electronic device or may refer to a device (e.g., an artificial intelligence electronic device) that uses an electronic device.

FIG. 1A is a drawing illustrating an example of a usage policy adjustment environment according to an embodiment.

Referring to FIG. 1A, a first electronic device 100 may receive user information (e.g., biometric related information) of a user who wears a second electronic device 201 or a third electronic device 203 and may change a usage policy (e.g., an authentication policy, a content policy, and the like) based on the received user information. The user information may include, for example, a biometric signal for identifying who the user is and a biometric authentication result associated with an authentication level. The biometric related information may include a measurement time interval and information of meeting specified persistence based on measurement frequency. For example, if sequentially detecting an iris of the electronic device's user in a state where his or her pulse is detected, the first electronic device 100 may determine the detected information as continuous biometric related information of a middle and high level. Also, if detecting only a pulse of the user, the first electronic device 100 may determine the detected information as continuous biometric related information of a middle and low level.

If the biometric related information meets a first specified condition, the first electronic device 100 may change at least part of a usage policy to a first usage policy or first information. For example, the first electronic device 100 may change a type of the usage policy, a complex degree of the usage policy (the number of types of the usage policies), complexity of the usage policy, difficultly of the usage policy, and the like. The first electronic device 100 may receive a biometric signal over a security channel from the second electronic device 201 or the third electronic device 203 or may receive a biometric authentication result over a general channel from the second electronic device 201 or the third electronic device 203.

The first electronic device 100 may compare data send from the second electronic device 201 or the third electronic device 203 with authentication information previously stored in the first electronic device's 100 memory to verify (or identify, or check, or confirm, or ascertain) a relationship. For example, the first electronic device 100 may identify whether a user who wears the second electronic device 201 or the third electronic device 203 is the same person as the user of the first electronic device 100, a his or her family member, or another. The second electronic device 201 or the third electronic device 203 may send biometric information and right request data to the first electronic device 100. If receiving a permissible right request from the second electronic device 201 or the third electronic device 203, the first electronic device 100 may change the received permissible right request to a usage policy corresponding to right request data.

FIG. 1B is a drawing illustrating another example of a usage policy adjustment environment according to an embodiment.

Referring to FIG. 1B, the usage policy adjustment environment according to an embodiment may support to adjust a usage policy of at least one of a plurality of electronic devices based on a state between a plurality of electronic devices which may establish a communication channel based on a specified communication mode. According to an embodiment, the first electronic device 100 may adjust a usage policy (e.g., an authentication policy and a content policy) for the first electronic device 100 based on a distance from the second electronic device 200 or a change in a space where the electronic device 100 is located. For example, the first electronic device 100 may adjust the usage policy corresponding to at least one of a state where the second electronic device 200 is worn, persistence or variability where the second electronic device 200 is worn, a type of biometric information collected by the second electronic device 200, a mutual displace between the first electronic device 100 and the second electronic device 200, verified based on a communication channel state (e.g., a short-distance communication channel state), and a type or characteristic of a place where devices are located (e.g., a private area, a public area, a home, an office, or the like).

According to various embodiments, the first electronic device 100 may change a usage policy based on a relationship with the user (e.g., the same person, an acquaintance, or another), verified by receiving biometric persistent information from the second electronic device 200, a distance from the second electronic device 200, and a location of the second electronic device 200. For example, if user information (e.g., biometric persistent information and an authentication result) received from the second electronic device 200 corresponds to information about the same person as the user of the first electronic device 100 and if a mutual distance between the first electronic device 100 and the second electronic device 200 is close to each other, the first electronic device 100 may change an unlock method to the easiest method or may change a content access right to a high level. If the mutual distance is distant from each other, the first electronic device 100 may change the unlock method to a difficult method or may change the content access right to a low level. Also, if the user information received from the second electronic device 200 corresponds to information about another, the first electronic device 100 may change the unlock method to unlock the first electronic device 100 only when the user should enter a specified password although the mutual distance is close to each other or may limit the content access right to a specified level. If the mutual distance is distant from each other, the first electronic device 100 may change the unlock method to the most difficult method or may change the content access right to the lowest level. According to various embodiments, if the user information received from the second electronic device 200 corresponds to information about the same person as the user of the first electronic device 100 and if the first electronic device 100 is located in a private place, the first electronic device 100 may change the unlock method to the easiest method or may change the content access right to a high level. If the first electronic device 100 is located in a public place, the first electronic device 100 may change the unlock method to a difficult method or may change the content access right to a low level. Also, if the user information (e.g., biometric persistent information and an authentication result) received from the second electronic device 200 corresponds to information about another, the first electronic device 100 may change the unlock method to unlock the first electronic device 100 only when the user should enter a specified password although the first electronic device 100 is located in a private place or may limit the content access right to a specified level. If the first electronic device 100 is located in the public place, the first electronic device 100 may change the unlock method to the most difficult method or may change the content access right to the lowest level.

A state where the second electronic device 200 is worn, persistence, or variability may be determined as biometric persistent information collected in real time or at a period by the second electronic device 200 is provided to the first electronic device 100 during a time or more or is changed during the time or more. The biometric persistent information may include, for example, biometric information repeatedly obtained in real time or within a time range. Alternatively, the biometric persistent information may include information indicating a state where an electronic device is used by a specified user in a process of obtaining biometric information.

According to an embodiment, the first electronic device 100 may adjust at least one of a type of authentication, the number of authentication, complexity of authentication, or a complex degree of authentication in connection with adjusting an authentication policy. The type of the authentication may include, for example, fingerprint authentication, iris authentication, pulse authentication, password authentication, and the like. In connection with the complexity of the authentication, the first electronic device 100 may determine that an authentication scheme that may be necessary for relatively more calculation or is relatively more difficult to obtain information has higher complexity. The first electronic device 100 may determine that an authentication scheme that may be necessary for relatively less calculation or is relatively easier to obtain information has lower complexity. In connection with the complexity, the first electronic device 100 may determine that the complexity is higher when there are more types of authentication and may determine that the complexity is lower when there are fewer types of authentication.

The first electronic device 100 (or the second electronic device 200) may adjust at least one of whether to apply second authentication, a type of the second authentication, the number of the second authentication, complexity of the second authentication, or a complex degree of the second authentication in connection with adjusting a second authentication policy. The first electronic device 100 may adjust at least one of a type of executable content, the number of the executable content, a use depth (e.g., depth) in the same content, and the use of a function linked to content in connection with adjusting a content policy (or a content use grade, a content use level, and the like).

According to various embodiments, the first electronic device 100 may adjust a usage policy (e.g., at least one of an authentication policy, a second authentication policy, and a content policy) in response to a distance between the first electronic device 100 and the second electronic device 200 in an environment where biometric persistent information is provided from the second electronic device 200. Thus, the first electronic device 100 may adaptively adjust a usage policy of at least one electronic device (e.g., the first electronic device 100 or the second electronic device 200) in response to whether the user continuously operates the first electronic device 100 in the usage policy adjustment environment.

According to various embodiments, the first electronic device 100 may adjust a usage policy in response to a current location (e.g., a specified zone or a type of a zone) in an environment where biometric persistent information is provided from the second electronic device 200. For example, according to an embodiment, if the first electronic device 100 and the second electronic device 200 are located in a first space A (e.g., a private area or a home), the first electronic device 100 (or the second electronic device 200) may adjust the first electronic device's 100 usage policy to a first level (or degree or grade). For example, if the first electronic device 100 (or the second electronic device 200) is located in the first space A, the first electronic device 100 may adjust at least one of a type of authentication, the number of the authentication, complexity of the authentication, or a complex degree of the authentication to the first level in connection with adjusting an authentication policy among usage policies. According to various embodiments, if the first electronic device 100 (or the second electronic device 200) is located in the first space A the first electronic device 100 it may adjust at least one of a type of second authentication, the number of the second authentication, complexity of the second authentication, or a complex degree of the second authentication to the first level in connection with adjusting a second authentication policy among the usage policies. According to various embodiments, if the first electronic device 100 (or the second electronic device 200) is located in the first space A, the first electronic device 100 may adjust a content policy to the first level (or degree or grade) in connection with adjusting the content policy among the usage policies.

According to various embodiments, if the first electronic device 100 (or the second electronic device 200) is located in the first space A, the first electronic device 100 may adjust a threshold distance value of determining to adjust an authentication policy to a first distance d1 (e.g., a value which is longer than a second distance d2 or a third distance d3). If the second electronic device 200 is distant from the first electronic device 100 at intervals of the first distance d1 in the first space A, the first electronic device 100 may determine that there is a high possibility that another will operate the first electronic device 100, and may change an authentication policy in a complicated manner or may limit a content usage policy. Also, if the second electronic device 200 is close to the first electronic device 100 at intervals of the first distance d1 in the first space A, the first electronic device 100 may determine that there is a high possibility that the user rather than another will operate the first electronic device 100, and may change the authentication policy in a simple manner or may release the limited content usage policy. The above-mentioned first electronic device 100 may be substantially same or similar electronic device to the second electronic device 200.

In the description below, that a level of a policy is set to a low or high level may be understood as an absolute setting or a relative setting. For example, if a low setting of a usage policy is an unlock setting by a specified gesture, a high setting of the usage policy may be a setting of inputting a specified number or an unlock pattern. Also, if the low setting is based on first biometric information (e.g., pulse information) of a specified user, the high setting may be based on second biometric information (e.g., fingerprint information or iris information) of the specified user. Also, if the low setting includes one authentication scheme, the high setting may include a plurality of authentication schemes. As described above, the low setting may be a relatively simpler or easier setting than the high setting in type, number, complexity, or complex degree of authentication. If a content policy is low in level, there may be a setting with relatively easy content access (e.g., a setting with an easy authentication degree for content access). If the content policy is high in level, there may be a setting with relatively difficult content access (e.g., a setting with a difficult authentication degree for content access).

According to an embodiment, if the first electronic device 100 and the second electronic device 200 are located in a second space B (e.g., an office), the first electronic device 100 (or the second electronic device 200) may adjust a usage policy to a second level (or degree or grade) which is higher than the first level. For example, if the first electronic device 100 (or the second electronic device 200) is located in the second space B, the first electronic device 100 may adjust a level (or degree or grade) of an authentication policy, a second authentication policy, or a content policy among usage policies to the second level which is higher (or more complicated or limited) than the first level. According to various embodiments, if the first electronic device 100 (or the second electronic device 200) is located in the second space B, the first electronic device 100 may adjust a threshold distance value (e.g., a mutual distance to apply a change in policy) of determining to adjust a usage policy (e.g., to change at least one of the authentication policy, the second authentication policy, or the content policy) to the second distance d2 (e.g., a distance which is shorter than the first distance d1). The first electronic device 100 and the second electronic device 200 which are located in the second space B may change the second distance d2 which is shorter than the first distance d1 to the threshold distance of changing the usage policy and may change the usage policy whenever they are distant or close to each other by the corresponding distance d2 (e.g., apply a security policy which is higher than a previous state).

Further, if the first electronic device 100 and the second electronic device 200 are located in a third space C (e.g., a public area), the first electronic device 100 (or the second electronic device 200) may adjust the usage policy to a third level which is higher the second level. If the first electronic device 100 (or the second electronic device 200) is located in the third space C, the first electronic device 100 may adjust a level of the authentication policy, the second authentication policy, or the content policy among the usage polices to the third level which is higher (or more complicated or limited) than the second level. According to various embodiments, the first electronic device 100 (or the second electronic device 200) is located in the third space C, the first electronic device 100 may adjust a threshold distance value of determining to adjust an authentication policy to the third distance d3 (or a distance which is shorter than the second distance d2). The first electronic device 100 and the second electronic device 200 which are located in the third space C may change the third distance d3 which is shorter than the second distance d2 to the threshold distance of changing the usage policy and may change the usage policy whenever they are distant or close to each other by the corresponding distance d3 (e.g., apply an authentication policy (or a security policy) which is higher than a previous state). If an electronic device (e.g., the first electronic device 100) is operated in a location determined as being relatively stable, the electronic device may reduce a level of a usage policy in the environment of adjusting the usage policy through the above-mentioned operation. For example, the electronic device (e.g., the first electronic device 100) may apply relatively low security, a relatively easy authentication method, or second authentication method in a location determined as being relatively stable based on the environment of adjusting the usage policy and may provide relatively more content or relatively more depth movable content. Also, the electronic device (e.g., the first electronic device 100) may enhance a level of the usage level in a location determined as not being relatively stable in the environment of adjusting the usage policy.

According to various embodiments, the first electronic device 100 may change a policy change threshold distance configured to change a policy based on at least one of information indicating whether biometric persistent information received from the second electronic device 200 is provided, a type of the biometric persistent information, the number of the biometric persistent information, complexity of the biometric persistent information, or a complex degree of the biometric persistent information. For example, the first electronic device 100 may make a threshold distance configured to change the policy relatively longer, within a time with respect to a time when the biometric persistent information is provided. If a time elapses with respect to the time when the biometric persistent information is provided, the first electronic device 100 may make the threshold distance configured to change the policy relatively shorter. Further, if only pulse information is provided, the first electronic device 100 may make the policy change threshold distance relatively shorter than if fingerprint information is provided. Further, if fingerprint information is provided, the first electronic device 100 may make the policy change threshold distance relatively shorter than if iris information is provided.

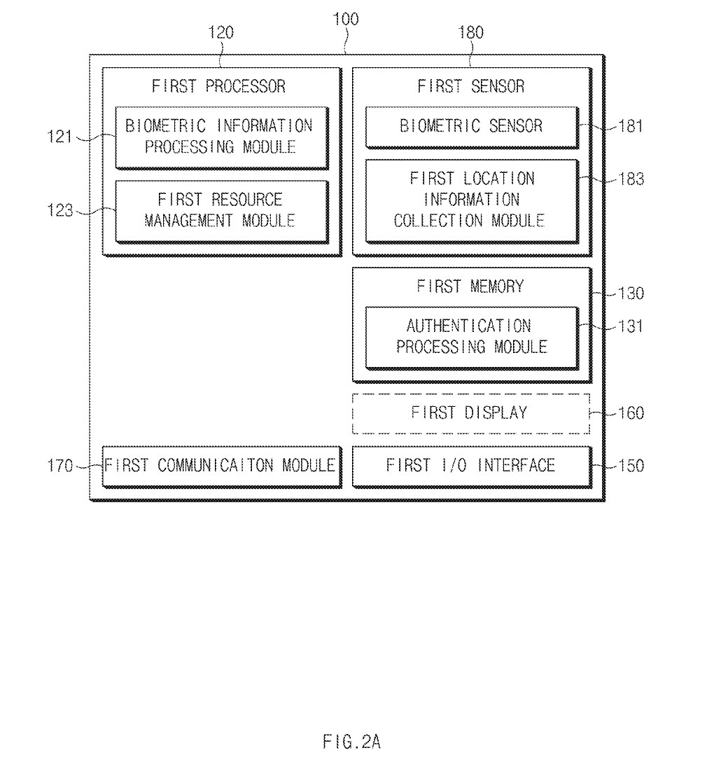

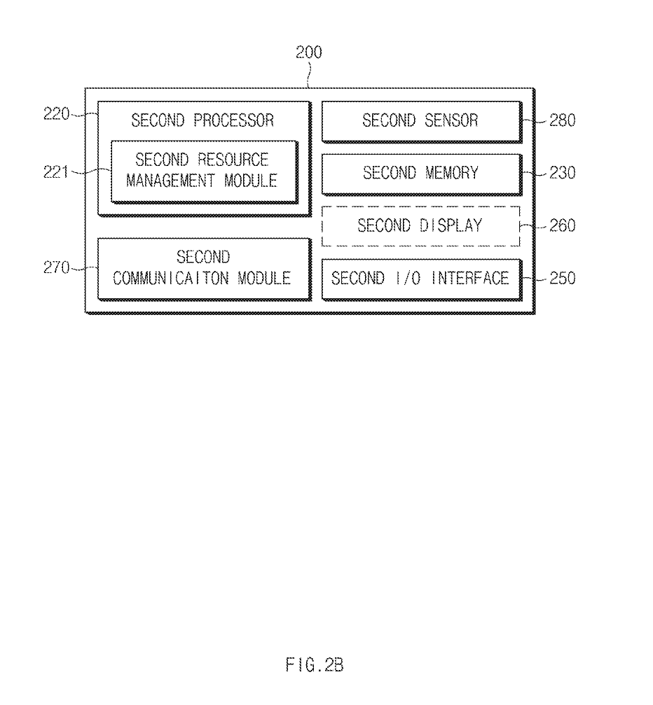

FIG. 2A is a block diagram illustrating an example of a first electronic device according to an embodiment.

Referring to FIG. 2A, a first electronic device 100 may include a first processor 120 (e.g., an application processor (AP)), a first memory 130, a first sensor 180, a first communication module (or a first communication circuit) 170, a first display 160, a first input/output (I/O) interface 150. The electronic device 100 may be implemented as, for example, a portable electronic device. The portable electronic device may be implemented as, for example, a mobile phone, a smartphone, a tablet personal computer (PC), a personal digital assistant (PDA), an enterprise digital assistant (EDA), a digital still camera, a digital video camera, a portable multimedia player (PMP), a personal navigation device or portable navigation device (PND), a handheld game console, a mobile internet device (MID), an internet tablet, or an electronic-book (e-book) terminal.

The first processor 120 may control an overall operation of the first electronic device 100. According to an embodiment, the first processor 120 may be implemented as an integrated circuit (IC), a system on chip (SoC), or a mobile AP. The first processor 120 may perform at least one of a change in usage policy of the first electronic device 100 or adjustment of a threshold distance for changing a policy, based on at least one of an operation state of the first electronic device 100 or a state with the second electronic device 200. According to an embodiment, the first processor 120 may perform at least one of the change in usage policy or the adjustment of the threshold distance for changing the policy, based on at least one of a current location of the first electronic device 100 or a distance between the first electronic device 100 and the second electronic device 200 in a state where biometric persistent information provided from the second electronic device 200 is collected.

According to various embodiments, the first processor 120 may include a biometric information processing module 121 (or a biometric information processor) and a first resource management module 123 (or a first resource management processor).

The biometric information processing module 121 may receive a biometric signal and may perform at least one of user authentication, user identification, determination whether the second electronic device 200 is worn, determination of biometric persistent information, or analysis of biometric information of the user. The biometric information processing module 121 may extract and analyze a feature for authenticating or identifying the user. For example, the biometric information processing module 121 may detect a biometric signal, a state where the second electronic device 200 is worn, biometric persistent information, a location, a proximity degree, a touch, an input, and the like. According to various embodiments, the biometric information processing module 121 may detect a face, an iris, a depth, a distance, and the like based on a first sensor (e.g., a camera, an infrared (IR) camera, a stereo camera, and a depth camera). Further the biometric information processing module 121 may analyze a fingerprint, an iris, a hand's vein, and a face image and may extract a feature, based on a first sensor (e.g., a physiological sensor, a heart rate monitor (FIRM), a blood pressure gauge, an electrocardiogram (ECG) sensor, a photoplethysmography (PPG) sensor, a ballistocardiogram (BCG) sensor, a galvanic skin response (GSR) sensor, a human temperature sensor, a gas sensor, an electromyography (EMG) sensor, an electroencephalogram (EEG) sensor, a heartbeat sensor, an oxygen saturation (SpO2) sensor, a blood pressure sensor, a body fat sensor, or a blood glucose sensor).

In connection with determining whether the second electronic device 200 is worn or determining continuity where the second electronic device 200 is worn, the biometric information processing module 121 may detect an adhesion state (e.g., capacitance and impedance) by a touch screen panel (TSP), an electrode contact, and the like. Alternatively, if the first electronic device 100 is a wearable device, the biometric information processing module 121 may detect a state where a strap is bound (e.g., a switch, a magnetic force, and the like). The biometric information processing module 121 may determine whether the second electronic device 200 is worn based on a level of a direct current (DC) component among optical signals received based on a proximity degree using an optical sensor or a PPG sensor.

In connection with determining the biometric persistent information, the biometric information processing module 121 may detect a human body by analyzing a waveform received over a biometric sensor. For example, the biometric information processing module 121 may detect whether there is an alternating current (AC) component and a pattern among optical signals received using a PPG sensor to detect that the AC component and the pattern are measured from a human body. Alternatively, the biometric information processing module 121 may detect ballistocardiogram (BCG) via an acceleration sensor, may determine motion of a pupil in iris recognition, may detect a human body by GSR and complex sensing in fingerprint recognition, and may detect motion of a human body by a motion sensor.

In connection with analyzing biometric information, the biometric information processing module 121 may analyze physiological information of the user (e.g., a blood pressure, a heartbeat, stress, emotion, exercise intensity, a caloric amount consumed by an exercise, a body temperature, BCG, oxygen saturation (SpO2), vascular elasticity, heart rate variability (HRV), disease, and the like). Also, the biometric information processing module 121 may obtain information at least one of an exercise type, a movement distance, a movement direction, a change in height, and the like based on motion. The biometric information processing module 121 may provide information indicating whether biometric persistent information is collected, a type of the biometric persistent information, and a characteristic of the biometric persistent information (e.g., a value indicating whether the biometric persistent information is biometric information of a specified person) to the first resource management module 123. The biometric information processing module 121 may compare the extracted and analyzed characteristic with a characteristic previously stored in a database to authenticate or identify the user. Also, the biometric information processing module 121 may compare a plurality of biometric information to authenticate the user.

The first resource management module 123 may process an authentication policy and determine to apply an additional policy, based on at least one of biometric persistent information received a second electronic device 200 of FIG. 1B, a location of the second electronic device 200, or a distance between the first electronic device 100 and the second electronic device 200 through an operation of the at least one first communication module 170.

According to an embodiment, the first resource management module 123 may collect location information of the first electronic device 100 using a first location information collection module 183. For example, the first location information collection module 183 may measure a location using one or more of a global positioning system (GPS), an indoor location recognizer, a wireless-fidelity (Wi-Fi) based positioning system (WPS), a Wi-Fi fingerprint, an AP signal receiver, a feature extraction and DB feature mapping technique based on image analysis, near field communication (NFC), a radio frequency identification (RFID) positioning technology, a positioning technology by a marker, or long term evolution (LTE) positioning protocol extension 2.0 (LPPe2.0). A positioning technique using the LPPe2.0 may include, for example, a radio characteristic information method, an image recognition based method (IRB), pedestrian dead reckoning (PDR), a method by a user equipment (UE)-assisted motion sub-state, a method by map based attributes, a method by crowd sourcing support for location and measurement information of the UE itself, a method by indoor/outdoor transit area information, a method by radio map data, a method by UE-based IRB positioning, or a method by providing improved wireless local area network (WLAN) positioning information. In a technique using the NFC/RFID, for example, NFC readers or sensors may be installed at an interval in a room or indoor locations (e.g., a door location, a corner location of each room, a lamp location, the center of a wall, a bottom or ceiling, and the like), and a location of a camera device may be determined by reading an NFC signal of each of the NFC readers installed in the room via the camera device or reading an NFC signal of the camera device using the indoor NFC readers. Accuracy may be more improved based on an arrangement interval between NFC devices. A coordinate of the camera device may be predicted by determining a movement distance and direction after the NFC signal is detected. The first resource management module 123 may capture an object including a marker or may determine location information using a device of capturing the object including the marker. In this regard, the first resource management module 123 may ascertain a location of a specific marker by decoding the corresponding marker input through an obtained image and may ascertain a relative location between the corresponding marker and the camera device. The marker may include at least one of a bar code, a two-dimensional (2D) code (e.g., a quick response (QR) code, PDF-417, DataMatrix, and ColorCode™), or a watermark. The first resource management module 123 may decode data read from the marker to ascertain a coordinate, direction information, and the like and may predict location information of the camera device through pose or direction information of a camera which captures the marker, size information, and a marker location on an image because the marker varies in shape based on a direction captured by the camera. The first resource management module 123 may determine a more accurate location using depth information of a captured image. The first resource management module 123 may obtain (or verify) a current location (or a zone to which the current location belongs) of the first electronic device 100. The first resource management module 123 may adjust an authentication policy or a threshold distance for changing a policy based on information indicating whether biometric persistent information is provided and a current location.

According to various embodiments, the first resource management module 123 may determine a distance between the first electronic device 100 and the second electronic device 200 based on radio signal received strength of the at least one first communication module 170 (or communication circuit) or communicable transmission distance information by each communication mode. For example, the first resource management module 123 may operate an optical sensor, a wireless signal sensor (or a network module), an NFC sensor, and the like to determine a degree of proximity and a distance. Also, the first resource management module 123 may perform received signal strength (RSS)-based distance estimation. If operating a Bluetooth communication mode, the first resource management module 123 may analyze a difference between a transmit (TX) power value of a TX end and received signal strength indication (RSSI) from a received signal to estimate a relative distance. The first resource management module 123 may determine a distance between the first electronic device 100 and the second electronic device 200 as a short distance when signal quality is better based on a signal-to-noise ratio (SNR). According to various embodiments, if motion signals of the first electronic device 100 and the second electronic device 200 are similar to each other, the first resource management module 123 may determine the distance between the first electronic device 100 and the second electronic device 200 as a short distance. For example, the first resource management module 123 may collect a motion pattern of the first electronic device 100 and a motion pattern of the second electronic device 200 and may determine a short distance based on similarity between the two motion patterns. The first resource management module 123 may determine whether to apply an authentication policy and may adjust the authentication policy, based on the obtained distance information (or separation distance information) with the second electronic device 200.

According to various embodiments, the first resource management module 123 may apply a change threshold distance of a second authentication policy in a different way based on a level (or a degree or a grade) of an authentication policy released before the second authentication policy is applied. For example, if the level of the authentication policy released before the second authentication policy is applied is relatively high (or difficult or complicated), the first resource management module 123 may set a threshold distance for changing the second authentication policy to be relatively longer. If the level of the authentication policy released before the second authentication policy is applied is relatively low (or easy or simple), the first resource management module 123 may set the threshold distance for changing the second authentication policy to be relatively shorter.

According to various embodiments, the first resource management module 123 may apply a time of applying the second authentication policy based on the level of the authentication policy released before the second authentication is applied. For example, if the level of the authentication policy released before the second authentication policy is applied is relatively high (or difficult or complicated), the first resource management module 123 may set a period for changing the second authentication policy to be relatively longer (e.g., once every one hour). If the level of the authentication policy released before the second authentication policy is applied is relatively low (or easy or simple), the first resource management module 123 may set a period for changing the second authentication policy to be relatively shorter (e.g., two times every one hour).

The first resource management module 123 may adjust at least one of an access (execution) right for each content type, a depth access right of content, a content link function access right, content end, deletion, and movement rights, a content usage time, a content usage place, or a type of an external device executed based on content access in a different way based on at least one of a level of the authentication policy, a level of the second authentication policy, biometric persistent information, a location, or a distance.

According to an embodiment, the first resource management module 123 may limit a type of accessible content based on a current location in a state where biometric persistent information is provided from the second electronic device 200. For example, if the current location is a relatively private place (e.g., a specified first place), the first resource management module 123 may grant access to content of a specified first security level. If the current location is a relatively public place (e.g., a specified second place), the first resource management module 123 may grant access to content of a specified second security level (e.g., a level which is lower than the first security level) and may limit or block the access to the content of the first security level.

According to various embodiments, if the current location is a first place (e.g., a relatively private place) in a state where biometric persistent information is provided from the second electronic device 200, the first resource management module 123 may limit the number of accessible content to the first number of content. According to various embodiments, if the current location is a second place (e.g., a relatively public place) in the state where the biometric persistent information is provided from the second electronic device 200, the first resource management module 123 may limit the number of the accessible content to the second number of content which is less than the first number of content. According to various embodiments, if the current location is a third place (e.g., a relatively open place) in the state where the biometric persistent information is provided, the first resource management module 123 may block access to all content (or may block access to the other content except for a specified function such as an emergency call).

According to various embodiments, the first resource management module 123 may change a type of an external device based on accessible content and a type of an execution function of the external device, based on the current location in the state where the biometric persistent information is provided. For example, in the state where the biometric persistent information is provided, if the current location is the first place (e.g., the relatively private place), the first resource management module 123 may grant access to external devices by a specified first type and the specified first number of external devices. According to various embodiments, in the state where the biometric persistent information is provided, if the current location is the second place (e.g., the relatively public place), the first resource management module 123 may grant access to external devices by a specified second type and the specified second number of external devices (e.g., a type and the number of external devices are more limited than the first type and the first number of the external devices).

According to various embodiments, the first resource management module 123 may adjust at least one of an access (or execution) right for each content type, a depth access right to content, an access right to a content link function, the right to end, delete, and move content, a content usage time, a content usage place, or a type of an external device executed based on access to content, in a different way based on a distance (e.g., information about a distance between the first electronic device 100 and the second electronic device 200) in the state where the biometric persistent information is provided. For example, in the state where the biometric persistent information is provided, if the distance is a specified first distance, the first resource management module 123 may grant access to relatively more types of content and a relatively greater number of content than that of the first electronic device 100. According to various embodiments, in the state where the biometric persistent information is provided, if the distance is a specified second distance (e.g., a distance which is longer than the first distance), the first resource management module 123 may grant access to relatively less types of content and a relatively fewer number of content than that of the first electronic device 100.

According to various embodiments, in the state where the biometric persistent information is provided, if the distance is the specified first distance, the first resource management module 123 may grant relatively many types of operable external devices and a relatively great number of operable external devices. Further, in the state where the biometric persistent information is provided, if the distance is the specified second distance, the first resource management module 123 may grant relatively less types of operable external devices and a relatively few number of operable external devices.

The first memory 130 may store at least one program associated with operating the first electronic device 100 and may store data associated with operating the program. According to an embodiment, the first memory 130 may store an operating system (OS) of the first electronic device 100. Further, the first memory 130 may store an authentication processing program 131. The authentication processing program 131 may store an instruction set (or a program routine, a function, and the like) for adjusting a level of an authentication policy (e.g., at least one of a type of authentication, the number of the authentication, complexity of the authentication, or a complex degree of the authentication) based on a specified condition, an instruction set for adjusting a level of a second authentication policy (e.g., at least one of information indicating whether second authentication is applied, a type of the second authentication, the number of the second authentication, complexity of the second authentication, or a complex degree of the second authentication) based on a specified condition, and an instruction set for adjusting a level of a content policy (e.g., at least one of a type of accessible content, the number of the accessible content, a content link function, a type of an external electronic device associated with content, or the number of external devices) based on a specified condition.

According to various embodiments, the authentication processing program 131 may store an instruction set for adjusting a threshold distance for changing an authentication policy based on a specific condition, an instruction set for adjusting a threshold distance for changing a second authentication policy based on a specified condition, and an instruction set for adjusting a threshold distance for changing a content policy based on a specified condition. The specified condition associated with the authentication policy may include at least one of biometric persistent information, a current location of the first electronic device 100, or a mutual distance between the first electronic device 100 and the second electronic device 200. The specified condition associated with the second authentication policy may include at least one of a level of an authentication policy, biometric persistent information, a current location of the first electronic device 100, or a mutual distance between the first electronic device 100 and the second electronic device 200. The specified condition associated with the content policy may include at least one of a level of an authentication policy, a level of a second authentication policy, biometric persistent information, a current location of the first electronic device 100, or a mutual distance between the first electronic device 100 and the second electronic device 200.

The first I/O interface 150 may play a role of an interface which may send a command or data input from the user or another external device to another component (other components) of the first electronic device 100. Also, the first I/O interface 150 may output a command or data, received from another component (other components) of the first electronic device 100, to the user or the other external device. The first I/O interface 150 may include, for example, at least one physical button, at least one touch button, at least one touch pad, at least one touch screen, and the like. Also, the first I/O interface 150 may include an input means by an electronic pen and the like. The first I/O interface 150 may support, for example, a gesture input, a number input, and the like associated with authentication or second authentication (or unlocking). Also, the first I/O interface 150 may support an input associated with executing content.

According to various embodiments, the first I/O interface 150 may include an audio device which may collect or output an audio signal. According to an embodiment, the audio device may support to collect audio information (e.g., a user voice) associated with authentication in response to control of the first processor 120. The audio device may output specified audio information associated with authentication (or unlocking), second authentication, and content operation in response to control of the processor 120.

The first display 160 may be implemented with a thin film transistor-liquid crystal display (TFT-LCD) panel, a light emitting diode (LED) panel, an organic LED (OLED) panel, an active matrix OLED (AMOLED) panel, a flexible panel, or the like. The first display 160 may output an execution screen based on executing a specific application. For example, the first display 160 may output a screen associated with an authentication policy and a screen associated with unlocking a user interface (UI) set by the authentication policy upon unlocking the UI. A specified home screen or a previously executed content execution screen may be displayed on the first display 160 upon unlocking the UI. The first display 160 may output a screen associated with a second authentication policy, a second authentication screen, and the like.

The first communication module 170 may include at least one module which supports to establish a communication channel of the first electronic device 100. Alternatively, the first communication module 170 may support at least one communication mode. According to various embodiments, the first communication module 170 may include, for example, a plurality of communication modules, each of which has a different transmission distance. The first communication module 170 may be used to determine information about a mutual distance between the first electronic device 100 and the second electronic device 200. Also, the first communication module 170 may be used to collect biometric persistent information from the second electronic device 200. Also, the first communication module 170 may send a control signal associated with changing a policy or changing a content policy, received from the second electronic device 200.

The first sensor 180 may collect biometric persistent information and current location information. In this regard, the first sensor 180 may include a biometric sensor 181 and the first location information collection module 183. The biometric sensor 181 may include at least one sensor which may collect biometric information. The first location information collection module 183 may include a sensor such as a GPS. According to various embodiments, the first location information collection module 183 may be replaced with a Wi-Fi communication module for supporting to operation a WPS. The first sensor 180 may send the collected biometric persistent information and the collected location information to the first processor 120. According to various embodiments, if the first electronic device 100 obtains at least one of biometric persistent information or location information from the second electronic device 200, the first sensor 180 may be omitted from the first electronic device 100.

FIG. 2B is a block diagram illustrating an example of a second electronic device according to an embodiment.

Referring to FIG. 2B, a second electronic device 200 may be a device which establishes a communication channel with a first electronic device 100 of FIG. 2A. According to an embodiment, the second electronic device 200 may be a wearable device and may be a companion device of the first electronic device 100 (e.g., a device with a wearable type which establishes a short-distance communication channel with the first electronic device 100). Alternatively, the second electronic device 200 may be a device which supports the substantially same function as the first electronic device 100. According to various embodiments, the second electronic device 200 may collect biometric persistent information in connection with changing a usage policy of the first electronic device 100 and may send the collected biometric persistent information to the first electronic device 100, or may send specified data corresponding to the biometric persistent information to the first electronic device 100. According to various embodiments, the second electronic device 200 may send a control signal associated with changing the usage policy of the first electronic device 100 to the first electronic device 100.

The second electronic device 200 may include a second processor 220, a second memory 230, a second sensor 280, a second communication module 270 (or a second communication circuit), a second display 260, and a second I/O interface 250.

The second processor 220 may perform data processing, signal transmission, and the like associated with operating the second electronic device 200. For example, the second processor 220 may perform signal processing associated with changing the usage policy. In this regard, the second electronic device 200 may include a second resource management module 221 (or a second resource management processor).

The second resource management module 221 may operate the second sensor 280 to collect biometric persistent information. For example, the second resource management module 221 may operate the second sensor 280 to collect pulse information in real time or periodically. Alternatively, the second resource management module 221 may perform processing associated with collecting fingerprint information. Alternatively, the second resource management module 221 may perform processing such as collection of iris information and collection of face recognition information. The second resource management module 221 may send the collected biometric persistent information (e.g., at least one of pulse information, fingerprint information, iris information, or face recognition information) to a first resource management module 123 of FIG. 2A.

According to various embodiments, the second resource management module 221 may collect biometric persistent information from the first electronic device 100. According to various embodiments, the second resource management module 221 may send biometric persistent information, obtained from the second sensor 280, to the first electronic device 100. In this operation, the second resource management module 221 may establish a security communication channel with the first electronic device 100 and may send the biometric persistent information to the first electronic device 100 over the security communication channel. According to various embodiments, the second resource management module 221 may send a specified result value indicating whether biometric persistent information is collected or whether the collected biometric persistent information is valid to the first electronic device 100.

The second resource management module 221 may collect biometric persistent information provided from the first resource management module 123, a current location, and a distance (or mutual distance information) between the first electronic device 100 and the second electronic device 200. In this regard, the second resource management module 221 may collect a current location using a location information sensor included in the second sensor 280. Alternatively, the second resource management module 221 may receive current location information from the first electronic device 100 which establishes a communication channel. The second resource management module 221 may establish a short-distance communication channel with the first electronic device 100 to obtain mutual distance information. The second resource management module 221 may measure mutual distance information based on a short-distance communication channel environment (e.g., radio signal received strength, a type of a communication module which establishes a communication channel, and the like) or may receive mutual distance information from the first electronic device 100.

The second resource management module 221 may change an authentication policy for the first electronic device 100 based on biometric persistent information, a current location of the second electronic device 200, and a distance (or mutual distance information) between the first electronic device 100 and the second electronic device 200. Also, similar to the first electronic device 100, the second resource management module 221 may adjust information indicating whether a second authentication policy is applied, a type of the second authentication policy, the number of second authentication policies, complexity of the second authentication policy, a complex degree of the second authentication policy, and the like based on at least one of biometric persistent information, a current location, mutual distance information, or a level of a previous authentication policy. Also, the second resource management module 221 may adjust a content policy for the first electronic device 100 based on at least one of a level of an authentication policy, a level of a second authentication policy, biometric persistent information, a current location, or mutual distance information. According to an embodiment, the second resource management module 221 may adjust a setting value (e.g., a threshold distance value) to which a change in authentication policy will be applied or a setting value to which a change in second authentication policy will be applied, based on a current location of the second electronic device 200.

The second memory 230 may store information associated with operating the second electronic device 200. For example, the second memory 230 may store information associated with the authentication policy, information associated with the second authentication policy, and information associated with a content policy. Also, the second memory 230 may store a threshold distance value to which a change in policy is applied. The threshold distance value to which the change in policy is applied may be changed based on, for example, a current location (or a current location in a state where biometric persistent information is provided). According to various embodiments, the second memory 230 may store at least one content.

The second I/O interface 250 may support a user input associated with operating the second electronic device 200. According to an embodiment, the second I/O interface 250 may include a touch pad, a touch screen, a physical button, and the like. Also, the second I/O interface 250 may include a crown button, a rotating bezel, and the like. Also, the second I/O interface 250 may include an audio device such as a microphone or a speaker.

The second display 260 may provide at least one screen associated with operating the second electronic device 200. For example, the second display 260 may provide a screen of applying an authentication policy, a screen of releasing the authentication policy, a screen of applying a second authentication policy, a screen of releasing the second authentication policy, a screen of using specified content, and the like. According to various embodiments, the second display 260 may output a screen associated with collecting biometric persistent information, a screen associated with providing the biometric persistent information (e.g., sending the biometric persistent information to the first electronic device 100), a screen associated with establishing a short-distance communication channel with the first electronic device 100, and the like. Also, the second display 260 may output an indicator or a pop-up message indicating a state where the biometric persistent information is collected.

The second communication module 270 may support a communication function of the second electronic device 200. For example, the second communication module 270 may include at least one short-distance communication module. The second communication module 270 may be activated based on settings or in response to a user input to establish a communication channel with the first electronic device 100. According to various embodiments, the second communication module 270 may receive a result signal associated with changing a policy from the first electronic device 100. Alternatively, the second communication module 270 may send a control signal associated with changing a policy of the first electronic device 100 to the first electronic device 100 in response to control of the second processor 220. According to various embodiments, the second communication module 270 may establish a communication channel which sends biometric persistent information or a specified result value corresponding to the biometric persistent information to the first electronic device 100, under control of a biometric information processing module 121 of FIG. 2A.

The second sensor 280 may include the substantially same sensor as a first sensor 180 of the first electronic device 100. Alternatively, the second sensor 280 may include a sensor associated with collecting biometric persistent information (e.g., a pulse sensor, a fingerprint sensor, a camera sensor for collecting iris information, and the like). Also, the second sensor 280 may a GPS associated with collecting current location information.

According to various embodiments, an electronic device may include a memory configured to store a usage policy associated with operating the electronic device, a communication module configured to communicate with an external electronic device, and a processor configured to connect with the memory and the communication module. The processor may be configured to collect biometric persistent information within a specified time range and to adjust the usage policy based on operation state information (or context information) including at least one of a distance from the external electronic device, a type of a zone to which a current location of the electronic device belongs, previous authentication history, or a type of the external electronic device.

According to various embodiments, the processor may be configured to adjust the usage policy in a different way based on at least one of a type of the biometric persistent information, an elapsed time from a time when the biometric persistent information is collected, complexity of the biometric persistent information, or a complex degree of the biometric persistent information.

According to various embodiments, the processor may be configured to adjust a level of the usage policy in a different way in response to a size of a distance value from the external electronic device.

According to various embodiments, the processor may be configured to adjust a level of the usage policy to be relatively higher if a distance close to the external electronic device is relatively longer. The processor may be configured to adjust the level of the usage policy to be relatively lower if the distance close to the external electronic device is relatively shorter.

According to various embodiments, the processor may be configured to classify a type of the zone based on communication access information in the zone or local information mapped to a location of the electronic device and to adjust a level of the usage policy in a different way based on the type of the zone.

According to various embodiments, the processor may be configured to adjust a level of a usage policy of the electronic device in a relatively private place to be relatively lower and to adjust the level of the usage policy of the electronic device in a relatively public place to be relatively higher.

According to various embodiments, the processor may be configured to adjust at least one of a level of an authentication policy associated with authenticating the electronic device in response to the operation state information, a level of a second authentication policy associated with second authentication applied while the electronic device is operated after first authentication, or a level of a content policy associated with a content access range.

According to various embodiments, the processor may be configured to adjust a level of the usage policy to be subsequently applied to be lower if an authentication policy level of previous authentication is higher. The processor may be configured to adjust the level of the usage policy to be subsequently applied to be higher if the authentication policy level of the previous authentication is lower.

According to various embodiments, the processor may be configured to receive the biometric persistent information from the external electronic device.

According to various embodiments, the electronic device may further include a sensor configured to sense biometric persistent information within a specified time range.

According to various embodiments, an electronic device may include a memory configured to store a usage policy associated with operating the electronic device, a communication module configured to communicate with an external electronic device, and a processor configured to connect with the memory and the communication module. The processor may be configured to adjust a length of a threshold distance for applying a change in usage policy based on at least one of the biometric persistent information, a type of a zone to which a current location of the electronic device belongs, or previous authentication history.

According to various embodiments, the processor may be configured to classify the type of the zone based on an access point (AP) installed in the zone and to adjust the length of the threshold distance in a different way based on the type of the area.

According to various embodiments, the processor may be configured to adjust the threshold distance to be relatively shorter if the zone is a relatively public place. The processor may be configured to adjust the threshold distance to be relatively longer if the area is a relatively private place.

According to various embodiments, the processor may be configured to adjust the threshold distance to be longer if complexity or a complex degree of the biometric persistent information is higher. The processor may be configured to adjust the threshold distance to be shorter if the complexity or complex degree of the biometric persistent information is lower.

According to various embodiments, the processor may be configured to adjust the threshold distance to be longer if an authentication policy level of previous authentication is higher. The processor may be configured to adjust the threshold distance to be shorter if the authentication policy level of the previous authentication is lower.

According to various embodiments, the processor may be configured to identify (or verify, or check, or confirm, or ascertain) a user relationship between a first user of the electronic device and a second user of the external electronic device and to adjust the threshold distance in a different way based on the user relation.

According to various embodiments, the processor may be configured to adjust the threshold distance to be longer if the user relationship is a specified user relationship. The processor may be configured to adjust the threshold distance to be shorter if there is no information about the user relationship or if the user relationship is not the specified user relationship.

According to various embodiments, the processor may be configured to may obtain user information by comparing the obtained biometric persistent information with stored biometric persistent information and to identify a relationship with a user of the external electronic device based on the obtained user information and stored user relationship information.

According to various embodiments, the processor may be configured to adjust a level of the usage policy to be lower if a type of the external electronic device is a specified first type. The processor may be configured to adjust the level of the usage policy to be higher if the type of the external electronic device is a specified second type.

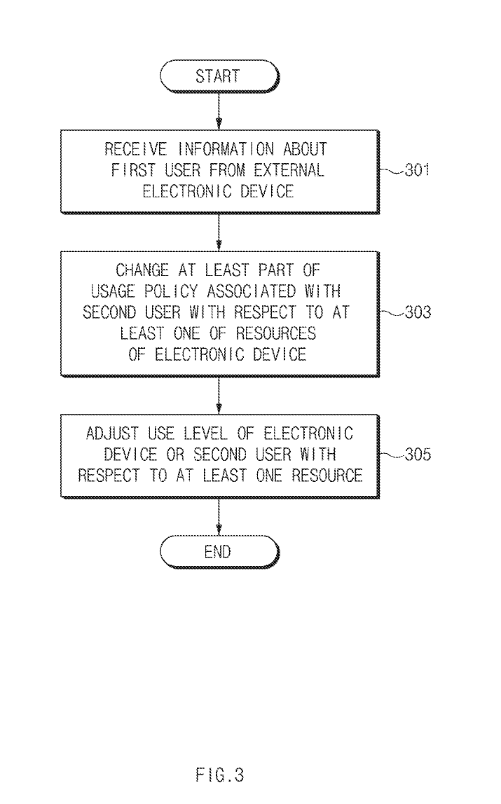

FIG. 3 is a flowchart illustrating a method for adjusting a usage policy according to an embodiment.

Referring to FIG. 3, in connection with the method for adjusting the usage policy, in operation 301, a first resource management module 123 of a first electronic device 100 of FIG. 2A may receive information about a first user (e.g., biometric related information) from an external electronic device (e.g., a second electronic device 200 of FIG. 2A) using a first communication module 170 of FIG. 2A.

In operation 303, the first resource management module 123 may change at least part of a usage policy (e.g., an authentication policy, a content policy, or the like) associated with a second user for at least one of resources of the first electronic device 100. In connection with the changing of the usage policy, the first resource management module 123 may identify a relationship between the first user and the second user based on at least part of the information about the first user and may change at least part of the usage policy based on at least part of the relationship.

If the information about the first user includes biometric related information corresponding to the first user, in connection with the changing of the usage policy, the first resource management module 123 may change the at least part of the usage policy to a first usage policy or first information if the biometric related information meets a first specified condition and may change the at least part of the usage policy to a second usage policy or second information if the biometric related information meets a second specified condition. The biometric related information may include an authenticated result, indicating an authentication level for the first user, performed based on at least one biometric signal corresponding to the first user.

According to various embodiments, in connection with the changing of the usage policy, the first resource management module 123 may obtain a relationship between the first user and the second user, a distance between the electronic device and the external electronic device, a first location corresponding to the electronic device, or a second location corresponding to the external electronic device and may change the at least part of the usage policy further based on the relationship, the distance, the first location, or the second location.

According to various embodiments, in connection with the changing of the usage policy, the first resource management module 123 may receive a usage right of the first user to use the at least one resource from the external electronic device using the first communication module 170 and may change the at least part of the usage policy further based on the usage right.

In operation 305, the first resource management module 123 may adjust a use level of the first electronic device 100 or the second user for the at least one resource in response to changing the usage policy.

In the above-mentioned operation, the first resource management module 123 may change a usage policy based on at least one of biometric related information of the first user and distance information from the external electronic device, the biometric related information and location information of a space where the first electronic device 100 is currently located, the biometric related information and information about a relationship with the external electronic device (e.g., a device operated by the first user, a family member, or another), the biometric related information and right request data received from the external electronic device, the biometric related information, right request data received from the external electronic device, and distance information from the external electronic device, or the biometric related information, right request data received from the external electronic device, and relationship information with the external electronic device.

In connection with changing a usage policy based on the biometric persistent information and the user relationship, the first resource management module 123 of the first electronic device 100 may change the usage policy based on a relationship with the user (e.g., the same person, an acquaintance, or another), verified by receiving biometric persistent information from the second electronic device 200, a distance from the second electronic device 200, and a location of the second electronic device 200. For example, if user information (e.g., biometric persistent information and an authentication result) received from the second electronic device 200 corresponds to information about the same person as the user of the first electronic device 100 and if a mutual distance between the first electronic device 100 and the second electronic device 200 is close to each other, the first resource management module 123 may change an unlock method to the easiest method or may change a content access right to a high level. If the mutual distance is distant from each other, the first resource management module 123 may change the unlock method to a difficult method or may change the content access right to a low level. Also, if the user information received from the second electronic device 200 corresponds to information about another, the first resource management module 123 may change the unlock method to unlock the first electronic device 100 only when the user should enter a specified password although the mutual distance is close to each other or may limit the content access right to a specified level. If the mutual distance is distant from each other, the first resource management module 123 may change the unlock method to the most difficult method or may change the content access right to the lowest level. According to various embodiments, if the user information received from the second electronic device 200 corresponds to information about the same person as the user of the first electronic device 100 and if the first electronic device 100 is located in a private place, the first resource management module 123 may change the unlock method to the easiest method or may change the content access right to a high level. If the first electronic device 100 is located in a public place, the first resource management module 123 may change the unlock method to a difficult method or may change the content access right to a low level. Also, if the user information (e.g., biometric persistent information and an authentication result) received from the second electronic device 200 corresponds to information about another, the first resource management module 123 may change the unlock method to unlock the first electronic device 100 only when the user should enter a specified password although the first electronic device 100 is located in a private place or may limit the content access right to a specified level. If the user information corresponds to the information about another and if the first electronic device 100 is located in the public place, the first resource management module 123 may change the unlock method to the most difficult method or may change the content access right to the lowest level.

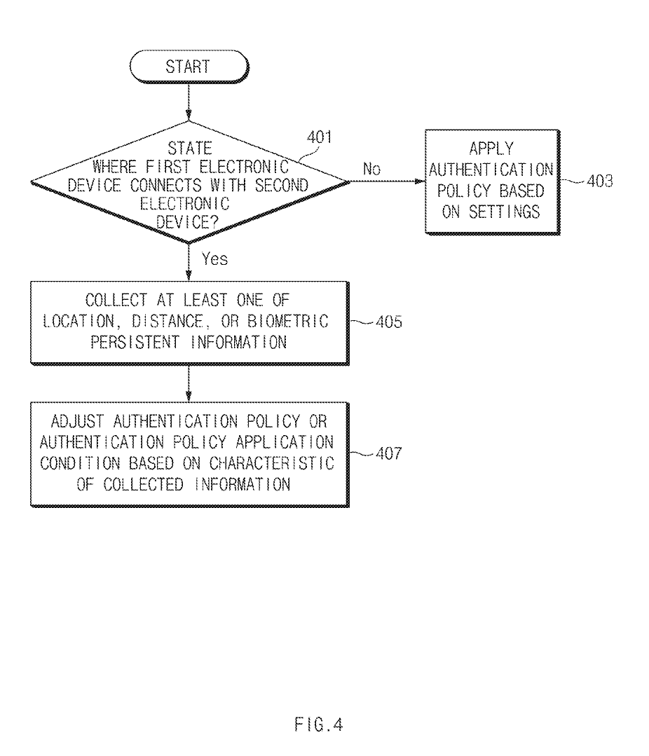

FIG. 4 is a flowchart illustrating a method for adjusting an authentication policy of an electronic device according to an embodiment.

Referring to FIG. 4, in connection with the method for adjusting the authentication policy of the electronic device, in operation 401, a first resource management module 123 of a first electronic device 100 of FIG. 2A may obtain a state where the first electronic device 100 connects with a second electronic device 200 of FIG. 2B. If the first electronic device 100 is not connected with the second electronic device 200, in operation 403, the first resource management module 123 may apply an authentication policy according to settings. For example, the first resource management module 123 may maintain an authentication policy level (or degree or grade) according to the settings.

If the first electronic device 100 connects with the second electronic device 200, in operation 405, the first resource management module 123 may collect at least one of a location, a distance (e.g., a mutual distance between the first electronic device 100 and the second electronic device 200), or biometric persistent information. The location may be a current location of the first electronic device 100, for example, may be verified by operating a location information sensor or may be verified based on information received from the second electronic device 200. The distance may be verified based on a communication channel established with the second electronic device 200 (e.g., radio signal received strength). The biometric persistent information may be received from, for example, the second electronic device 200. The biometric persistent information may include, for example, pulse related information, fingerprint related information, iris recognition related information, and the like. If the biometric persistent information is received from the second electronic device 200, the first resource management module 123 may receive data indicating whether pulse information is continuously collected, whether a fingerprint is matched with specified information, and whether iris information is matched with specified information.

In operation 407, the first resource management module 123 may adjust an authentication policy or may adjust an authentication policy application condition, based on a characteristic of the collected information. For example, if a current location is a first specified place (e.g., a relatively private place such as a home) in a state which is kept receiving biometric persistent information, the first resource management module 123 may change a level of an authentication policy to a low level. If the current location is a second specified place (e.g., a relatively public place such as a library) in the state which is kept receiving the biometric persistent information, the first resource management module 123 may change the level of the authentication policy to a high level.

According to various embodiments, if the current location is the first specified place (e.g., a relatively private place such as a home) in the state which is kept receiving the biometric persistent information, the first resource management module 123 may lower the authentication policy application condition. For example, the first resource management module 123 may adjust a threshold distance from the second electronic device 200 which changes an authentication policy (e.g., changes a level of the authentication policy to a high level) to be longer. Thus, although a distance from the second electronic device 200 is distant in a more private space (e.g., although the distance from the second electronic device 200 is more distant from a specified distance in a public space), a user of the first electronic device 100 may operate the first electronic device 100 based on a low authentication policy.

Further, according to various embodiments, if the current location is a third specified space (e.g., a relatively open place such as a park) in a state which is kept receiving the biometric persistent information, the first resource management module 123 may raise the authentication policy application condition. For example, the first resource management module 123 may adjust a threshold distance from the second electronic device 200 which changes an authentication policy (e.g., changes the level of the authentication policy to a high level) to be shorter. Thus, if the first electronic device 100 and the second electronic device 200 are operated in an open place, although the first electronic device 100 is distant from the second electronic device 200 to be shorter than a private place or a public place, the authentication policy may be changed to apply a higher authentication policy (e.g., a policy with relatively high security, a policy with high complexity or complex degree of authentication, and a policy to which more complicated authentication is applied to unlock the first electronic device 100).

According to various embodiments, if the second electronic device 200 is authenticated, the first resource management module 123 may receive the authentication result of the second electronic device 200 from the second electronic device 200. Also, the first resource management module 123 may receive usage right request information from the second electronic device 200. The first resource management module 123 may change a usage policy based on at least one of the authentication result or the right request information received from the second electronic device 200.

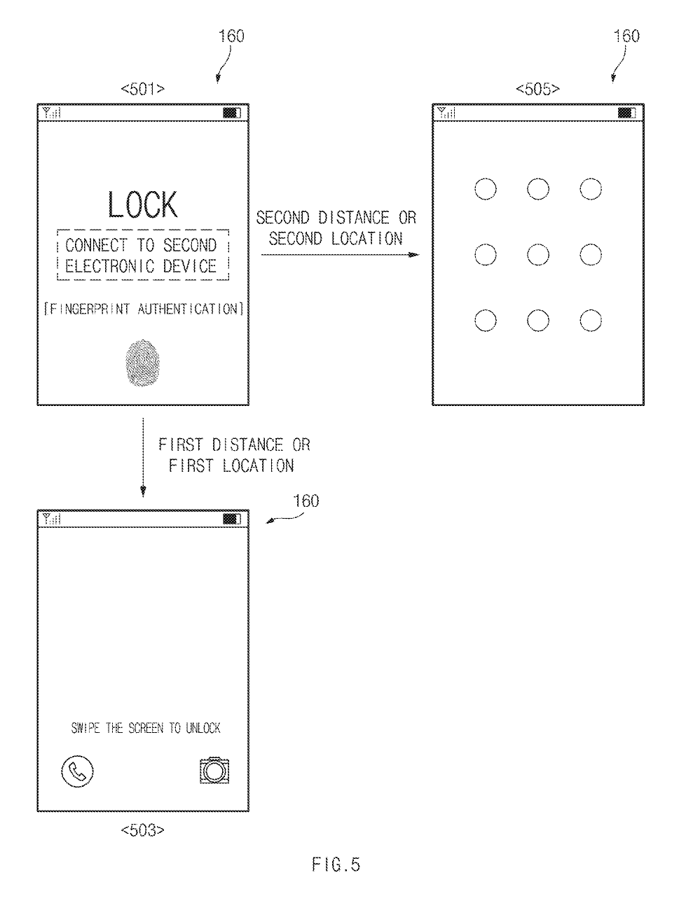

FIG. 5 is a drawing illustrating an example of a screen interface associated with adjusting an authentication level according to an embodiment.

Referring to FIG. 5, in state 501, a first electronic device 100 of FIG. 2A (or a second electronic device 200 of FIG. 2B) may provide a lock screen. The lock screen may output, for example, at least one of text or an image indicating that the first electronic device 100 (or the second electronic device 200) is in a lock state currently. Alternatively, the lock screen may output a specified background screen. According to various embodiments, the lock screen may output, for example, information indicating a state where the first electronic device 100 connects with the second electronic device 200. In FIG. 5, a connection state of the second electronic device 200 is arranged in the center of a screen. However, for example, after the connection state is temporarily output in the form of a pop-up window (e.g., when the connection state is in an ON state from a sleep state), the connection state may disappear from a display 160 of FIG. 2A (or a display 260 of FIG. 2B). According to various embodiments, the first electronic device 100 may be in a state where biometric persistent information is collected. For example, the first electronic device 100 may collect pulse information of the user of the first electronic device 100. Alternatively, the first electronic device 100 may receive biometric persistent information (e.g., pulse information, motion information, fingerprint information obtained at a period, iris information, or the like) from the second electronic device 200. According to an embodiment, the first electronic device 100 may output at least one of an image or text associated with collecting specified biometric information (e.g., fingerprint information).

According to an embodiment, the first electronic device 100 may obtain mutual distance information from the second electronic device 200 based on a state where the first electronic device 100 connects with the second electronic device 200. Also, the first electronic device 100 may collect its current location information. If determining a mutual distance between the first electronic device 100 and the second electronic device 200 as a first distance which is relatively close (or the first distance which is within a specified distance), in state 503, the first electronic device 100 may output a screen based on applying a first authentication policy. The first authentication policy may include, for example, an authentication policy for unlocking the first electronic device 100 by a screen touch (or swiping a screen to unlock the first electronic device 100, unlocking the first electronic device 100 by a drag operation, or unlocking the first electronic device 100 through a specified gesture input on a touch screen). According to various embodiments, if a current location of the first electronic device 100 is a first location (e.g., a relatively private place), the first electronic device 100 may output a screen based on applying a first authentication policy.

According to various embodiments, if biometric persistent information (e.g., at least one of pulse information or fingerprint information) is collected within a specified time range and if a mutual distance from the second electronic device 200 is a first distance, the first electronic device 100 may output a screen according to a first authentication policy. Alternatively, if the biometric persistent information is collected within the specified time range (or an elapsed time after the biometric persistent information is collected is within the specified time range) and if a current location of the first electronic device 100 (or the second electronic device 200) is a first location, the first electronic device 100 may output the screen according to the first authentication policy.

According to various embodiments, if determining the mutual distant from the second electronic device 200 as a second distance which is relatively distant (or the second distance which is greater than a specified distance), in state 505, the first electronic device 100 may output a screen based on applying a second authentication policy. The second authentication policy may include, for example, an authentication policy for unlocking the first electronic device 100 using a pattern. According to various embodiments, if a current location of the first electronic device 100 is a second location (e.g., a relatively public place), the first electronic device 100 may output the screen according to the second authentication policy.

As described above, the first electronic device 100 may adjust an authentication policy (e.g., adjust the authentication policy to a relatively higher security level or a relatively lower security level than a previous state) in response to at least one of information indicating whether biometric persistent information is provided, a type of the biometric persistent information, elapsed time information after the biometric persistent information is provided, a mutual distance from the second electronic device 200, or a current location of the first electronic device 100 (or a location of the second electronic device 200).

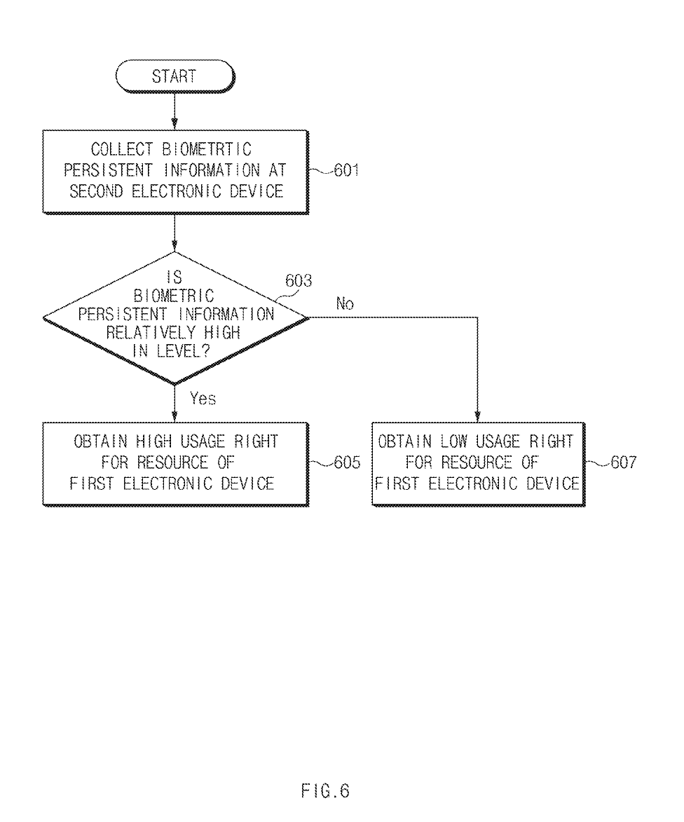

FIG. 6 is a flowchart illustrating a method for obtaining a usage right of a second electronic device according to an embodiment.

Referring to FIG. 6, in connection with the method for obtaining the usage right of the second electronic device, in operation 601, a second resource management module 221 of a second electronic device 200 of FIG. 2B may collect biometric persistent information.

In operation 603, if the biometric persistent information is collected, the second resource management module 221 may determine whether the collected biometric persistent information has a relatively high level. In this regard, the second electronic device 200 may store level information about the biometric persistent information. The second resource management module 221 may determine a level of currently collected biometric persistent information based on the stored level information.

If the collected biometric persistent information has the relatively high level, in operation 605, the second resource management module 221 may obtain a high usage right for a resource of a first electronic device 100 of FIG. 2A. In this regard, the second resource management module 221 may send a message or information for providing notification that high biometric persistent information is collected to the first electronic device 100 and may obtain a high usage right for the first electronic device 100 in response to the sent message or information.

If the collected biometric persistent information has a relatively low level, in operation 607, the second resource management module 221 may obtain a low usage right for a resource of the first electronic device 100. In this regard, the second resource management module 221 may send the obtained biometric persistent information to the first electronic device 100 and may obtain a low usage right for the first electronic device 100 in response to the sent biometric persistent information.

According to various embodiments, a first resource management module 123 of the first electronic device 100 may receive biometric persistent information from the second electronic device 200 and may allocate a usage right in a different way based on a degree of first authentication although a distance from the second electronic device 200 is the same as each other. For example, if a first authentication scheme is an authentication policy, such as unlocking by a screen touch, in which a degree of security is relatively low (or easy or simple) and if usage right request data is received from the second electronic device 200, the first resource management module 123 may allocate a relatively low usage right.

According to various embodiments, although a current operation state is the same as each other, if biometric persistent information provided from the second electronic device 200 is an authentication policy, such as iris recognition, in which a degree of security is relatively high (or difficult or completed), the first resource management module 123 may allocate a relatively high usage right to the second electronic device 200.

According to various embodiments, if a usage right request is received from the second electronic device 200, the first resource management module 123 may determine a usage policy and may send the determined usage policy to the second electronic device 200.

According to various embodiments, the second resource management module 221 may determine a usage policy of the first electronic device 100 based on biometric persistent information and a mutual distance between the first electronic device 100 and the second electronic device 200 and may send the determined usage policy to the first electronic device 100.

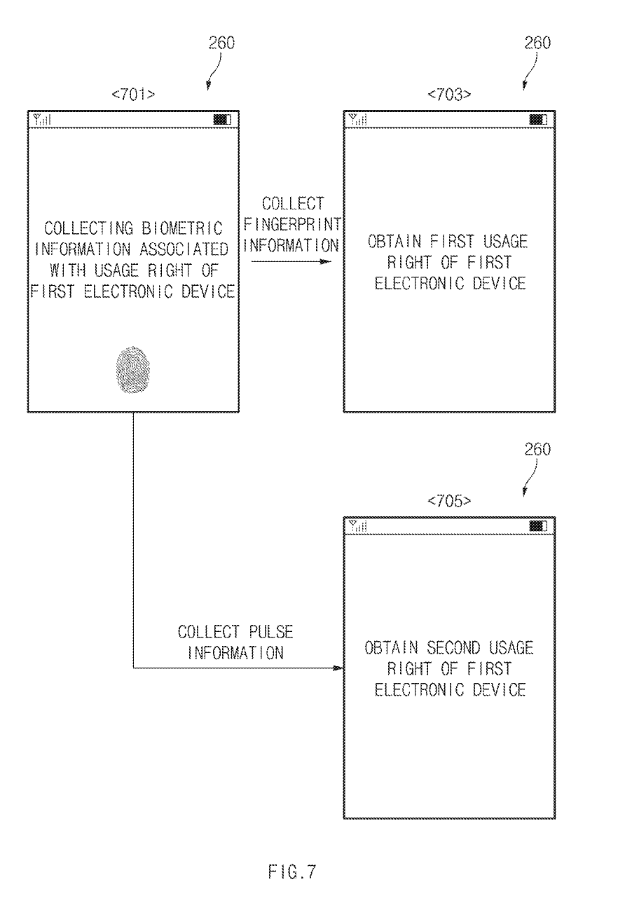

FIG. 7 is a drawing illustrating an example of a screen interface associated with obtaining a usage right of a second electronic device according to an embodiment.

Referring to FIG. 7, according to an embodiment, in a state 701, a second electronic device 200 of FIG. 2B may collect biometric information associated with obtaining a usage right of a first electronic device 100 of FIG. 2A. In such state, if collecting fingerprint information with a relatively high authentication level, in state 703, the second electronic device 200 may obtain a first usage right (e.g., a relatively high usage right) of the first electronic device 100. If collecting pulse information with a relatively low authentication level, in state 705, in state 705, the second electronic device 200 may obtain a second usage right (e.g., a relatively low usage right) of the first electronic device 100.

In connection with obtaining the above-mentioned usage right, the second electronic device 200 may send the collected biometric persistent information to the first electronic device 100. Also, the second electronic device 200 may send usage right request data to the first electronic device 100 while sending the biometric persistent information to the first electronic device 100. The first electronic device 100 may determine a usage right to be allocated to the second electronic device 200 based on a type of the received biometric persistent information. In this regard, the first electronic device 100 may store and manage a database for a usage right to be allocated based on a type of the biometric persistent information. The usage right database may be changed by a user of the first electronic device 100.

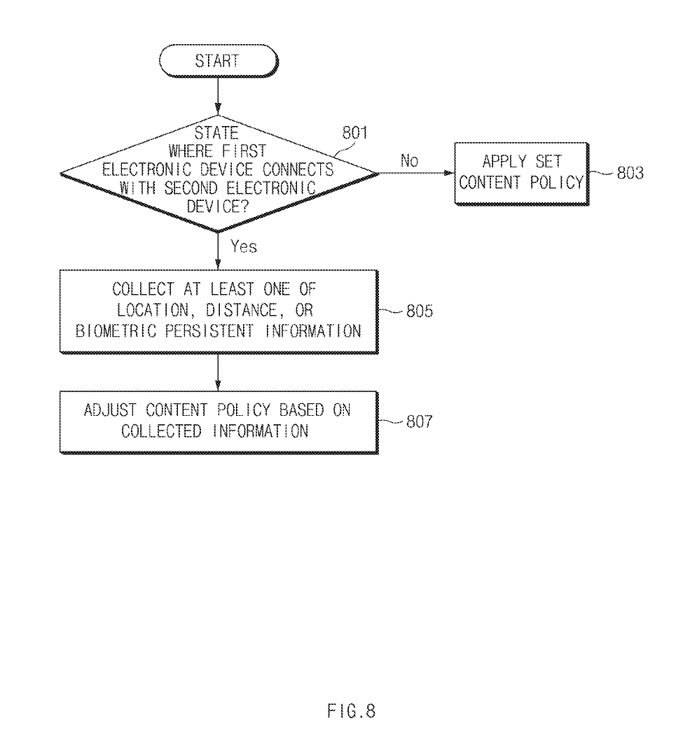

FIG. 8 is a flowchart illustrating a method for adjusting a content policy of an electronic device according to an embodiment.

Referring to FIG. 8, in connection with the method for adjusting the content policy of the electronic device, in operation 801, a first resource management module 123 of a first electronic device 100 of FIG. 2A may obtain a state where the first electronic device 100 connects with a second electronic device 200 of FIG. 2B. If the first electronic device 100 is not connected with the second electronic device 200, in operation 803, the first resource management module 123 may apply a set content policy. For example, the first resource management module 123 may apply a content policy of a specified grade to output a number of content, to output content (or at least one application) of a security level on a display, or to grant access to a user of the first electronic device 100.

If the first electronic device 100 connects with the second electronic device 200, in operation 805, the first resource management module 123 may collect at least one of a location, a distance, or biometric persistent information. The location may include a location of the first electronic device 100 or place information corresponding to the location. The distance may include mutual distance information between the first electronic device 100 and the second electronic device 200. The biometric persistent information may include biometric persistent information obtained at a period or in real time by the second electronic device 200. According to various embodiments, the first resource management module 123 may further collect information such as a level of an authentication policy and a level of a second authentication policy.

In operation 807, the first resource management module 123 may adjust a content policy based on the collected information. If a current location of the first electronic device 100 is a first specified place or if mutual distance information (e.g., distance information between the first electronic device 100 and the second electronic device 200) is a first distance (e.g., a distance within a specific length), the first resource management module 123 may set the content policy to a first level (e.g., a first type, a first number, a first depth, a first time, and the like of specified at least one). According to various embodiments, if the current location of the first electronic device 100 is a second specified place (e.g., a relatively more public place than the first place) or if the mutual distance information is a second distance (e.g., a distance which is greater than a specified length or a length which is longer than the first distance), the first resource management module 123 may set the content policy to a second level (e.g., a second type (e.g., a type different from the first type), a second number (a number which is less or greater than the first number), a second depth (e.g., a depth with more steps or fewer steps than the first depth), and a second time (e.g., a time which is longer or shorter than the first time) of specified at least one).

According to various embodiments, the first resource management module 123 may adjust the content policy based on biometric persistent information and a user relationship. For example, the first resource management module 123 may receive user information (e.g., second user information) from the second electronic device 200 and may obtain information who a user of the second electronic device 200 is. The second user information may be, for example, biometric related information. If biometric persistent information is provided and if determining that a specified user operates the second electronic device 200, the first resource management module 123 may allocate the content policy in a different way based on a type of the specified user (e.g., the specified user, a family member, a friend, another, and the like).

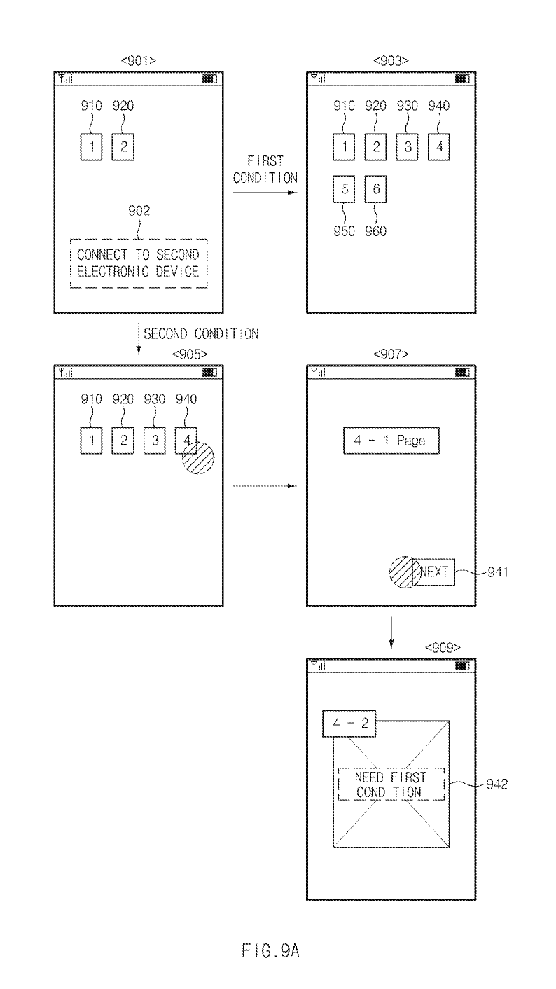

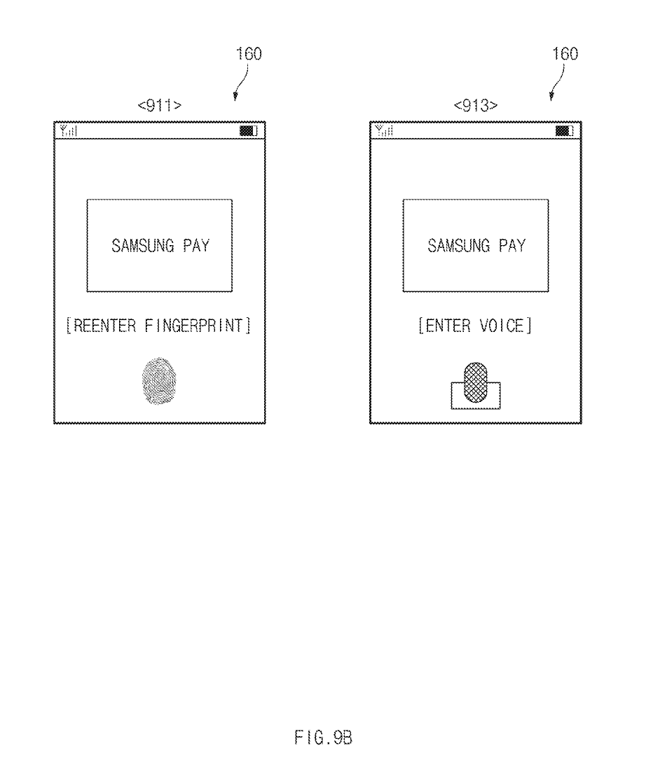

According to various embodiments, if the second electronic device 200 is authenticated, the first resource management module 123 of the first electronic device 100 may receive an authentication result from the second electronic device 200. Also, the first resource management module 123 may further receive usage right request information from the second electronic device 200. The first resource management module 123 may change the content policy based on the received information. FIG. 9A is a drawing illustrating an example of a screen interface associated with adjusting an authentication level according to an embodiment.

Referring to FIG. 9A, in state 901, a first electronic device 100 of FIG. 2A (or a second electronic device 200 of FIG. 2B) may output a basic content policy screen. The basic content policy screen may include, for example, a first icon 910 corresponding to first content (or a first application) and a second icon 920 corresponding to second content (or a second application). According to various embodiments, the basic content policy screen may output a first guide message 902 for a state where the first electronic device 100 connects with the second electronic device 200. According to various embodiments, the first electronic device 100 may output an indicator, indicating the state where the first electronic device 100 connects with the second electronic device 200, together with the first guide message 902 or may output the indicator by being replaced with the first guide message 902. After the first guide message 902 is temporarily output, the first guide message 902 may be removed from a display 160 of FIG. 2A (or a display 260 of FIG. 2B).

When meeting a first specified condition, in state 903, the first electronic device 100 may output a first content policy screen. The first condition may include, for example, at least one of a level of an authentication policy associated with first authentication of a first level, a level of a second authentication policy, a current location of a first place, a first distance from the second electronic device 200, or biometric persistent information of a first form. The first content policy screen may include icons 910, 920, 930, 940, 950, and 960 corresponding to a variety of content (or applications). According to various embodiments, if a user of the second electronic device 200 is the same person as that of the first electronic device 100, the first electronic device may determine that the first condition is met and may output the first content policy screen.

When meeting a second specified condition, in state 905, the first electronic device 100 may output a second content policy screen. The second condition may include, for example, at least one of a level of an authentication policy associated with first authentication of a second level (e.g., an authentication level or a security level which is lower than the first level), a level of a second authentication policy, a current location of a second place (e.g., a relatively more public place than the first place), a second distance from the second electronic device 200 (e.g., a distance which is longer than the first distance), or biometric persistent information of a second form (in which a degree of security is relatively low, easy, or simple). If the first form is fingerprint information or iris information, the second form may include, for example, pulse information. The second content policy screen may include the icons 910, 920, 930, and 940 corresponding to a variety of content (or applications). If the user of the second electronic device 200 is an acquaintance or another, the first electronic device 100 may determine that the second condition is met and may output the second content policy screen.

As described above, if there is an environment with a relatively low security level (e.g., if a degree of authentication is relatively low, if the first electronic device 100 is located in a relatively public place, if a mutual distance between the first electronic device 100 and the second electronic device 200 is relatively long, if biometric persistent information is not provided, or if biometric persistent information relatively easily obtained is provided), the first electronic device 100 may provide a content policy to be lower (e.g., provide the number of accessible content to be fewer and provide a type of accessible content as non-security content).

In state 905, if a specific icon, for example, the fourth icon 940 is selected, the first electronic device 100 may output an execution screen corresponding to the selection of the fourth icon 940 in state 907. According to various embodiments, a depth of content associated with the fourth icon 940 may include a plurality of steps. For example, the execution screen associated with executing the fourth icon 940 may include an execution initial screen and another screen associated with an additional input. Thus, the first electronic device 100 may provide screens corresponding to a plurality of depth steps based on the additional input. The execution screen shown in state 907 may be the screen corresponding to a first depth on an execution screen of the fourth icon 940. The screen corresponding to the first depth may include, for example, a virtual movement button 941 associated with a next depth or outputting related another screen.

If the virtual movement button 941 is selected, in state 909, the first electronic device 100 may output a screen corresponding to a second depth. In such operation, the first electronic device 100 may output a second guide message 942 for providing notification that an output of the screen corresponding to the second depth is limited. For example, the first electronic device 100 may request to satisfy the first condition in connection with outputting the screen corresponding to the second depth. Alternatively, if the fourth icon 940 is executed by meeting the second condition, the first electronic device 100 may apply a second authentication policy in connection with outputting the screen corresponding to the second depth. According to an embodiment, the first electronic device 100 may apply the second authentication policy (e.g., a request to authenticate a fingerprint, a request to authenticate an iris, and a request to adjust a mutual distance between the first electronic device 100 and the second electronic device 200). According to various embodiments, if the fourth icon 940 is requested to be executed in state 903 where the first condition is met, in state 907, if the virtual movement button 941 is selected, the first electronic device 100 may normally output the screen corresponding to the second depth on a display 160 of FIG. 2A (or a display 260 of FIG. 2B).

FIG. 9B is a drawing illustrating an example of a screen interface associated with a second authentication policy according to an embodiment.

Referring to FIG. 9B, according to various embodiments, if a current location of a first electronic device 100 of FIG. 2A is a second specified place (e.g., a relatively public place such as a company) after first authentication (e.g., fingerprint authentication) or if a distance from the second electronic device 200 is a second distance (e.g., a distance which is greater than a specified length or a distance which is longer than a first distance), the first electronic device 100 may determine that a second condition is met. In state 911 in response to meeting the second condition, the first electronic device 100 may output a screen to which a second authentication policy based on biometric information is applied. For example, the first electronic device 100 may apply the second authentication policy configured to reenter a fingerprint.

According to various embodiments, in state 913 in response to meeting the first condition, the first electronic device 100 may output a screen to which the second authentication policy based on a voice is applied. For example, the first electronic device 100 may apply the second authentication policy configured to enter a specified voice. According to various embodiments, if a current location of the first electronic device 100 is a first place in a state where biometric persistent information (e.g., a zone within a specified time after pulse information is entered or fingerprint authentication is performed) and if a distance from the second electronic device 200 is a first distance, the first electronic device 100 may determine that the first condition is met.

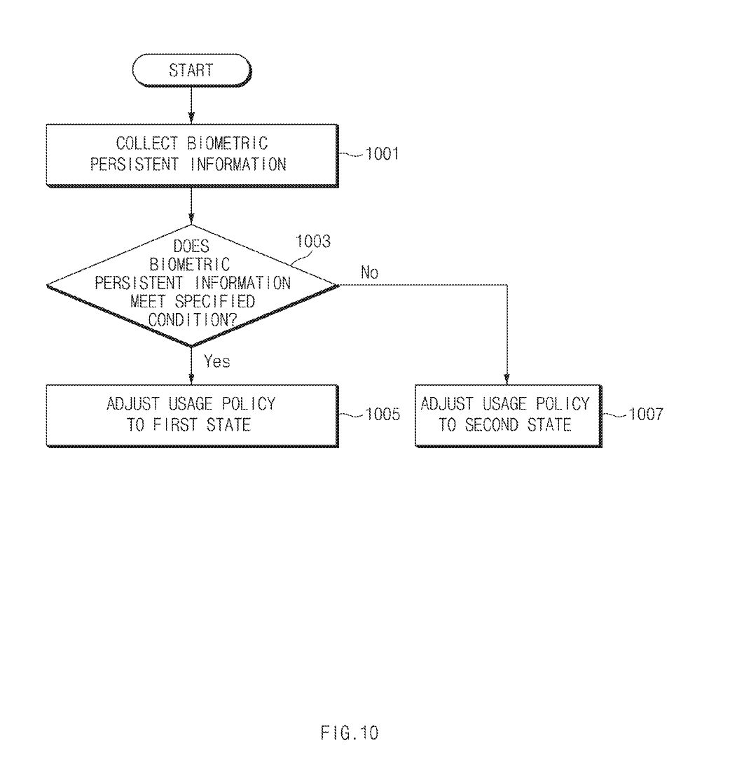

FIG. 10 is a flowchart illustrating a method for adjusting a usage policy based on biometric persistent information according to an embodiment.

Referring to FIG. 10, in connection with the method for adjusting the usage policy, in operation 1001, a first resource management module 123 of a first electronic device 100 of FIG. 2A may collect biometric persistent information from a second electronic device 200 of FIG. 2B. For example, the first resource management module 123 may collect biometric persistent information (e.g., biometric information obtained in real time or at a period, for example, pulse information, and fingerprint information or iris information obtained at a period, and the like). Alternatively, the first resource management module 123 may collect biometric persistent information collected by the second electronic device 200.

In operation 1003 the first resource management module 123 may obtain information of whether the biometric persistent information meets a specified condition. For example, the first resource management module 123 may obtain information of whether a persistent degree of providing the biometric persistent information is persistent within a time range. Alternatively, the first resource management module 123 may obtain information whether the frequency of providing the biometric persistent information is greater than or equal to a specified value within a time range. Alternatively, the first resource management module 123 may obtain information of whether a complex degree of the collected biometric persistent information meets a specified condition (e.g., a condition indicating whether fingerprint information is input in a state where pulse information is continuously detected or whether iris information is input in a state where the pulse information is continuously detected). Also, the first resource management module 123 may obtain information of whether a type of the biometric persistent information meets a specified condition (e.g., whether a security level is relatively middle and high grade if each or combinations of an iris and a fingerprint are received).

If the biometric persistent information meets the specified condition, in operation 1005, the first resource management module 123 may adjust a usage policy to a first state. For example, the first resource management module 123 may provide at least one of a level of an authentication policy or a level of a second authentication level to be relatively lower. Alternatively, the first resource management module 123 may provide a content policy to be relatively higher (e.g., provide the content policy to use relatively more content or to use content with relatively high security degree).

If the biometric persistent information does not meet the specified condition, in operation 1007, the first resource management module 123 may adjust the usage policy to a second state (e.g., adjust a level of the usage policy to be relatively higher than the first state). For example, the first resource management module 123 may provide at least one of the level of the authentication policy or the level of the second authentication policy to be relatively higher than the first state. Alternatively, the first resource management module 123 may provide a content policy to be relatively lower (e.g., provide the content policy to use relatively less content than the first state or to use only relatively lower security degree or non-security content).

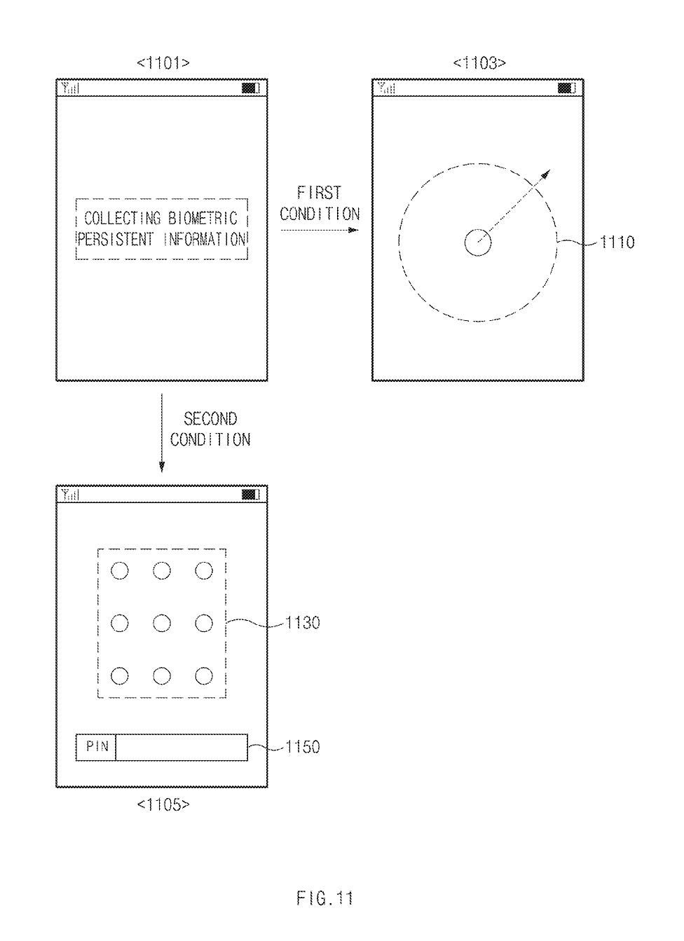

FIG. 11 is a drawing illustrating an example of a screen interface associated with adjusting an authentication level according to an embodiment.

Referring to FIG. 11, a first resource management module 123 of a first electronic device 100 of FIG. 2A may collect biometric persistent information based on settings. Alternatively, the first resource management module 123 may receive biometric persistent information from a second electronic device 200 of FIG. 2B. According to various embodiments, in state 1101, the first resource management module 123 may output a collection guide message (e.g., a message indicating that the biometric persistent information is being collected) corresponding to the biometric persistent information on a display 160 of FIG. 2A (or a display 260 of FIG. 2B). Alternatively, the first resource management module 123 may omit to output the collection guide message.

If the biometric persistent information is collected, the first resource management module 123 may obtain information of whether the collected information meets any condition. For example, if the collected biometric persistent information meets a first specified condition (e.g., if pulse information is continuously provided and if a time when an input of fingerprint information elapses is a specified time), in state 1103, the first resource management module 123 may output a first authentication policy object 1110 of an unlock type by a screen touch on the display 160 (or the display 260). The first condition may vary according to settings. For example, the first condition may include a condition in which a specified type of biometric persistent information is obtained, in a state where the first resource management module 123 is located in a first specified place or where mutual distance information between the first electronic device 100 and the second electronic device 200 is within a first distance.

According to various embodiments, if the collected biometric persistent information meets a second specified condition (e.g., if pulse information is continuously provided and if a time when an input of iris information elapses is a specified time), in state 1105, the first resource management module 123 may output a second authentication policy object 1130 of a lock pattern release type and the third authentication policy object 1150 of a specified number input type on the display 160 or the display 260. The second condition may vary according to settings. For example, the second condition may include a condition in which a specified type of biometric persistent information is obtained, in a state where the first resource management module 123 is located in a second specified place (e.g., a relatively more public place than the first place) or where mutual distance information between the first electronic device 100 and the second electronic device 200 is within a second distance (e.g., a distance which is longer than the first distance). Alternatively, if the specified biometric persistent information is not obtained, the first resource management module 123 may output a screen in state 1105. The first authentication policy object 1110, the second authentication policy object 1130, and the third authentication policy object 1150 may vary according to settings or an applied authentication scheme. Also, the pulse information may be replaced with other biometric information continuously sensed. For example, the pulse information may be replaced with biometric information (e.g., body temperature information, heartbeat information, and the like) which may be obtained in a state where a user of the second electronic device 200 continuously wears the second electronic device 200.

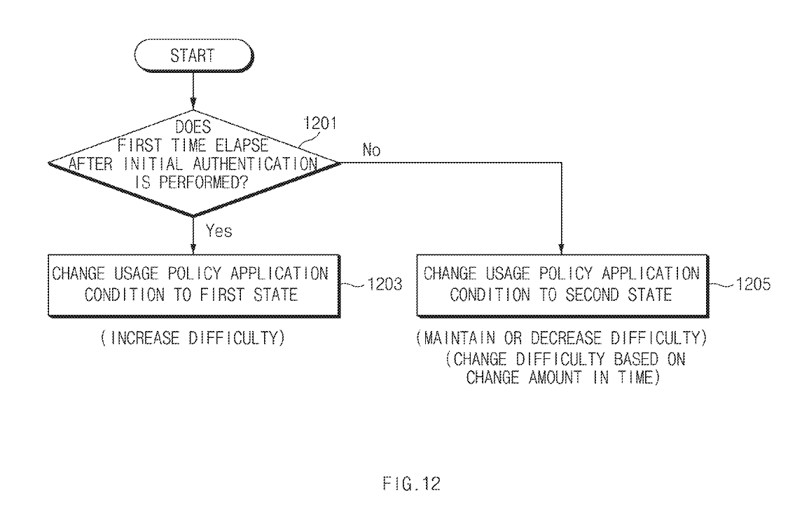

FIG. 12 is a flowchart illustrating a method for changing a time-based usage policy application condition according to an embodiment.

Referring to FIG. 12, in operation 1201, a first resource management module 123 of a first electronic device 100 of FIG. 2A may determine whether a first time elapses after first authentication is performed. The first time may vary according to settings or a user input.

If the first time elapses after the first authentication is performed, in operation 1203, the first resource management module 123 may change a usage policy application condition to a first state. For example, if applying a usage policy based on a distance from a second electronic device 200 of FIG. 2B, the first resource management module 123 may change the distance to a first distance. According to an embodiment, the first distance may be a distance which is shorter than before the first time elapses. If the first time does not elapse after the first authentication is performed, in operation 1205, the first resource management module 123 may change the usage policy application condition to a second state. For example, if applying the usage policy based on a distance from the second electronic device 200, the first resource management module 123 may change the distance to a second distance (e.g., a distance which is longer than the first distance). As described above, if a specified time does not elapses after authentication is completed, the first resource management module 123 may apply a relatively low authentication level (e.g., unlocking by a screen touch) although a distance from the second electronic device 200 is relatively distant. If the specified time elapses, the first resource management module 123 may apply a low authentication level (e.g., unlocking by a screen touch) if the second electronic device 200 is located within a distance and may apply a high authentication level (e.g., fingerprint authentication) if the second electronic device 200 departs from the distance.

According to various embodiments, if the first resource management module 123 is configured to change the usage policy based on a type of a current location in a state where biometric persistent information is provided, the first resource management module 123 may set the same usage policy application condition for first and second specified places in a state where the specified time does not elapse after the first authentication is performed. According to various embodiments, if the specified time elapses after the first authentication is performed, the first resource management module 123 may set different usage policy application conditions for the first place and the second place. For example, if the specified time does not elapse after the first authentication is performed, the first resource management module 123 may apply the same authentication level (e.g., unlocking by a screen touch) to the first place (e.g., a relatively private place such as a home, a room, or an office of a user) and the second place (e.g., a public place which departs from his or her home or office). If the specified time elapses after the first authentication is performed, the first resource management module 123 may apply a relatively low authentication level (e.g., unlocking by a screen touch) to the first place and may apply a relatively high authentication level (e.g., a password input) to the second place.

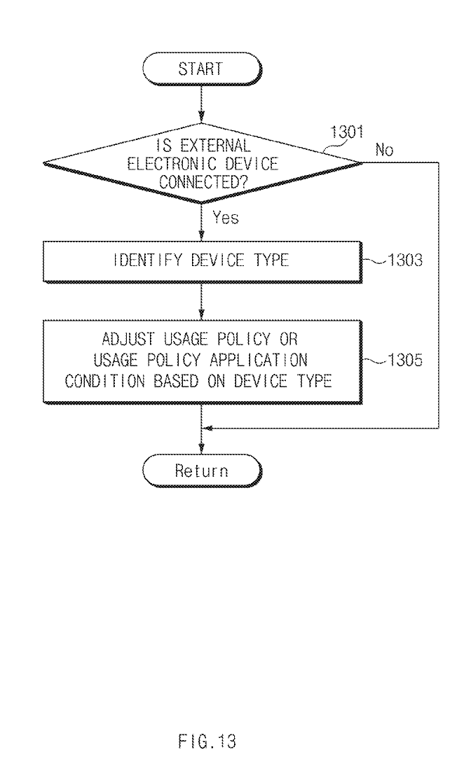

FIG. 13 is a flowchart illustrating a method for operating a usage policy based on a device type according to an embodiment.

Referring to FIG. 13, in connection with the method for operating the usage policy, in operation 1301, a second resource management module 221 of a second electronic device 200 of FIG. 2B may determine whether the second electronic device 200 connects with at least one external electronic device (e.g., peripheral household appliances, electronic devices, and the like) in a state where biometric persistent information is collected. If the second electronic device 200 is not connected with the external electronic device, operation 1303 or 1305 may be skipped.

If the second electronic device 200 connects with the at least one external electronic device, in operation 1303, the second resource management module 221 may obtain information of a device type. In this regard, the second resource management module 221 may perform the operation of determining whether the second electronic device 200 connects with the at least one external electronic device. According to an embodiment, the second resource management module 221 may determine whether at least one external device exists around the second electronic device 200 using a short-distance communication module. If an external electronic device which establishes a short-distance communication channel with the second electronic device 200 is found, the second resource management module 221 may identify a type of the external electronic device. In this regard, the second resource management module 221 may store and manage a database associated with the type of the external electronic device in a second memory 230 of FIG. 2B. Alternatively, the second resource management module 221 may inquire a type of the external device of a specified server device and may receive information about the type of the external electronic device from the corresponding server device.

If identifying the type of the external electronic device, in operation 1305, the second resource management module 221 may adjust a usage policy or a usage policy application condition based on the device type. For example, if the second electronic device 200 is located in a specified location (e.g., a home) in a state where biometric persistent information (e.g., biometric persistent information collected by the second electronic device 200) is provided, the second resource management module 221 may set at least one of a level of an authentication policy, a level of a second authentication policy, a content policy, or a usage policy application condition to be lower (or higher), based on the type of the external electronic device. Also, the second resource management module 221 may set at least one of a level of an authentication policy of the external electronic device, a level of a second authentication policy of the external electronic device, a content policy of the external electronic device, or a usage policy application condition of the external electronic device based on at least one of information indicating whether biometric persistent information is provided, a current location of a first electronic device 100 of FIG. 2A, a mutual distance between the first electronic device 100 and the second electronic device 200, or the type of the external electronic device.

According to an embodiment, if the connected external electronic device has a first type, the second resource management module 221 may apply a first specified usage policy to the external electronic device of the first type. According to various embodiments, if the connected external electronic device is a portable electronic device, the second resource management module 221 may apply an authentication policy executed in the portable electronic device to unlocking by a screen touch or an authentication policy based on a lock pattern (or a second authentication policy after the authentication policy is released) to use the portable electronic device. Also, if the connected external electronic device is a kitchen utensil and is controlled from a remote place, the second resource management module 221 may apply an authentication policy to request to enter a password in connection with entering a menu of the external electronic device. Alternatively, the second resource management module 221 may apply an authentication policy executed in the kitchen utensil to authentication by a password input.

Further, the second resource management module 221 may apply a second authentication policy based on a type of a menu. For example, if the external electronic device is an electronic device used in a kitchen and if a specified time is exceeded after an authentication policy is released, the second resource management module 221 may apply the second authentication policy (e.g., a password reentering input, a fingerprint input request, or the like) to at least one of the second electronic device 200 or a kitchen utensil to use the kitchen utensil again.

According to various embodiments, the second resource management module 221 may limit an authentication policy, a second authentication policy, a menu operation, and the like based on at least one of a current location of the second electronic device 200 or a mutual distance between the second electronic device 200 and the connected external electronic device. For example, the second resource management module 221 may send obtained user information (e.g., biometric related information and a biometric authentication result) to the external electronic device (e.g., a kitchen utensil). A processor included in the external electronic device may obtain the user information and space information (e.g., current location information) and may change a usage policy (e.g., an authentication policy and an operation range policy) of a kitchen utensil.

According to various embodiments, if the second electronic device 200 is located in a kitchen (or if the mutual distance between the second electronic device 200 and the external electronic device is within a first specified distance), the second resource management module 221 may set a level of an authentication policy of the connected external electronic device (e.g., a kitchen utensil) to be lower. Also, if the second electronic device 200 is not located in the kitchen (or if the mutual distance between the second electronic device 200 and the external electronic device is greater than the first specified distance), the second resource management module 221 may set a level of an authentication policy of the connected external electronic device to be higher.

According to various embodiments, if the connected external electronic device has a second type, the second resource management module 221 may apply a second specified usage policy to the external electronic device of the second type. For example, if the connected external electronic device is a fixed content player (e.g., a TV, an audio, a projector, a desktop computer, or the like), the second resource management module 221 may apply an authentication policy based on a password input (e.g., a second authentication policy after an authentication policy is released). Alternatively, if a distance from the connected external electronic device is within a first distance or if the second electronic device 200 is located in a specified location (e.g., a living room or a main room), the second resource management module 221 may set a level of an authentication policy of the fixed content player to be relatively lower. For example, the second resource management module 221 may not apply an authentication policy or a second authentication policy of the fixed content player.

According to various embodiments, if the external electronic device of the first type (e.g., a portable electronic device) connects with the second electronic device 200 in a state where biometric persistent information is provided, the second resource management module 221 may set a threshold distance associated with changing a level of an authentication policy of the external electronic device of the first type, a level of a second authentication policy of the external electronic device of the first type, a level of a content usage policy of the external electronic device of the first type to first mutual distance (e.g., a distance between the second electronic device 200 and the external electronic device). According to various embodiments, if the external electronic device of the second type (e.g., a kitchen utensil and the like) connects with the second electronic device 200 in a state where biometric persistent information is provided, the second resource management module 221 may set a threshold distance associated with changing a level of an authentication policy of the external electronic device of the second type, a level of a second authentication policy of the external electronic device of the second type, and a level of a content usage policy of the external electronic device of the second type to second mutual distance information (e.g., a distance which is shorter than the first mutual distance information).

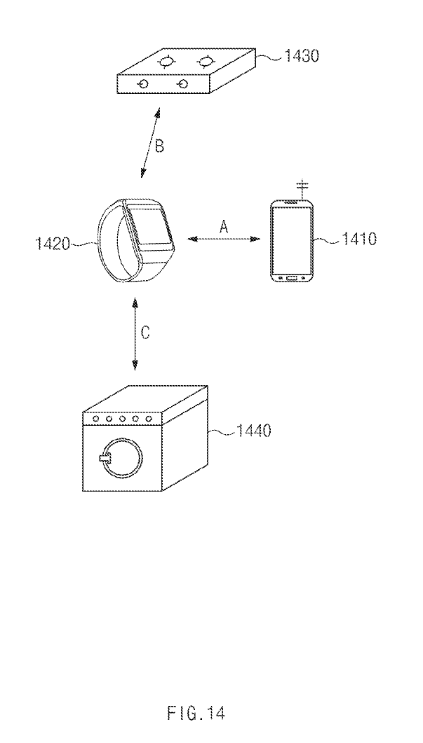

FIG. 14 is a drawing illustrating an example of a system for operating a usage policy for each external electronic device according to an embodiment.

Referring to FIG. 14, a second electronic device 1420 may have a wearing state to collect biometric persistent information of the user of the second electronic device 1420. The second electronic device 1420 may search at least one external electronic device in real time, periodically, or based on its current location. If the first electronic device 1410, a first external electronic device 1430, and the second electronic device 1440 are found by performing the device search, the second electronic device 1420 may identify types of the external electronic devices. If a type of the first electronic device 1410 is identified, the second electronic device 1420 may send biometric information and a right request to the first electronic device 1410 to change a usage policy of the first electronic device 1410.

According to various embodiments, if each of the first electronic device 1410, the first external electronic device 1430, and the second external electronic device 1440 connects with the second electronic device 1420, they may provide their respective identification information to the second electronic device 1420. Alternatively, the second electronic device 1420 may determine the types of the external electronic devices based on information provided from the first electronic device 1410, the first external electronic device 1430, and the second external electronic device 1440, previously stored information, or information verified through a web search.

The second electronic device 1420 may apply a first usage policy (e.g., at least one of a first authentication policy, a first second authentication policy, or a first content usage policy) to the connected first electronic device 1410. The second electronic device 1420 may apply a second usage policy (e.g., at least one of a second authentication policy, a second authentication policy, or a second content usage policy) to the connected first external electronic device 1430. The second electronic device 1420 may apply a third usage policy (e.g., at least one of a third authentication policy, a third second authentication policy, or a third content usage policy) to the connected second external electronic device 1440. At least some of the first usage policy, the second usage policy, and the third usage policy may be the same as each other or may be different from each other.

According to various embodiments, the second electronic device 1420 may apply a first usage policy application condition (e.g., an authentication policy for requesting a specified authentication scheme in a communicable distance) to the connected first electronic device 1410. The second electronic device 1420 may apply a second usage policy application condition (e.g., an authentication policy for requesting a specified authentication scheme within a first distance which is shorter than the communicable distance) to the connected first external electronic device 1430. The second electronic device 1420 may apply a third usage policy application condition (e.g., an authentication policy for requesting a specified authentication scheme within a range which is narrower than the communicable distance and is wider than the first distance) to the connected second external electronic device 1440.

According to various embodiments, a method for adjusting a usage policy may include collecting biometric persistent information detected within a specified time range, collecting operation state information including at least one of a distance from an external electronic device, a type of a zone to which a current location of an electronic device belongs, previous authentication history, or a type of the external electronic device, and adjusting a usage policy associated with access to a function of the electronic device based on the operation state information.

According to various embodiments, the adjusting of the usage policy may include adjusting the usage policy in a different way based on at least one of a type of the biometric persistent information, an elapsed time from a time when the biometric persistent information is collected, complexity of the biometric persistent information, or a complex degree of the biometric persistent information.

According to various embodiments, the adjusting of the usage policy may include adjusting a level of the usage policy in a different way in response to a size of a distance value from the external electronic device.

According to various embodiments, the adjusting of the usage policy may include adjusting a level of the usage policy to be relatively higher if a distance close to the external electronic device is relatively longer and adjusting the level of the usage policy to be relatively lower if the distance close to the external electronic device is relatively shorter.

According to various embodiments, the adjusting of the usage policy may include classifying a type of the zone based on communication access information in the zone or local information mapped to a location of the electronic device and adjusting a level of the usage policy in a different way based on the type of the zone.

According to various embodiments, the adjusting of the usage policy may include adjusting a level of a usage policy of the electronic device in a relatively private place to be relatively lower and adjusting the level of the usage policy of the electronic device in a relatively public place to be relatively higher.

According to various embodiments, the adjusting of the usage policy may include adjusting at least one of a level of an authentication policy associated with authenticating the electronic device in response to the operation state information, a level of a second authentication policy associated with second authentication applied while the electronic device is operated after first authentication, or a level of a content policy associated with a content access range.

According to various embodiments, the adjusting of the usage policy may include adjusting a level of the usage policy to be subsequently applied to be lower if an authentication policy level of previous authentication is higher and adjusting the level of the usage policy to be subsequently applied to be higher if the authentication policy level of the previous authentication is lower.

According to various embodiments, the collecting of the operation state information may include receiving the biometric persistent information from the external electronic device.

According to various embodiments, the method may further include sensing biometric persistent information within a specified time range.

According to various embodiments, a method for adjusting a usage policy may include collecting biometric persistent information within a specified time range (e.g., detecting, by an electronic device, biometric persistent information or receiving, by the electronic device, the biometric persistent information from an external electronic device) and adjusting a length of a threshold distance for applying a change in usage policy based on at least one of the biometric persistent information, a type of a zone to which a current location of the electronic device belongs, previous authentication history, or a type of the external electronic device.

According to various embodiments, the adjusting of the length of the threshold distance may include classify the type of the zone based on an access point (AP) installed in the zone and adjusting the length of the threshold distance in a different way based on the type of the zone.

According to various embodiments, the adjusting of the length of the threshold distance may include adjusting the threshold distance to be relatively shorter if the zone is a relatively public place and adjusting the threshold distance to be relatively longer if the zone is a relatively private place.

According to various embodiments, the adjusting of the length of the threshold distance may include adjusting the threshold distance to be longer if complexity or a complex degree of the biometric persistent information is higher and adjusting the threshold distance to be shorter if the complexity or complex degree of the biometric persistent information is lower.

According to various embodiments, the adjusting of the length of the threshold distance may include adjusting the threshold distance to be longer if an authentication policy level of previous authentication is higher and adjusting the threshold distance to be shorter if the authentication policy level of the previous authentication is lower.

According to various embodiments, the adjusting of the length of the threshold distance may include identifying a user relationship between a first user of the electronic device and a second user of the external electronic device and adjusting the threshold distance in a different way based on the user relation.

According to various embodiments, the adjusting of the length of the threshold distance may include adjusting the threshold distance to be longer if the user relationship is a specified user relationship and adjusting the threshold distance to be shorter if there is no information about the user relationship or if the user relationship is not the specified user relationship.

According to various embodiments, the adjusting of the length of the threshold distance may include obtaining user information by comparing the obtained biometric persistent information with stored biometric persistent information and identifying a relationship with a user of the external electronic device based on the obtained user information and stored user relationship information.

According to various embodiments, the adjusting of the length of the threshold distance may include adjusting the threshold distance to be shorter if a type of the external electronic device is a first specified type and adjusting the threshold distance to be longer if the type of the external electronic device is a second specified type.

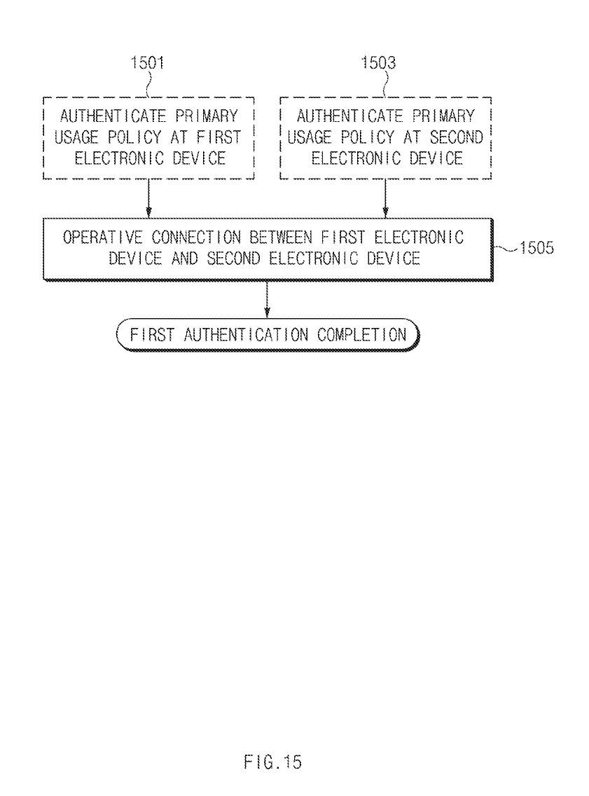

FIG. 15 is a flowchart illustrating an example of a method for performing an authentication policy according to an embodiment.

Referring to FIG. 15, in connection with the method for performing the authentication policy, in operation 1501, a first electronic device (e.g., a first resource management module 123 of a first electronic device 100 of FIG. 2A) may perform processing associated with authenticating a primary usage policy. For example, the first electronic device may output a user interface corresponding to the primary usage policy (e.g., unlocking by a screen touch, a password input, an unlock pattern input, fingerprint authentication, or the like). If receiving an input signal associated with releasing the primary usage policy, the first electronic device may complete authentication of the primary usage policy and may change a current state to a specified state (e.g., an output state of a home screen or an output state of a specified application execution screen).

During operation 1501 or irrespective of an order, in operation 1503, a second electronic device (e.g., a second electronic device 200 of FIG. 2B) may perform processing associated with authenticating a primary usage policy. The primary usage policy of the second electronic device may be the same or different from the primary usage policy of the first electronic device. If the primary usage policy of the second electronic device is different from the primary usage policy of the first electronic device, for example, the second electronic device may output a user interface corresponding to the primary usage policy (e.g., collecting specified biometric information and inputting a specified voice signal). If an input signal associated with the authentication of the primary usage policy occurs, the second electronic device may change a current state to a specified state according to the authentication of the primary usage policy.

In operation 1505, the first electronic device and the second electronic device may perform an operative connection. In this regard, the first electronic device or the second electronic device may perform an ambient search to determine whether there is a companion device (e.g., the second electronic device in view of the first electronic device or the first electronic device in view of the second electronic device). If the companion device is found, the first electronic device or the second electronic device may perform an operative connection (e.g., a communication connection). According to various embodiments, the first electronic device and the second electronic device may connect with each other by a wired type. If the first electronic device and the second electronic device connect with each other, the first electronic device and the second electronic device may complete authentication of the primary usage policy. In this regard, the first electronic device and the second electronic device may share the authenticated result with each other. Thus, the first electronic device and the second electronic device may grant to use specified content. If the operative connection is not completed, the first electronic device and the second electronic device may grant to use content according to the authentication of the primary usage policy (e.g., use content different from at least part of content provided in an operatively connected state).

According to various embodiments, if the operative connection is completed in a state where biometric persistent information is provided, the first electronic device and the second electronic device may complete authentication. In this regard, the first electronic device and the second electronic device may perform communication for sharing the authenticated result. If the operative connection is completed in a state where the biometric persistent information is not provided, the first electronic device and the second electronic device may grant to use content according to primary authentication. According to various embodiments, the first electronic device and the second electronic device may adjust a usage policy (e.g., a level of an authentication level, a level of a second authentication policy, a content policy, and the like) of the first electronic device or the second electronic device with respect to a current location of the first electronic device or the second electronic device or a distance value between the first electronic device and the second electronic device.

According to various embodiments, when biometric persistent information (e.g., a value indicating a wearing state or biometric information collected within a time range as the first electronic device or the second electronic device is worn) is maintained, the first electronic device or the second electronic device may set at least one of an authentication policy, a second authentication policy, or a content policy in response to a user relationship (e.g., a family member, a friend, or a lover) with the first electronic device or the second electronic device.

According to an embodiment, the first electronic device or the second electronic device may apply a level of a usage policy like Table 1 based on a plurality of steps.

TABLE 1

| | |
|---|---|
| N step | apply complex authentication, such as fingerprint recognition, |
| | iris recognition, face recognition, and motion recognition |
| | authenticated together with biometric persistent information, |
| | including two or more biometric persistent information; |
| | apply a pin code and a password of combinations of alphabets, |
| | numbers, and symbols of a relatively long unit; or |
| | apply watermarked signature recognition and biometric |
| | recognition |
| N − 1 step | apply two or more complex authentication, such as fingerprint |
| | recognition, iris recognition, face recognition, and motion |
| | recognition; apply a pin code and a password of combinations |
| | of alphabets and numbers of a long unit; |
| | apply watermarked signature recognition; |
| | apply direction and pressure pattern lock; or |
| | apply partial authentication of all pin codes |
| . . . | . . . |
| Second | apply a pin code and a password of a length of a middle unit |
| step | t (shorter han the long unit); |
| | apply a pattern lock which has four points or less and has two |
| | directions; |
| | apply a signature; |
| | apply simple biometric authentication such as fingerprint |
| | recognition, iris recognition, and face recognition; or |
| | apply specific digit authentication of all pin codes |
| First | apply non-oriented drag and non-oriented swipe; |
| step | apply unidirectional drag and unidirectional swipe; |
| | apply a pin code and a password of a short unit; |
| | apply a pattern lock which has three points or less or has |
| | one direction; |
| | or |
| | apply first digit authentication of all pin codes |

According to various embodiments, the first electronic device or the second electronic device may apply an accessible application like Table 2 based on a usage policy.

TABLE 2

| application | application based on usage policy | right |
|---|---|---|
| Public level | Camera, Time & Date, calculator, etc. | User, a |
| application | | recognizable |
| | | person of user, |
| | | and |
| | | stranger |
| Opened level | Web browser, call, camera, navigation, | User, and a |
| application | map, etc. | recognizable |
| | | person of user |
| Secure level | Banking, stocking, mobile wallet, | User |
| application | payment, etc. | |
| Private level | Gallery, SMS, email, messenger | User |
| application | application, call log, web history, etc. | |

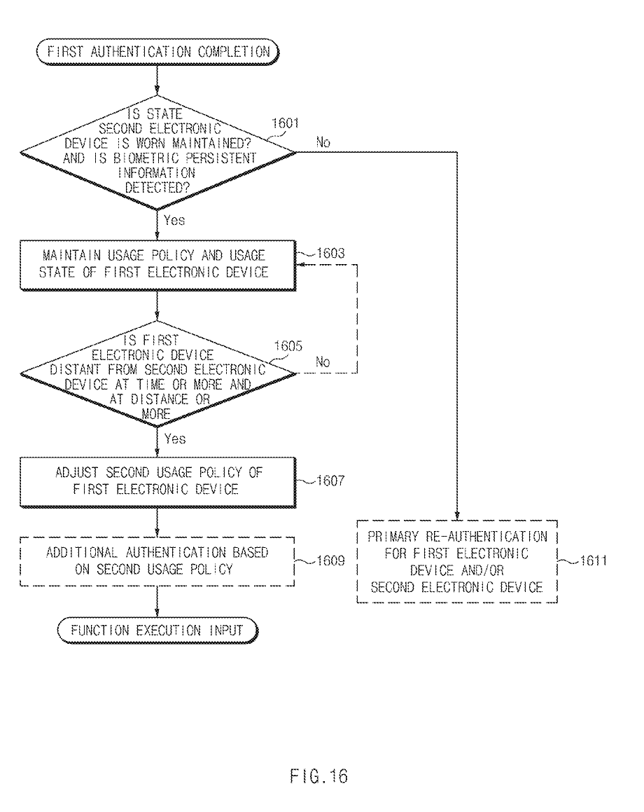

FIG. 16 is a flowchart illustrating an example of a method for changing a usage policy of a first electronic device 100 according to an embodiment.

Referring to FIG. 16, if first authentication described with reference to FIG. 15 is completed, in operation 1601, the first electronic device (e.g., a first resource management module) may determine whether a state where a second electronic device is worn is maintained and biometric persistent information is detected. If the state where the second electronic device is worn is maintained and if the biometric persistent information is detected, in operation 1603, the first resource management module may maintain a usage policy and a usage state.

In operation 1605, the first resource management module may determine whether the first electronic device is distant from the second electronic device at a time or more and at a distance or more. If the first electronic device is not distant from the second electronic device at a specified distance or more, the first electronic device (e.g., the first resource management module) may return to operation 1603 to perform the operation from operation 1603. If the first electronic device is distant from the second electronic device at the time or more or at the distance or more, in operation 1607 the first resource management module may adjust a second usage policy. If the second usage policy of the first electronic device is adjusted, the first resource management module may apply the changed second usage policy to a second authentication policy. Thus, the first resource management module may output a user interface for requesting authentication based on the second authentication policy. In operation 1609, if second authentication according to the second usage policy is completed, the first resource management module may grant to use a device of the first electronic device and may execute a specified function. According to various embodiments, if the first electronic device is distant from the second electronic device at the distance or more, the first resource management module may change a current state to an unavailable state or a usage limit state (e.g., a state accessible to only specified content or application). If a second authentication policy according to the second usage policy is authenticated, the first resource management module may execute a specified function. Alternatively, the first resource management module may change a current state to a preparation step for executing the specified function (e.g., a state where a user input associated with accessing specified content or application is received).

If the state where the second electronic device is worn is not maintained or if the specified biometric persistent information is not detected, in operation 1611, the first resource management module may request to perform primary re-authentication in the first electronic device or the second electronic device. The performing of the primary re-authentication in operation 1611 may correspond to operation 1501 or 1503 described above with reference to FIG. 15.

The first resource management module may apply at least one of a type of authentication policy, a means of the authentication policy, and an amount of authentication information in a different way based on a usage policy. The usage policy may include a policy associated with at least one authentication level. The usage policy may be changed based on a degree of proximity between the first electronic device and the second electronic device, a distance between the first electronic device and the second electronic device, or a current location (e.g., a sharing zone).

According to various embodiments, the first electronic device (or the second electronic device) may reduce the number of authentication types of the first electronic device (or the second electronic device) or may not apply authentication if a degree of proximity or a distance between the first electronic device (or the second electronic device) and the second electronic device (or the first electronic device) are closer to each other. Also, first electronic device (or the second electronic device) may increase the number of the authentication types of the first electronic device (or the second electronic device) if the degree of proximity or the distance between the first electronic device (or the second electronic device) and the second electronic device (or the first electronic device) are more distant from each other. According to various embodiments, the first electronic device may change a content policy (e.g., a content access right).

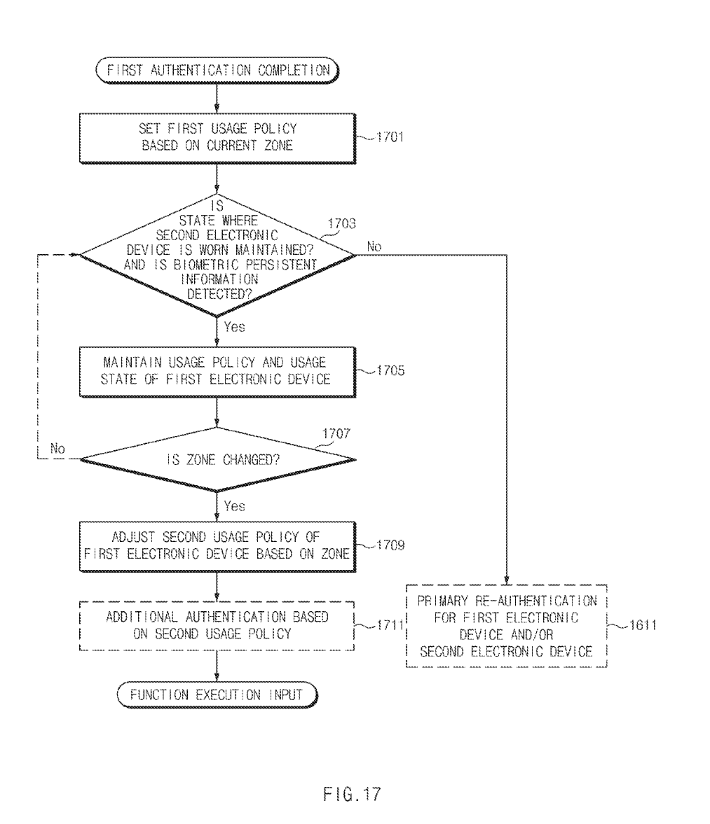

FIG. 17 is a flowchart illustrating an example of a method for applying a location-based usage policy according to an embodiment.

Referring to FIG. 17, in connection with the method for applying the location-based usage policy, if first authentication described with reference to FIG. 15 is completed or independent of the first authentication, in operation 1701, a first resource management module of a first electronic device may set a first usage policy based on a current zone. In this regard, the first resource management module may collect current location information using a location information sensor. The first resource management module may determine whether a current location corresponds to a specified place. In this regard, the first resource management module may store and manage a list or database for place information for each location.

In operation 1703, the first resource management module may determine whether a state where a second electronic device is worn is maintained and whether biometric persistent information is detected. If the state where the second electronic device is worn is maintained and if the biometric persistent information is detected, in operation 1705, the first resource management module may maintain a usage policy and a usage state. In this regard, the second electronic device may send a control signal associated with operating the usage policy of the first electronic device to the first electronic device. If receiving a signal associated with maintaining the usage policy from the second electronic device, the first resource management module may change or maintain a state of a previous usage policy.

In operation 1707, the first resource management module may determine whether a zone is changed. If the zone is not changed, the first resource management module may branch to operation 1703 to perform the operation from operation 1703. In this regard, the first resource management module may collect current location information in real time or at a period and may determine whether a place or a zone is changed.

If the zone is changed, in operation 1709, the first resource management module may adjust a second usage policy based on the zone. For example, the first resource management module may obtain second usage policy information mapped to a current location and may send a control signal corresponding to the verified second usage policy information to the second electronic device. In this regard, the first resource management module may store and manage information about various usage polices in the form of a list or database (e.g., Table 1 above). According to an embodiment, the second usage policy may be a usage policy mapped to the changed area and may be a usage policy different from the first usage policy (e.g., a usage policy with a high or low level).

In operation 1711, the first resource management module may perform second authentication according to the second usage policy. In this regard, the first resource management module may output a user interface to which a second authentication policy is applied and may determine whether a user input is a specified input. The first resource management module may obtain the user input to determine whether the second authentication is completed. Alternatively, the second electronic device may output a user interface to which a second authentication policy is applied, may obtain a user input, and may send the obtained user input to the first electronic device. The first resource management module may determine whether the sent user input is a specified input to determine whether second authentication is completed. If the second authentication is completed, the first resource management module may execute a function based on the completion of the second authentication or may change a current state to a preparation state for executing the function.

If the state where the second electronic device is worn is not maintained and if the biometric persistent information is not detected, at least one of the first electronic device or the second electronic device may perform primary re-authentication (e.g., operations 1501 and 1503) described with reference to FIG. 15.

According to various embodiments, in connection with applying the usage policy based on the zone, the first electronic device or the second electronic device may lower an authentication level in a private space (e.g., a home). For example, the first electronic device or the second electronic device may reduce the number of authentication types or may not apply authentication. Alternatively, the first electronic device or the second electronic device may more increase the number of authentication types in a public space (e.g., a company) than the private space or may maintain the number of specified authentication types or levels of the specified authentication types. The first electronic device or the second electronic device may set an authentication level in an open space (e.g., a subway, a park, the outside, and the like) to be the same or higher than an authentication level in the public space. Also, if the changed second usage policy is higher than a first authentication level, the first electronic device may perform processing associated with second authentication according to the second usage policy. The maintaining operation may include, for example, an operation of requesting again to perform authentication of the same authentication type or level when a zone is changed.

According to various embodiments, the first electronic device (or the first resource management module) (or the second electronic device) may change its authentication to a convenient means if a degree of proximity or a distance between the first electronic device (or the second electronic device) and the second electronic device (or the first electronic device) is closer to each other or if the first electronic device (or the second electronic device) is closer to a relatively private space. Alternatively, the second electronic device (e.g., a second resource management module) may request to change authentication of the first electronic device to a convenient means (e.g., a relatively simple or easy authentication scheme) if a degree of proximity or a distance between the first electronic device and the second electronic device is closer to each other or if the second electronic device is closer to the relatively private space. According to various embodiments, the first electronic device (or the second electronic device) may change its authentication to a difficult means if a degree of proximity or a distance between the first electronic device (or the second electronic device) and the second electronic device (or the first electronic device) is distant from each other or if the first electronic device (or the second electronic device) is distant from the relatively private space. Alternatively, the second electronic device may request to change authentication of the first electronic device to a difficult means (e.g., a relatively complicated authentication scheme) if a degree of proximity or a distance between the first electronic device and the second electronic device is distant from each other or if the second electronic device is closer to the relatively public space (or distant from the relatively private space). According to various embodiments, the means with the convenient authentication may include a pattern lock, face recognition, fingerprint recognition, and the like. The means with the difficult authentication may include iris recognition, ECG-based authentication, and the like. The means with the convenient authentication or the means with the difficult authentication may be relative and may be defined in a different way based on intention of a designer or a user.

According to various embodiments, the first electronic device (or the first resource management module) may reduce an amount of input information for its authentication if a degree of proximity or a distance between the first electronic device and the second electronic device is closer to each other or when the first electronic device is closer to a private space. Alternatively, the second electronic device (or the second resource management module) may reduce an amount of input information for authentication of the first electronic device if a degree of proximity or a distance between the first electronic device and the second electronic device is closer to each other or when the second electronic device is closer to the private space. According to various embodiments, the first electronic device may increase an amount of input information for its authentication if the degree of proximity or the distance between the first electronic device and the second electronic device is distant from each other or when the first electronic device is distant from the private space. Alternatively, the third electronic device may increase an amount of input information for the authentication of the first electronic device if a degree of proximity or a distance between the first electronic device and the third electronic device is distant from each other or when the third electronic device is closer to the private space.

According to an embodiment, if an authentication level is requested to be strengthened in case of a password input (e.g., if the first electronic device (or the second electronic device) is located in a relatively open place), the first electronic device (or the second electronic device) may output a user interface for requesting to enter all of a password of 8 to 10 digits. If the authentication level is a middle level (e.g., if the first electronic device (or the second electronic device) is located in a relatively public place), the first electronic device (or the second electronic device) may output a user interface for requesting to enter a password of only 4 digits. Also, If the authentication level is a low level (e.g., if the first electronic device (or the second electronic device) is located in a relatively private place), the first electronic device (or the second electronic device) may output a user interface for requesting to enter a password of only 2 digits or may omit to output a user interface associated with entering a password.

The user interface associated with the authentication level may include, for example, a lock screen release interface, a user interface associated with an application access code, and a user interface associated with memory access or a document inquiry code. According to various embodiments, the first electronic device or the second electronic device may determine whether to encrypt a message based on mutual distance information or a zone (or a place) to which a current location belongs. Also, the first electronic device may change a security strengthening request level for mutual distance according to a zone. For example, the first electronic device or the second electronic device may set an authentication level in a public place to be higher than a private place although the first electronic device or the second electronic device is located at the same mutual distance as a previous state. Also, the first electronic device may change a content policy (e.g., a content access right).

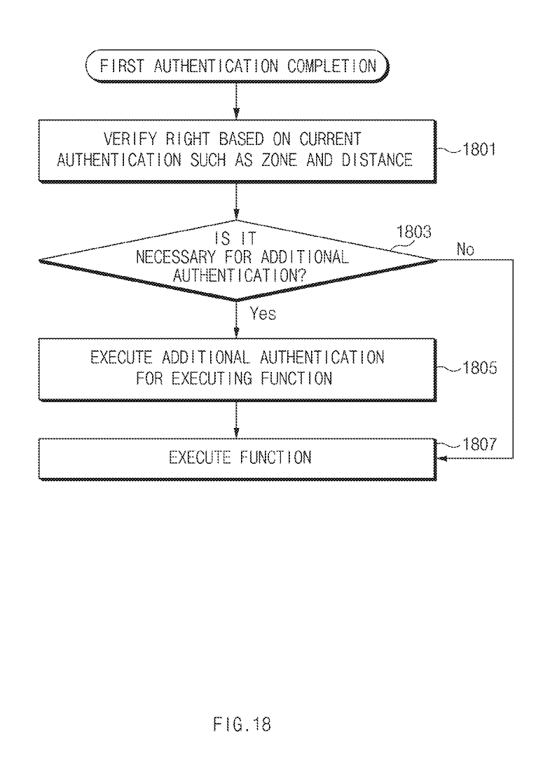

FIG. 18 is a flowchart illustrating a method for applying a usage policy associated with a content policy according to an embodiment.

Referring to FIG. 18, in connection with the method for applying the usage policy associated with the content policy, if receiving a request to execute a function after first authentication described with reference to FIG. 15 is completed (e.g., a request to execute a function corresponding to a user input or a request to execute a specified function), in operation 1801, a first electronic device may obtain information of a right based on current authentication such as a zone and a distance (e.g., a distance from a second electronic device). For example, if the first electronic device is located in a relatively private place or if a distance from the second electronic device is within a first specified distance, the first electronic device may output a user interface associated with a corresponding authentication policy. When the corresponding authentication policy is released, the first electronic device may obtain information of a content access right corresponding to the release of the authentication policy.

In operation 1803, the first electronic device may determine whether it is necessary for second authentication. For example, the first electronic device may obtain information of the verified content access right and a right set to a function requested to be currently executed to determine whether it is necessary for the second request. If it is unnecessary for the second authentication, the first electronic device may skip operation 1805. If it is necessary for the second authentication, in operation 1805, the first electronic device may execute the second authentication for executing a function. For example, the first electronic device may output a user interface associated with the second authentication. The user interface associated with the second authentication may correspond to a specified authentication level. The user interface associated with the second authentication may correspond to an authentication level set based on a zone or a distance.

If the second authentication is completed, in operation 1807, the first electronic device may execute the function based on the completion of the second authentication. If the second authentication is not completed, the first electronic device may keep outputting the user interface associated with the second authentication. Alternatively, the first electronic device may output a guide message for guiding an incorrect user input.

As described above, the method for applying the usage policy according to an embodiment may set a content access right in a different way (e.g., apply the second authentication) based on a function to be executed although authentication of a user interface to which a specified authentication level is applied is released. For example, the first electronic device may support to access specified content (or a resource, an application, and the like of the first electronic device) without the second authentication based on a usage policy application environment or may support to access content through the second authentication.

According to an embodiment, if a specified external electronic device (e.g., the second electronic device, for example, a watch or a head mount display (HMD)) accesses an electronic device (e.g., the first electronic device), the electronic device may collect biometric persistent information from the external electronic device. If the biometric persistent information obtained from the external electronic device is authentication information of a high authentication level (e.g., a means with a relatively high or complicated degree of complexity), for example, if an iris, a fingerprint, and a pulse are authenticated in a complex manner, the electronic device may lower an authentication level or may raise a content access right. For example, the electronic device may grant access to content (or a resource) to request simple drag-based unlocking or request security authentication of a high level without separate second authentication, for example, may automatically log in/off an account and may automatically transmit location information.

According to various embodiments, if the biometric persistent information obtained from the external electronic device is verified as only authentication information (e.g., a pulse) of a low level (a single authentication means) (or if biometric information of another is received), the electronic device may raise an authentication level or may lower a content access right if the external electronic device accesses the electronic device to set not to access specified content or set to access only the specified content (e.g., a guest mode).

According to various embodiments, if the electronic device is set in common (e.g., a TV, a conference progress terminal, and the like in a smart home), the electronic device may obtain biometric persistent information obtained from the external electronic device and may compare the verified biometric persistent information with previously registered authentication information. The electronic device (e.g., a first electronic device or a second electronic device) may change an accessible content grade based on a type of a user of the external electronic device or a relationship with a user of the electronic device as a result of the comparison. For example, if a child wears the external electronic device in his or her home, the electronic device may change a content access right to access only content for child. Also, if a child is located with an adult (e.g., if an electronic device operated by a specified adult accesses the external electronic device by a specified distance), the electronic device may change a content access right to access content for adult.

The content (or resource) access right may include, for example, at least one of the right to execute an application, the right to inquire a document, the right to access a memory, or the right to access a secure memory or a trust memory. The electronic device may provide an access right module classified into a guest mode, a private mode, a low battery mode, a car mode, and the like based on a level (or a grant range) of the content access right. The electronic device may determine whether a payment available account is automatically selected and may determine a payment permissible limit, or may adjust an amount of charged money, based on a level of the content access right.

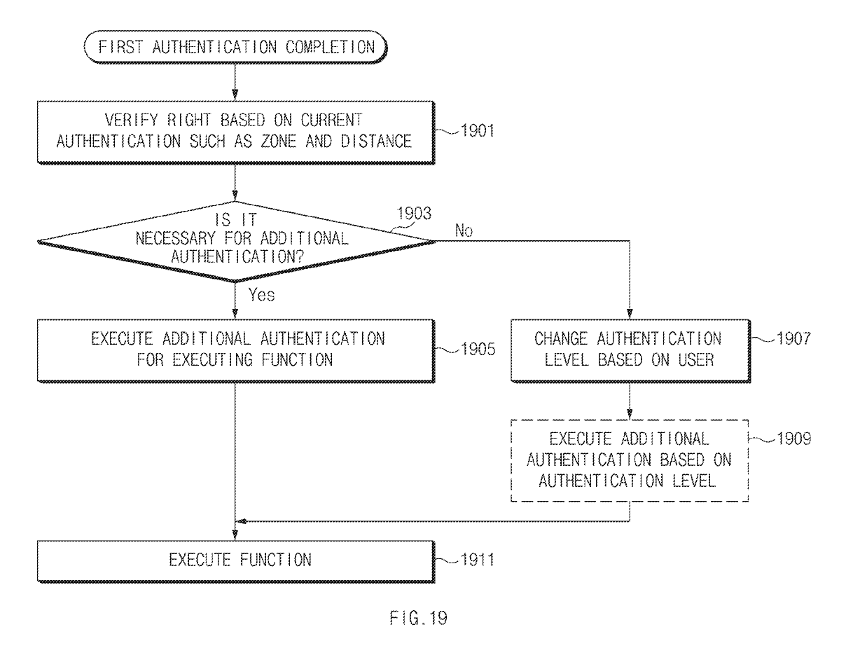

FIG. 19 is a flowchart illustrating a method for applying a usage policy associated with changing an authentication level according to an embodiment.

Referring to FIG. 19, in connection with the method for applying the usage policy, if first authentication is completed like FIG. 15, a first electronic device may perform operations 1901, 1903, and 1905 to be the same or similar to operations 1801, 1803, and 1805 in FIG. 18, respectively. For example, in operation 1901, the first electronic device may obtain information of a right based on current authentication such as a zone or a distance (e.g., a mutual distance between the first electronic device and a second electronic device). In operation 1903, the first electronic device may determine whether it is necessary for second authentication for executing a function. In operation 1905, the first electronic device may perform the second authentication for executing the function.

According to various embodiments, in operation 1903, if it is unnecessary for the second authentication, in operation 1907, the first electronic device may change an authentication level based on the user of the first electronic device. For example, since a right according to current authentication is higher than the right to access content requested to be executed (or a resource requested to be accessed), if it is unnecessary for the second authentication, the first electronic device may identify user information of an external electronic device. In this regard, the first electronic device may receive the user information of the external electronic device from the external electronic device. Alternatively, the first electronic device may store and manage user information associated with at least one external electronic device in its memory. For example, the first electronic device may allocate specified authentication levels to specified user information. When a relationship with the user information is changed (e.g., when the user is registered as a family member, when the user is registered as a friend, when the user is registered as a colleague, and the like), the first electronic device may change an authentication level of the user. According to an embodiment, the first electronic device may identify a relationship with a user of the connected external electronic device based on phonebook data. If the user of the external electronic device is specified user (e.g., a parent, a brother, and the like), the first electronic device may change an authentication level to an authentication level corresponding to the corresponding user.

After the authentication level is changed, if receiving a request to execute the second authentication based on the changed authentication level, in operation 1909, the first electronic device may output a user interface associated with executing the second authentication. If not receiving a request to execute separate second authentication based on the changed authentication level, the first electronic device may skip operation 1909. In operation 1911, the first electronic device may execute the specified function in response to completing the execution of the authentication.

According to various embodiments, the first electronic device may determine a relationship between the user of the first electronic device and the user of the connected second electronic device. The first electronic device may apply an authentication level in a different way in response to the relationship (e.g., a family member, a friend, a colleague, and the like) between the user of the first electronic device and the user of the connected second electronic device. For example, the first electronic device may determine a relationship with the second electronic device based on phonebook information or identification information of the second electronic device, received via its communication module and may set an authentication level of a user (e.g., a familiar member) with relatively high familiarity to be lower than that of a user (e.g., a colleague) with relatively low familiarity.

According to various embodiments, if a specific user operates the second electronic device together, the first electronic device may set an authentication level to be relatively lower. For example, each of the first electronic device and the second electronic device may identify the user of the first electronic device based on collected biometric persistent information. If the user of the first electronic device is the same as the user of the second electronic device, the first electronic device may set an authentication level to be lower or may not apply authentication. According to various embodiments, if the user of the second electronic device is registered as a family member, the first electronic device may apply a specified authentication level. For example, if one of second electronic devices (e.g., wearable devices) is worn by a child and if the other is worn by one of parents, the first electronic device may apply a specified authentication level (e.g., to be higher than that of the same user). According to various embodiments, if the second electronic device is set to be worn by a family member and if the second electronic device accesses the first electronic device within a specific distance, the first electronic device may request additional authentication. According to various embodiments, if a third party uses the second electronic device, the first electronic device may set an authentication level to be relatively higher.

According to an embodiment, if a distance between the first electronic device and the second electronic device is greater than a specified distance and if they is not located in a specified place (e.g., a security area), the first electronic device may change a current mode into a loss mode if a user of the first electronic device is different from the user of the first electronic device, and may execute all functions of the first electronic device at the most strengthening security level or may raise a resource (or content) access right.

If receiving an input associated with an operation in a state where the first electronic device is spaced apart from the second electronic device at a specified distance or more, the first electronic device may determine a current operation mode as an abnormal operation mode. Alternatively, the first electronic device may activate a camera on a periodic or aperiodic basis to perform face recognition. If determined as the abnormal operation mode or if determined as another user based on face recognition, the first electronic device may operate in a loss mode. The first electronic device may send motion information or face recognition information collected in the abnormal operation mode to the second electronic device via the communication module (e.g., a cellular module).

According to various embodiments, if biometric information obtained from the second electronic device (e.g., a watch) is changed or if the second electronic device accesses the first electronic device while biometric information is not detected, the first electronic device may apply a specified authentication level (e.g., the most strengthening authentication or a security level). According to various embodiments, the second electronic device (e.g., the watch) may register a plurality of user information (e.g., family member information) in advance and may share the user information with the first electronic device in advance. The first electronic device may detect biometric information obtained from the second electronic device to determine a real user, may change a security level corresponding to the real user (e.g., a child, an acquaintance, and a relative), and may provide the changed security level.

According to various embodiments, the user may obtain security of an upper level using complex authentication of a terminal upon initial authentication. The user may obtain may obtain the security of the upper level through single or complex authentication such as iris recognition, face recognition, and fingerprint recognition using biometric data other than a conventional pattern lock, a conventional pin code, and a conventional signature lock.

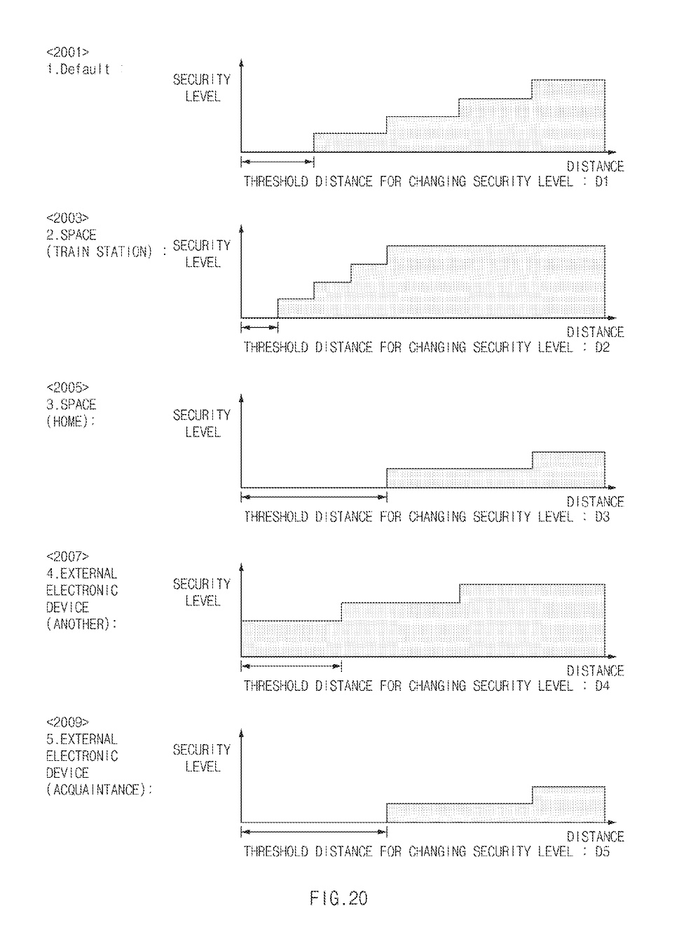

FIG. 20 is a drawing illustrating an example of an operation of changing a usage policy according to an embodiment.

Referring to FIG. 20, a first electronic device may process a time when a usage policy (e.g., an authentication policy or a security level) is changed, based on a distance from a second electronic device. For example, in graph 2001, the first electronic device may set a threshold distance for changing a security level at intervals of D1. Thus, the first electronic device may classify a distance difference from the second electronic device at intervals of D1 and may change a security level of the first electronic device or the second electronic device in response to the number of the classified D1. For example, if the first electronic device is spaced apart from the second electronic device by D1, the first electronic device may apply a first security level. Also, if the first electronic device is spaced apart from the second electronic device by D1X2, the first electronic device may apply a second security level. In the same manner as described above, if the first electronic device is spaced apart from the second electronic device by D1X4, the first electronic device may apply a fourth security level. Thus, the first electronic device may set to have a relatively higher security level if the first electronic device is more distant from the second electronic device. Graph 2001 represents a change in security level automatically or based on a default setting. The threshold distance of the security level may be changed in response to, for example, a current location of the first electronic device or the second electronic device in a state where biometric persistent information is provided.

According to an embodiment, in graph 2003, if the first electronic device (or the second electronic device) is located in a relatively open place (e.g., a train station), the first electronic device may set a threshold distance for changing a security level to D2 which is shorter than D1. Thus, the first electronic device may apply a relatively high security level, although the first electronic device is spaced apart from the second electronic device to be relatively shorter than graph 2001.

According to an embodiment, in graph 2005, if the first electronic device (or the second electronic device) is located in a relatively private place (e.g., a home), the first electronic device may set the threshold distance for changing the security level to D3 which is longer than D1. Thus, the first electronic device may apply a relatively low security level, although the first electronic device is spaced apart from the second electronic device to be relatively longer than graph 2001. Also, the first electronic device may set magnitude of each security level or the entire security level to be lower than graph 2001 or graph 2003.

According to an embodiment, in graph 2007, if a user of the second electronic device is an unregistered user (e.g., another), the first electronic device (or the second electronic device) may set the threshold distance for changing the security level to D4. If the unregistered user uses the second electronic device, the first electronic device may set magnitude of each security level or the entire security level to be relatively higher. Alternatively, if determining that another uses the second electronic device, the first electronic device may process the threshold distance for changing the security level in an unequal manner. For example, the first electronic device may set a first security level application distance to D2 and may process a current mode as a loss mode if the second electronic device departs from the first electronic device by D2 or more. When processing the current mode as the loss mode, the first electronic device may be in a state where it is not possible to operate the second electronic device. The classification of the user of the second electronic device may be performed by comparing biometric persistent information provided from the second electronic device with previously stored data. Alternatively, the second electronic device may operate its camera to recognize a face of the user of the second electronic device and may determine whether the user is a previously registered user. The second electronic device may send the determined information to the first electronic device.

According to an embodiment, in graph 2009, if the user of the second electronic device is a registered user (e.g., an acquaintance), the first electronic device (or the second electronic device) may set the threshold distance for changing the security level to D5 which is longer than D4 in graph 2007. Also, if the registered user uses the second electronic device, the first electronic device may set magnitude of each security level or the entire security level to be relatively lower than graph 2007. The security level of the first electronic device may be changed based on, for example, a state where at least one of the first electronic device or the second electronic device collects biometric persistent information.

As described above, the electronic device may proceed with complex authentication (e.g., at least one type of user input, for example, a biometric authentication, pattern, or information input) and may allow a wearable device (e.g., the second electronic device) worn by the user of the electronic device to recognize biometric persistent information. The electronic device may change a second authentication level based on a difference of zone information and distance (e.g., a distance from the second electronic device) according to its current location to simultaneously enhance security and convenience of the user.

The above-mentioned electronic device (e.g., the first electronic device 100 of FIG. 2A or the second electronic device 200 of FIG. 2B) may perform initial user authentication through biometric recognition. The electronic device may provide, for example, a user interface associated with an upper security level which uses biometric data authentication, a pattern lock, a pin code, a signature, and the like in a single or complex manner.

In connection with obtaining biometric recognition data, the electronic device may obtain fingerprint data via a fingerprint sensor and may obtain biometric data through biometric authentication of the user such as iris and face recognition via its camera. In connection with fingerprint authentication, the electronic device may obtain information together associated with expansion of a blood vessel and a skin moisture ratio via a GSR sensor, in connection with improving a level of fingerprint authentication. In connection with iris authentication, the electronic device may perform control associated with operating a camera during iris authentication, for example, may perform hand shaking correction when capturing an image. In connection with face authentication, the electronic device may include a method of recognizing a three-dimensional (3D) face, a method of recognizing a face using a moving image, and the like. In connection with motion authentication, the electronic device may set a specific operation, an operation order, directionality of an operation, and the like and may assign authentication if motion information is collected to suit an order or direction. Also, the electronic device may set conditions in which biometric persistent information is collected in connection with motion authentication to a precondition.

In connection with the complex authentication, the electronic device may use biometric data authentication in a complex manner. In connection with the biometric data authentication, the electronic device may collect at least one of user own heart waveform information collected via an ECG sensor, PPG sensor information, EMG sensor information, GSR sensor information, and BCG sensor information.

According to an embodiment, in an operation of being compared with stored biometric data, the electronic device may perform user authentication by comparing biometric recognition data (e.g., a recognition model) corresponding to the biometric data with data stored in a security region (e.g., a local memory, a memory of a remote server, or a memory area, such as a trust zone, in which security is set) previously registered by the user. For example, in connection with the user authentication, the electronic device may calculate a degree of conformity by comparing biometric data stored in a security region with features of received biometric recognition data. If the degree of conformity is greater than or equal to a specified level, the electronic device may complete user authentication or user identification. In connection with encrypting and storing an authenticated result, if user authentication succeeds, the electronic device may encrypt a corresponding authentication result value and may store the encrypted value in the security region.

According to various embodiments, the electronic device (e.g., the first electronic device) and a wearable device (e.g., the second electronic device) may communicate with each other through Bluetooth communication or cellular communication. When the first electronic device and the second electronic device connect with each other over a communication channel, they are paired with each other to establish authentication between the first electronic device and the second electronic device. The first electronic device or the second electronic device may transmit an authentication result value over the security channel. For example, the first electronic device may send an authentication result value of an upper level, in which complex authentication is performed, to the second electronic device. The first electronic device may encode and encrypt the authentication result value and may transmit the encrypted value. The second electronic device may decrypt and operate the encrypted authentication result value in the security region. The first electronic device may receive an authentication result value from the second electronic device, may store the received authentication result value in the security region, and may operate the authentication result value as a user recognition identification (ID) for obtaining biometric persistent information of the user.

The second electronic device (e.g., the wearable device) may obtain biometric persistent information of the user. In this regard, the second electronic device may collect persistent biometric information using at least one of an ECG sensor, a PPG sensor, an EMG sensor, a GSR sensor, and an ECG sensor or may obtain information of a collectible state.

According to various embodiments, if the user intentionally releases the wearing of the second electronic device (e.g., release a buckle), the second electronic device may determine that biometric persistent information of the user is not continuous and may request the first electronic device (or its authentication policy) to perform authentication of a relatively high level.

In connection with obtaining continuity in which the user wears the second electronic device, if the second electronic device is separated during a threshold time and is sensed again without adhering to his or her wrist, the second electronic device may determine that the wearing of the second electronic device is temporarily released. For example, if the second electronic device is worn loosely on the wrist, biometric persistent information of the user may be intermittently checked. According to an embodiment, the first electronic device or the second electronic device may ignore a discontinuous value of biometric persistent information checked during a short threshold time in a state where the buckle is worn or may process a continuous approximate value of the biometric persistent information for the discontinuous value through proportional interpolation or linear interpolation. According to various embodiments, if obtaining iris information a specified number of times while a pulse is obtained or if sequentially obtaining pulse information after obtaining iris information, the first electronic device or the second electronic device may regard that biometric persistent information of a security level corresponding to the iris information is sequentially obtained.

The first electronic device and the second electronic device may communicate with each other periodically or sequentially using at least one communication channel such as Bluetooth, cellular, and Wi-Fi direct. The first electronic device may perform initial authentication through continuous communication with the second electronic device and may then request second authentication of a relatively low level in connection with second authentication. Also, the first electronic device may operate a security level of a relatively high level by combining authentication of a relatively low level with a condition of collecting biometric persistent information of the second electronic device.

In connection with calculating a distance between the first electronic device and the second electronic device, the first electronic device may connect with the second electronic device and may measure a distance based on strength of a communication signal. According to various embodiments, the first electronic device may calculate a distance using an AP. If the first electronic device connects to a Wi-Fi device such as the second electronic device, the first electronic device may estimate a distance between the first electronic device and the second electronic device based on signal strength between the first electronic device and the AP and between the second electronic device and the AP. Also, the first electronic device or the second electronic device may recognize that one of the first electronic device or the second electronic device connects to the same AP to determine that the other of the first electronic device or the second electronic device is located in the same space.

According to various embodiments, the first electronic device (or the second electronic device) may classify a zone using a location sensor (e.g., a GPS) or an AP. For example, the first electronic device or the second electronic device may determine a GPS sensor, an AP, and the like and may obtain local information based on specific AP access information. Also, the first electronic device and the second electronic device may obtain information of a type (e.g., a private zone, an official zone, and a public zone) of a zone from AP information. If the first electronic device and the second electronic device are not located in the same zone, the first electronic device and the second electronic device may determine that they are spaced apart from each other by a specified distance or more. In the description above, the zone may be classified into two types of zones or three types of zones. However, the first electronic device or the second electronic device may operate a usage policy based on settings of more types of zones.

According to various embodiments, the first electronic device may change an authentication level based on a mutual distance between the first electronic device and the second electronic device. For example, if a distance from the second electronic device is less than or equal to a specified minimum distance, the first electronic device may determine that the user of the first electronic device has the second electronic device. In this case, the first electronic device may provide a user interface associated with second authentication of a relatively low level or may omit to output the user interface associated with the second authentication based on a situation. After initial user authentication is performed at a relatively high authentication level, if biometric persistent information is not changed as the specified second electronic device is worn, the first electronic device may determine that the user who has the second electronic device is not changed. In this case, the first electronic device may output a user interface corresponding to a relatively low second authentication level.

According to various embodiments, a mutual distance between the first electronic device and the second electronic device may be located within a specified middle distance range. In this case, the second electronic device is located within a proximity distance and is in an observable state, and the first electronic device may determines that the second electronic device is within a distance which is useable by another. Although biometric persistent information of the user is continuously collected via the second electronic device, the first electronic device may grant the user an authentication level of a relatively middle level. Also, the first electronic device may output a user interface associated with second authentication of a relatively high level in response to accessing private content in use or attempting to access a security region.

According to various embodiments, a mutual distance between the first electronic device and the second electronic device may be located within a specified maximum distance range. For example, if the first electronic device disconnects from the second electronic device because the first electronic device is distant from the second electronic device by a maximum distance or more or if strength of a signal is reduced to a specified level or less, the first electronic device may determine that there is a low probability that a worn user will use the second electronic device or may determine that there is a high probability that the second electronic device will be used by another. If the first electronic device is attempted to be used, the first electronic device may output a user interface corresponding to an authentication level of a specified maximum level. According to various embodiments, whenever another application is attempted to be used after authentication or whenever access to content, a memory area, or a security area defined as a relatively private region is attempted, the first electronic device may output a user interface corresponding to second authentication of a relatively high level.

According to various embodiments, if communication is disconnected, if communication is performed at received signal strength of a specified level or less and communication is resumed within a threshold time (e.g., a few seconds or a few minutes), or if strength of a signal is greater than or equal to a specified level, the first electronic device may output a user interface corresponding to a specified authentication level (e.g., an authentication level or a security level of a relatively low or middle degree) when second authentication is processed. For example, if the user puts the first electronic device in a specific location during a time and is back after a short absence, the first electronic device may estimate that there is a low probability that the user will be another, when second authentication is performed. If receiving biometric persistent information or a result value corresponding to the biometric persistent information after second authentication of a relatively middle level, the first electronic device may output a user interface corresponding to a relatively low authentication level. According to various embodiments, if sensing the second electronic device after a threshold time, the first electronic device may output a user interface corresponding to an authentication policy of an initial high level.

According to various embodiments, the first electronic device or the second electronic device may adjust a threshold distance for changing a zone-based authentication policy and may adjust an authentication level. For example, if a current zone is recognized as a home (e.g., a relatively private place), the first electronic device may set the threshold distance for changing the authentication policy to a specified length or more. Also, if determining that the first electronic device is located in a specified place (e.g., a relatively more private place such as a room of the user), the first electronic device may omit to output a user interface associated with second authentication or may apply an authentication policy corresponding to the easiest method (e.g., unlocking by a screen touch). Also, the first electronic device may output a user interface corresponding to an authentication level of a relatively middle degree in response to a use request of a specific person (e.g., a family member) based on a user relationship for an application which may be shared with family members (e.g., verification based on a phonebook or biometric persistent information). In this operation, the first electronic device (or the second electronic device) may omit to obtain biometric persistent information in connection with operating the first electronic device (or the second electronic device).

According to various embodiments, if there is no previous history, if unknown Wi-Fi is sensed, if Wi-Fi of a public place is sensed, or if determining that the first electronic device is located in a relatively open place (e.g., a public place such as a department store or a train station) based on a location of a GPS sensor, the first electronic device may set a threshold distance from the second electronic device for changing a level of an authentication policy to be relatively shorter.

According to various embodiments, if it is recognized that the first electronic device is located in a specified place, for example, within a vehicle, the first electronic device may collect voices and may change an authentication policy or a second authentication policy using an authentication scheme by replacing biometric persistent information other than collecting the biometric persistent information associated with the authentication policy or the second authentication policy. According to various embodiments, if it is determined that the first electronic device is located within a vehicle, the first electronic device may grant access only specified some applications (e.g., a navigation function).

The above-mentioned electronic device and method may provide a strengthened authentication scheme by using biometric authentication of the user and a variety of authentication in a complex manner and may keep security high without forcing the user to perform a complicated second authentication process several times using a wearable device.

According to various embodiments, an electronic device may include a memory configured to store a usage policy associated with the electronic device or a first user related to the electronic device with respect to at least one of resources of the electronic device, a communication module configured to communicate with an external electronic device, and a processor configured to connect with the memory and the communication module. The processor may be configured to receive user information about a second user corresponding to the external electronic device from the external electronic device and to change at least part of the usage policy based on at least part of the receiving of the user information.

According to various embodiments, the processor may be configured to collect first user information of the first user and second user information of the second user associated with the external electronic device, to identify a relationship between the first user and the second user based on the collected user information, and to adjust the usage policy based on at least part of the relationship.

According to various embodiments, the processor may be configured to determine the relationship based on at least part of a location the first user and the second user visit in common within a specified period of time, a web site the first user and the second user access in common within the specified period of time, or a product or service the first user and the second user purchase in common within the specified period of time.

According to various embodiments, the user information may include biometric related information corresponding to the second user. The processor may be configured to change the at least part of the usage policy to a first user policy or first information if the biometric related information meets a first specified condition and to change the at least part of the usage policy to a second user policy or second information if the biometric related information meets a second specified condition.

According to various embodiments, the biometric related information may include at least one biometric signal corresponding to the second user.

According to various embodiments, the processor may be configured to determine that the first specified condition is met if the number of the at least one biometric signal, a type of the at least one biometric signal, a measurement time, a measurement time interval, a measurement location, or a measurement frequency corresponds to a corresponding value among a first specified number, a first specified type, a first specified measurement time, a first measurement time interval, a first measurement location, or a first measurement frequency and to determine that the second specified condition is met if the number of the at least one biometric signal, the type of the at least one biometric signal, the measurement time, the measurement time interval, the measurement location, or the measurement frequency corresponds to a corresponding value among a second specified number, a second specified type, a second specified measurement time, a second measurement time interval, a second measurement location, or a second measurement frequency.

According to various embodiments, the biometric related information may include an authentication result indicating an authentication level for the second user, performed based on at least one biometric signal corresponding to the second user.

According to various embodiments, the processor may be configured to determine that the first specified condition is met if the authentication level is a first authentication level and to determine that the second specified condition is met if the authentication level is a second authentication level.

According to various embodiments, the usage policy may include a type of a security method corresponding to the electronic device, strength of the security method, the number of security methods, a right to use the resource (e.g., a right to use the electronic device based on an authentication policy or a second authentication policy among usage policies), and a right to execute functions executed by the electronic device (e.g., a content access right among usage policies). The processor may be configured to change the type of the security method, the strength of the security method, the number of the security methods, the right to use the resource, and the right to execute the functions executed by the electronic device and to perform the changing of the at least part of the usage policy.

According to various embodiments, the processor may be configured to obtain information of a distance between the electronic device and the external electronic device and to perform the changing further based on the distance.

According to various embodiments, the processor may be configured to obtain information of a change in distance between the electronic device and the external electronic device and to perform the changing further based on a lapse of a specified time after the distance is changed.

According to various embodiments, the processor may be configured to obtain information of occurrence of a specified event on the electronic device while a distance between the electronic device and the external electronic device departs from a specified range and to perform the changing further based on the occurrence of the event.

According to various embodiments, the processor may be configured to send notification information corresponding to the event to the external electronic device using the communication module.

According to various embodiments, the processor may be configured to obtain information of a first location corresponding to the electronic device or a second location corresponding to the external electronic device and to perform the changing further based on the first location or the second location.

According to various embodiments, the processor may be configured to obtain information of a relationship between the first user and the second user, a distance between the electronic device and the external electronic device, a first location corresponding to the electronic device, or a second location corresponding to the external electronic device and to perform the changing further based on the relationship, the distance, the first location, or the second location.

According to various embodiments, the processor may be configured to receive a usage right of the second user for the at least one resource from the external electronic device using the communication module and to change at least part of the usage policy further based on the usage right.

According to various embodiments, the processor may be configured to change the at least part of the usage policy to a first usage policy or first information if the usage right has a first level and to change the at least part of the usage policy to a second usage policy or second information if the usage right has a second level.

According to various embodiments, the electronic device may further include a display configured to display notification information indicating the changed usage policy.

According to various embodiments, an electronic device may include at least one sensor, a communication module, and a processor. The processor may be configured to obtain operation state information of the electronic device corresponding to a user of the electronic device and to determine a usage right (or a usage policy) associated with the electronic device or the user with respect to at least one of resources of an external electronic device.

According to various embodiments, the processor may be configured to send the usage right or the operation state information to the external electronic device using the communication module.

According to various embodiments, the electronic device may further include a memory configured to store the usage policy.

According to various embodiments, a method for adjusting a usage policy may include receiving user information about a first user corresponding to an external electronic device from the external electronic device using a communication module operatively connected with the electronic device and changing at least part of a usage policy associated with an electronic device or a second user corresponding to the electronic device with respect to at least one of resources of the electronic device, based on at least part of the receiving of the user information.

According to various embodiments, the changing of the at least part of the usage policy may include identifying a relationship between the first user and the second user based on at least part of the user information and changing at least part of the usage policy based on at least part of the relationship.

According to various embodiments, the user information may include biometric related information corresponding to the first user. The changing of the at least part of the usage policy may include changing the at least part of the usage policy to a first user policy or first information if the biometric related information meets a first specified condition and changing the at least part of the usage policy to a second user policy or second information if the biometric related information meets a second specified condition.

According to various embodiments, the biometric related information may include an authentication result indicating an authentication level for the first user, performed based on at least one biometric signal corresponding to the first user.

According to various embodiments, the changing of the at least part of the usage policy may include obtaining information of a relationship between the first user and the second user, a distance between the electronic device and the external electronic device, a first location corresponding to the electronic device, or a second location corresponding to the external electronic device and changing the at least part of the usage policy further based on the relationship, the distance, the first location, or the second location.

According to various embodiments, the changing of the at least part of the usage policy may include receiving a usage right of the first user for the at least one resource from the external electronic device using the communication module and changing the at least part of the usage policy further based on the usage right.

According to various embodiments, a method for adjusting a usage policy may include obtaining operation state information corresponding to a user corresponding to an electronic device and determining a usage right (or a usage policy) associated with the electronic device or the user with respect to at least one of resources of an external electronic device, based on at least part of the operation state information.

According to various embodiments, the determining of the usage right (or the usage policy) may include determining the usage right as a first usage right if the operation state information meets a first specified condition and determining the usage right as a second usage right if the operation state information meets a second specified condition

According to various embodiments, the determining of the usage right (or the usage policy) may include obtaining information of a relationship between the user and a user corresponding to the external electronic device, a distance between the electronic device and the external electronic device, a first location corresponding to the electronic device, or a second location corresponding to the external electronic device and determining the usage right further based on the relationship, the distance, the first location, or the second location.

According to various embodiments, a machine-readable storage device may store instructions for, when executed by a processor, causing the processor to receive user information about a first user corresponding to an external electronic device from the external electronic device using a communication module operatively connected with the storage device and to change at least part of a usage policy associated with the storage device or a second user corresponding to the storage device with respect to at least one of resources of the electronic device, based on at least part of the receiving of the user information.

According to various embodiments, a machine-readable storage device may store instructions for, when executed by a processor, causing the processor to obtain operation state information corresponding to a user corresponding to the storage device and to determine a usage right (or a usage policy) associated with the storage device or the user with respect to at least one of resources of an external electronic device, based on at least part of the operation state information.

According to various embodiments, the electronic device may provide high security or stable security by adaptively adjusting the usage policy to suit a situation and may allow the user to use the electronic device without inconvenience.

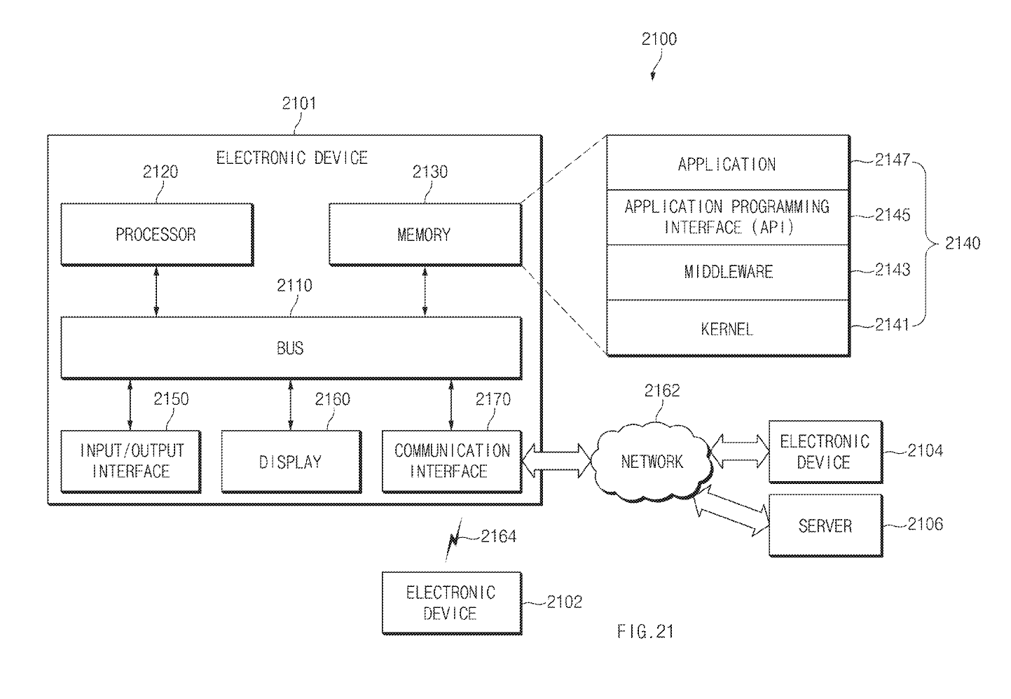

FIG. 21 is a block diagram illustrating a configuration of an electronic device in a network environment according to an embodiment.

Referring to FIG. 21, in various embodiments, an electronic device 2101 and a first external electronic device 2102, a second external electronic device 2104, or a server 2106 may connect with each other through a network 2162 or local-area communication 2164. The electronic device 2101 may include a bus 2110, a processor 2120, a memory 2130, an input and output interface 2150, a display 2160, and a communication interface 2170. In various embodiments, at least one of the components may be omitted from the electronic device 2101, or other components may be additionally included in the electronic device 2101.

The bus 2110 may be, for example, a circuit which connects components 2120 to 2170 with each other and transmits a communication signal (e.g., a control message and/or data) between the components.

The processor 2120 may include one or more of a central processing unit (CPU), an application processor (AP), or a communication processor (CP). For example, the processor 2120 may perform calculation or data processing about control and/or communication of at least another of the components of the electronic device 2101.

The memory 2130 may include a volatile and/or non-volatile memory. The memory 2130 may store, for example, a command or data associated with at least another of the components of the electronic device 2101. According to an embodiment, the memory 2130 may store software and/or a program 2140. The program 2140 may include, for example, a kernel 2141, a middleware 2143, an application programming interface (API) 2145, and/or an least one application program 2147 (or “at least one application”), and the like. At least part of the kernel 2141, the middleware 2143, or the API 2145 may be referred to as an operating system (OS).

The kernel 2141 may control or manage, for example, system resources (e.g., the bus 2110, the processor 2120, or the memory 2130, and the like) used to execute an operation or function implemented in the other programs (e.g., the middleware 2143, the API 2145, or the application program 2147). Also, as the middleware 2143, the API 2145, or the application program 2147 accesses a separate component of the electronic device 2101, the kernel 2141 may provide an interface which may control or manage system resources.

The middleware 2143 may play a role as, for example, a go-between such that the API 2145 or the application program 2147 communicates with the kernel 2141 to communicate data.

Also, the middleware 2143 may process one or more work requests, received from the application program 2147, in order of priority. For example, the middleware 2143 may assign priority which may use system resources (the bus 2110, the processor 2120, or the memory 2130, and the like) of the electronic device 2101 to at least one of the at least one application program 2147. For example, the middleware 2143 may perform scheduling or load balancing for the one or more work requests by processing the one or more work requests in order of the priority assigned to the at least one of the at least one application program 2147.

The API 2145 may be, for example, an interface in which the application program 2147 controls a function provided from the kernel 2141 or the middleware 2143. For example, the API 2145 may include at least one interface or function (e.g., a command) for file control, window control, image processing, or text control, and the like.

The input and output interface 2150 may play a role as, for example, an interface which may transmit a command or data input from a user or another external device to another component (or other components) of the electronic device 2101. Also, input and output interface 2150 may output an instruction or data received from another component (or other components) of the electronic device 2101 to the user or the other external device.

The display 2160 may include, for example, a liquid crystal display (LCD), a light emitting diode (LED) display, an organic LED (OLED) display, a microelectromechanical systems (MEMS) display, or an electronic paper display. The display 2160 may display, for example, a variety of content (e.g., text, images, videos, icons, or symbols, and the like) to the user. The display 2160 may include a touch screen, and may receive, for example, touch, gesture, proximity, or a hovering input using an electronic pen or part of a body of the user.

The communication interface 2170 may establish communication between, for example, the electronic device 2101 and an external device (e.g., a first external electronic device 2102, a second external electronic device 2104, or a server 2106). For example, the communication interface 2170 may connect to a network 2162 through wireless communication or wired communication and may communicate with the external device (e.g., the second external electronic device 2104 or the server 2106).

The wireless communication may use, for example, at least one of long term evolution (LTE), LTE-advanced (LTE-A), code division multiple access (CDMA), wideband CDMA (WCDMA), universal mobile telecommunications system (UMTS), wireless broadband (WiBro), or global system for mobile communications (GSM), and the like as a cellular communication protocol. Also, the wireless communication may include, for example, local-area communication 2164. The local-area communication 2164 may include, for example, at least one of wireless-fidelity (Wi-Fi) communication, Bluetooth (BT) communication, near field communication (NFC), or global navigation satellite system (GNSS) communication, and the like.

An MST module may generate a pulse based on transmission data using an electromagnetic signal and may generate a magnetic field signal based on the pulse. The electronic device 2101 may output the magnetic field signal to a point of sales (POS) system. The POS system may restore the data by detecting the magnetic field signal using an MST reader and converting the detected magnetic field signal into an electric signal.

The GNSS may include, for example, at least one of a global positioning system (GPS), a Glonass, a Beidou navigation satellite system (hereinafter referred to as “Beidou”), or a Galileo (i.e., the European global satellite-based navigation system) according to an available area or a bandwidth, and the like. Hereinafter, the “GPS” used herein may be interchangeably with the “GNSS”. The wired communication may include at least one of, for example, universal serial bus (USB) communication, high definition multimedia interface (HDMI) communication, recommended standard 232 (RS-232) communication, or plain old telephone service (POTS) communication, and the like. The network 2162 may include a telecommunications network, for example, at least one of a computer network (e.g., a local area network (LAN) or a wide area network (WAN)), the Internet, or a telephone network.

Each of the first and second external electronic devices 2102 and 2104 may be the same as or different device from the electronic device 2101. According to an embodiment, the server 2106 may include a group of one or more servers. According to various embodiments, all or some of operations executed in the electronic device 2101 may be executed in another electronic device or a plurality of electronic devices (e.g., the first external electronic device 2102, the second external electronic device 2104, or the server 2106). According to an embodiment, if the electronic device 2101 should perform any function or service automatically or according to a request, the electronic device 2101 may request another device (e.g., the first external electronic device 2102, the second external electronic device 2104, or the server 106) to perform at least part of the function or service, rather than executing the function or service for itself or in addition to the function or service. The other electronic device (e.g., the first external electronic device 2102, the second external electronic device 2104, or the server 2106) may execute the requested function or the added function and may transmit the executed result to the electronic device 2101. The electronic device 2101 may process the received result without change or additionally and may provide the requested function or service. For this purpose, for example, cloud computing technologies, distributed computing technologies, or client-server computing technologies may be used.

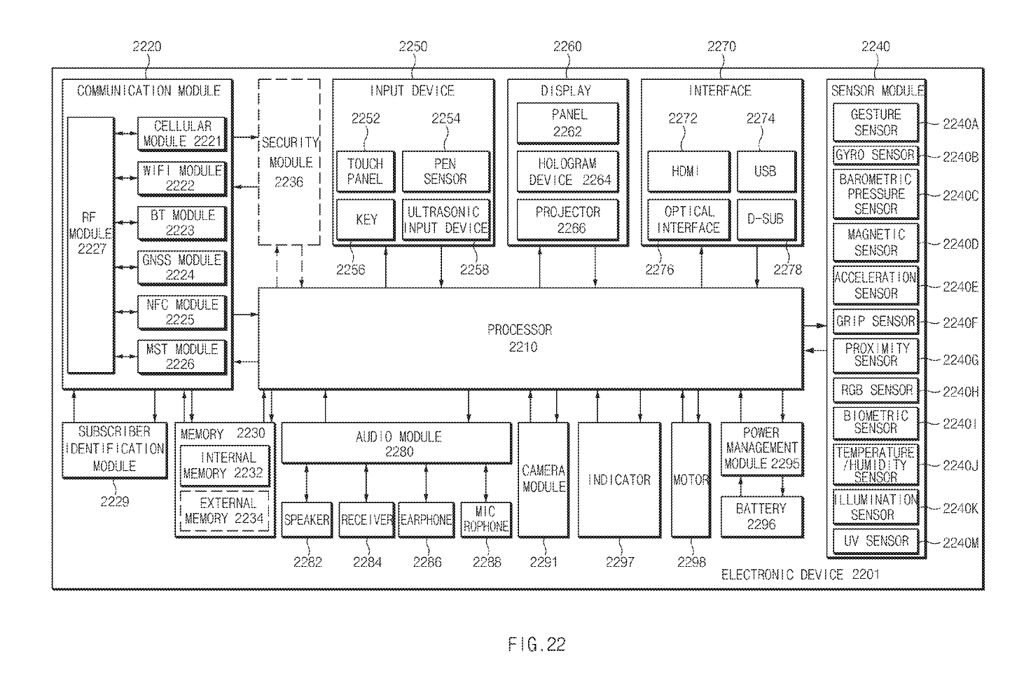

FIG. 22 is a block diagram illustrating a configuration of an electronic device according to various embodiments.

Referring to FIG. 22, the electronic device 2201 may include, for example, all or part of an electronic device 2101 shown in FIG. 21. The electronic device 2201 may include one or more processors 2210 (e.g., application processors (APs)), a communication module 2220, a subscriber identification module (SIM) 2229, a memory 2230, a security module 2236, a sensor module 2240, an input device 2250, a display 2260, an interface 2270, an audio module 2280, a camera module 2291, a power management module 2295, a battery 2296, an indicator 2297, and a motor 2298.

The processor 2210 may drive, for example, an operating system (OS) or an application program to control a plurality of hardware or software components connected thereto and may process and compute a variety of data. The processor 2210 may be implemented with, for example, a system on chip (SoC). According to an embodiment, the processor 2210 may include a graphic processing unit (GPU) (not shown) and/or an image signal processor (not shown). The processor 2210 may include at least some (e.g., a cellular module 2221) of the components shown in FIG. 22. The processor 2210 may load a command or data received from at least one of other components (e.g., a non-volatile memory) into a volatile memory to process the data and may store various data in a non-volatile memory.

The communication module 2220 may have the same or similar configuration to a communication interface 1370 of FIG. 21. The communication module 2220 may include, for example, the cellular module 2221, a wireless-fidelity (Wi-Fi) module 2222, a Bluetooth (BT) module 2223, a global navigation satellite system (GNSS) module 2224 (e.g., a GPS module, a Glonass module, a Beidou module, or a Galileo module), a near field communication (NFC) module 2225, an MST module 2226, and a radio frequency (RF) module 2227.

The cellular module 2221 may provide, for example, a voice call service, a video call service, a text message service, or an Internet service, and the like through a communication network. According to an embodiment, the cellular module 2221 may identify and authenticate the electronic device 2201 in a communication network using the SIM 2229 (e.g., a SIM card). According to an embodiment, the cellular module 2221 may perform at least part of functions which may be provided by the processor 2210. According to an embodiment, the cellular module 2221 may include a communication processor (CP).

The Wi-Fi module 2222, the BT module 2223, the GNSS module 2224, the NFC module 2225, or the MST module 2226 may include, for example, a processor for processing data transmitted and received through the corresponding module. According to various embodiments, at least some (e.g., two or more) of the cellular module 2221, the Wi-Fi module 2222, the BT module 2223, the GNSS module 2224, the NFC module 2225, or the MST module 2226 may be included in one integrated chip (IC) or one IC package.

The RF module 2227 may transmit and receive, for example, a communication signal (e.g., an RF signal). Though not shown, the RF module 2227 may include, for example, a transceiver, a power amplifier module (PAM), a frequency filter, or a low noise amplifier (LNA), or an antenna, and the like. According to another embodiment, at least one of the cellular module 2221, the Wi-Fi module 2222, the BT module 2223, the GNSS module 2224, the NFC module 2225, or the MST module 2226 may transmit and receive an RF signal through a separate RF module.

The SIM 2229 may include, for example, a card which includes a SIM and/or an embedded SIM. The SIM 2229 may include unique identification information (e.g., an integrated circuit card identifier (ICCID)) or subscriber information (e.g., an international mobile subscriber identity (IMSI)).

The memory 2230 (e.g., a memory 2130 of FIG. 21) may include, for example, an embedded memory 2232 or an external memory 2234. The embedded memory 2232 may include at least one of, for example, a volatile memory (e.g., a dynamic random access memory (DRAM), a static RAM (SRAM), a synchronous dynamic RAM (SDRAM), and the like), or a non-volatile memory (e.g., a one-time programmable read only memory (OTPROM), a programmable ROM (PROM), an erasable and programmable ROM (EPROM), an electrically erasable and programmable ROM (EEPROM), a mask ROM, a flash ROM, a flash memory (e.g., a NAND flash memory or a NOR flash memory, and the like), a hard drive, or a solid state drive (SSD)).

The external memory 2234 may include a flash drive, for example, a compact flash (CF), a secure digital (SD), a micro-SD, a mini-SD, an extreme digital (xD), a multimedia car (MMC), or a memory stick, and the like. The external memory 2234 may operatively and/or physically connect with the electronic device 2201 through various interfaces.

The secure module 2236 may be a module which has a relatively higher secure level than the memory 2230 and may be a circuit which stores secure data and guarantees a protected execution environment. The secure module 2236 may be implemented with a separate circuit and may include a separate processor. The secure module 2236 may include, for example, an embedded secure element (eSE) which is present in a removable smart chip or a removable SD card or is embedded in a fixed chip of the electronic device 2201. Also, the secure module 2236 may be driven by an OS different from the OS of the electronic device 2201. For example, the secure module 2236 may operate based on a java card open platform (JCOP) OS.

The sensor module 2240 may measure, for example, a physical quantity or may detect an operation state of the electronic device 2201, and may convert the measured or detected information to an electric signal. The sensor module 2240 may include at least one of, for example, a gesture sensor 2240A, a gyro sensor 2240B, a barometer sensor 2240C, a magnetic sensor 2240D, an acceleration sensor 2240E, a grip sensor 2240F, a proximity sensor 2240G, a color sensor 2240H (e.g., red, green, blue (RGB) sensor), a biometric sensor 2240I, a temperature/humidity sensor 2240J, an illumination sensor 2240K, or an ultraviolet (UV) sensor 2240M. Additionally or alternatively, the sensor module 2240 may further include, for example, an e-nose sensor (not shown), an electromyography (EMG) sensor (not shown), an electroencephalogram (EEG) sensor (not shown), an electrocardiogram (ECG) sensor (not shown), an infrared (IR) sensor (not shown), an iris sensor (not shown), and/or a fingerprint sensor (not shown), and the like. The sensor module 2240 may further include a control circuit for controlling at least one or more sensors included therein. According to various embodiments, the electronic device 2201 may further include a processor configured to control the sensor module 2240, as part of the processor 2210 or to be independent of the processor 2210. While the processor 2210 is in a sleep state, the electronic device 2201 may control the sensor module 2240.

The input device 2250 may include, for example, a touch panel 2252, a (digital) pen sensor 2254, a key 2256, or an ultrasonic input device 2258. The touch panel 2252 may use at least one of, for example, a capacitive type, a resistive type, an infrared type, or an ultrasonic type. Also, the touch panel 2252 may further include a control circuit. The touch panel 2252 may further include a tactile layer and may provide a tactile reaction to a user.

The (digital) pen sensor 2254 may be, for example, part of the touch panel 2252 or may include a separate sheet for recognition. The key 2256 may include, for example, a physical button, an optical key, or a keypad. The ultrasonic input device 2258 may allow the electronic device 2201 to detect a sound wave using a microphone (e.g., a microphone 2288) and to obtain data through an input tool generating an ultrasonic signal.

The display 2260 (e.g., a display 2160 of FIG. 21) may include a panel 2262, a hologram device 2264, or a projector 2266. The panel 2262 may include the same or similar configuration to the display 160 or 2160. The panel 2262 may be implemented to be, for example, flexible, transparent, or wearable. The panel 2262 and the touch panel 2252 may be integrated into one module. The hologram device 2264 may show a stereoscopic image in a space using interference of light. The projector 2266 may project light onto a screen to display an image. The screen may be positioned, for example, inside or outside the electronic device 2201. According to an embodiment, the display 2260 may further include a control circuit for controlling the panel 2262, the hologram device 2264, or the projector 2266.

The interface 2270 may include, for example, a high-definition multimedia interface (HDMI) 2272, a universal serial bus (USB) 2274, an optical interface 2276, or a D-subminiature 2278. The interface 2270 may be included in, for example, a communication interface 170 or 2170 shown in FIG. 2 or 21. Additionally or alternatively, the interface 2270 may include, for example, a mobile high definition link (MHL) interface, an SD card/multimedia card (MMC) interface, or an infrared data association (IrDA) standard interface.

The audio module 2280 may convert a sound and an electric signal in dual directions. At least part of components of the audio module 2280 may be included in, for example, an input and output interface 2150 (or a user interface) shown in FIG. 21. The audio module 2280 may process sound information input or output through, for example, a speaker 2282, a receiver 2284, an earphone 2286, or the microphone 2288, and the like.

The camera module 2291 may be a device which captures a still image and a moving image. According to an embodiment, the camera module 2291 may include one or more image sensors (not shown) (e.g., a front sensor or a rear sensor), a lens (not shown), an image signal processor (ISP) (not shown), or a flash (not shown) (e.g., an LED or a xenon lamp).

The power management module 2295 may manage, for example, power of the electronic device 2201. According to an embodiment, though not shown, the power management module 2295 may include a power management integrated circuit (PMIC), a charger IC or a battery or fuel gauge. The PMIC may have a wired charging method and/or a wireless charging method. The wireless charging method may include, for example, a magnetic resonance method, a magnetic induction method, or an electromagnetic method, and the like. An additional circuit for wireless charging, for example, a coil loop, a resonance circuit, or a rectifier, and the like may be further provided. The battery gauge may measure, for example, the remaining capacity of the battery 2296 and voltage, current, or temperature thereof while the battery 2296 is charged. The battery 2296 may include, for example, a rechargeable battery or a solar battery.

The indicator 2297 may display a specific state of the electronic device 2201 or part (e.g., the processor 2210) thereof, for example, a booting state, a message state, or a charging state, and the like. The motor 2298 may convert an electric signal into mechanical vibration and may generate vibration or a haptic effect, and the like. Though not shown, the electronic device 2201 may include a processing unit (e.g., a GPU) for supporting a mobile TV. The processing unit for supporting the mobile TV may process media data according to standards, for example, a digital multimedia broadcasting (DMB) standard, a digital video broadcasting (DVB) standard, or a mediaFlo™ standard, and the like.

Each of the above-mentioned elements of the electronic device according to various embodiments of the present disclosure may be configured with one or more components, and names of the corresponding elements may be changed according to the type of the electronic device. The electronic device according to various embodiments of the present disclosure may include at least one of the above-mentioned elements, some elements may be omitted from the electronic device, or other additional elements may be further included in the electronic device. Also, some of the elements of the electronic device according to various embodiments of the present disclosure may be combined with each other to form one entity, thereby making it possible to perform the functions of the corresponding elements in the same manner as before the combination.

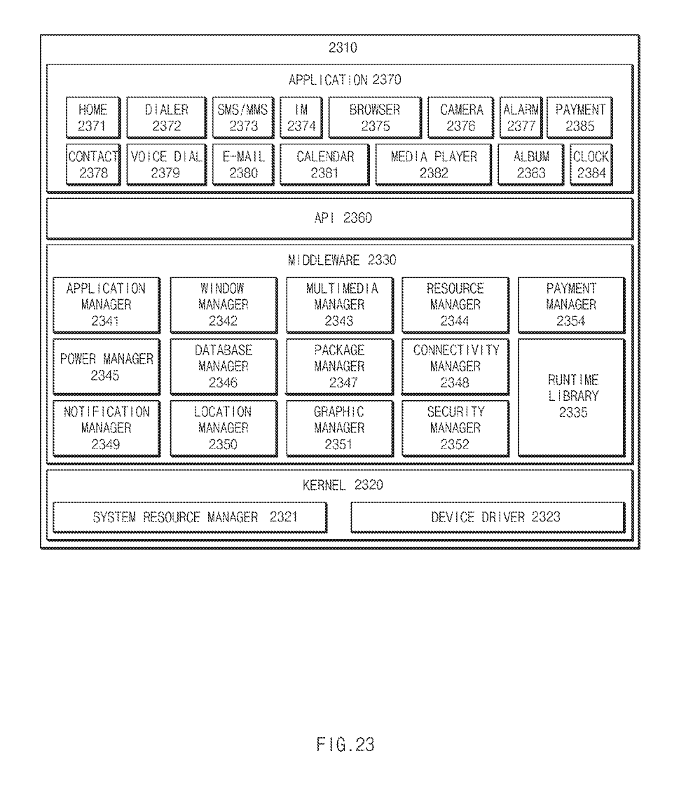

FIG. 23 is a block diagram illustrating a configuration of a program module according to various embodiments.

According to an embodiment, the program module 2310 (e.g., a program 2140 of FIG. 21) may include an operating system (OS) for controlling resources associated with an electronic device (e.g., an electronic device 2101 of FIG. 21) and/or various applications (e.g., an application program 2147 of FIG. 21) which are executed on the OS. The OS may be, for example, Android, iOS, Windows, Symbian, Tizen, or Bada, and the like.

The program module 2310 may include a kernel 2320, a middleware 2330, an application programming interface (API) 2360, and/or an application 2370. At least part of the program module 2310 may be preloaded on the electronic device, or may be downloaded from an external electronic device (e.g., a first external electronic device 2102, a second external electronic device 2104, or a server 2106, and the like of FIG. 21).

The kernel 2320 (e.g., a kernel 2141 of FIG. 21) may include, for example, a system resource manager 2321 and/or a device driver 2323. The system resource manager 2321 may control, assign, or collect, and the like system resources. According to an embodiment, the system resource manager 2321 may include a process management unit, a memory management unit, or a file system management unit, and the like. The device driver 2323 may include, for example, a display driver, a camera driver, a Bluetooth (BT) driver, a shared memory driver, a universal serial bus (USB) driver, a keypad driver, a wireless-fidelity (Wi-Fi) driver, an audio driver, or an inter-process communication (IPC) driver.

The middleware 2330 (e.g., a middleware 2143 of FIG. 21) may provide, for example, functions the application 2370 needs in common, and may provide various functions to the application 2370 through the API 2360 such that the application 2370 efficiently uses limited system resources in the electronic device. According to an embodiment, the middleware 2330 (e.g., the middleware 2143) may include at least one of a runtime library 2335, an application manager 2341, a window manager 2342, a multimedia manager 2343, a resource manager 2344, a power manager 2345, a database manager 2346, a package manager 2347, a connectivity manager 2348, a notification manager 2349, a location manager 2350, a graphic manager 2351, a security manager 2352, or a payment manager 2354.

The runtime library 2335 may include, for example, a library module used by a compiler to add a new function through a programming language while the application 2370 is executed. The runtime library 2335 may perform a function about input and output management, memory management, or an arithmetic function.

The application manager 2341 may manage, for example, a life cycle of at least one of the application 2370. The window manager 2342 may manage graphic user interface (GUI) resources used on a screen of the electronic device. The multimedia manager 2343 may determine a format utilized for reproducing various media files and may encode or decode a media file using a codec corresponding to the corresponding format. The resource manager 2344 may manage source codes of at least one of the application 2370, and may manage resources of a memory or a storage space, and the like.

The power manager 2345 may act together with, for example, a basic input/output system (BIOS) and the like, may manage a battery or a power source, and may provide power information utilized for an operation of the electronic device. The database manager 2346 may generate, search, or change a database to be used in at least one of the application 2370. The package manager 2347 may manage installation or update of an application distributed by a type of a package file.

The connectivity manager 2348 may manage, for example, wireless connection such as Wi-Fi connection or BT connection, and the like. The notification manager 2349 may display or notify events, such as an arrival message, an appointment, and proximity notification, by a method which is not disturbed to the user. The location manager 2350 may manage location information of the electronic device. The graphic manager 2351 may manage a graphic effect to be provided to the user or a user interface (UI) related to the graphic effect. The security manager 2352 may provide all security functions utilized for system security or user authentication, and the like. According to an embodiment, when the electronic device (e.g., an electronic device 100 or 2101 of FIG. 1 or 21) has a phone function, the middleware 2330 may further include a telephony manager (not shown) for managing a voice or video communication function of the electronic device.

The middleware 2330 may include a middleware module which configures combinations of various functions of the above-described components. The middleware 2330 may provide a module which specializes according to kinds of OSs to provide a differentiated function. Also, the middleware 2330 may dynamically delete some of old components or may add new components.

The API 2360 (e.g., an API 2145 of FIG. 21) may be, for example, a set of API programming functions, and may be provided with different components according to OSs. For example, in case of Android or iOS, one API set may be provided according to platforms. In case of Tizen, two or more API sets may be provided according to platforms.

The application 2370 (e.g., an application program 2147 of FIG. 21) may include one or more of, for example, a home application 2371, a dialer application 2372, a short message service/multimedia message service (SMS/MMS) application 2373, an instant message (IM) application 2374, a browser application 2375, a camera application 2376, an alarm application 2377, a contact application 2378, a voice dial application 2379, an e-mail application 2380, a calendar application 2381, a media player application 2382, an album application 2383, a clock application 2384, a health care application (e.g., an application for measuring quantity of exercise or blood sugar, and the like), or an environment information application (e.g., an application for providing atmospheric pressure information, humidity information, or temperature information, and the like), and the like.

According to an embodiment, the application 2370 may include an application (hereinafter, for better understanding and ease of description, referred to as “information exchange application”) for exchanging information between the electronic device (e.g., the electronic device 2101 of FIG. 21) and an external electronic device (e.g., the first external electronic device 2102 or the second external electronic device 2104). The information exchange application may include, for example, a notification relay application for transmitting specific information to the external electronic device or a device management application for managing the external electronic device.

For example, the notification relay application may include a function of transmitting notification information, which is generated by other applications (e.g., the SMS/MMS application, the e-mail application, the health care application, or the environment information application, and the like) of the electronic device, to the external electronic device (e.g., the first external electronic device 2102 or the second external electronic device 2104). Also, the notification relay application may receive, for example, notification information from the external electronic device, and may provide the received notification information to the user of the electronic device.

The device management application may manage (e.g., install, delete, or update), for example, at least one (e.g., a function of turning on/off the external electronic device itself (or partial components) or a function of adjusting brightness (or resolution) of a display) of functions of the external electronic device (e.g., the first external electronic device 2102 or the second external electronic device 2104) which communicates with the electronic device, an application which operates in the external electronic device, or a service (e.g., a call service or a message service) provided from the external electronic device.

According to an embodiment, the application 2370 may include an application (e.g., the health card application of a mobile medical device) which is preset according to attributes of the external electronic device (e.g., the first external electronic device 2102 or the second external electronic device 2104). According to an embodiment, the application 2370 may include an application received from the external electronic device (e.g., the server 2106, the first external electronic device 2102, or the second external electronic device 2104). According to an embodiment, the application 2370 may include a preloaded application or a third party application which may be downloaded from a server. Names of the components of the program module 2310 according to various embodiments of the present disclosure may differ according to kinds of OSs.

According to various embodiments, at least part of the program module 2310 may be implemented with software, firmware, hardware, or at least two or more combinations thereof. At least part of the program module 2310 may be implemented (e.g., executed) by, for example, a processor (e.g., a processor 2120 of FIG. 21). At least part of the program module 2310 may include, for example, a module, a program, a routine, sets of instructions, or a process, and the like for performing one or more functions.

The terminology “module” used herein may mean, for example, a unit including one of hardware, software, and firmware or two or more combinations thereof. The terminology “module” may be interchangeably used with, for example, terminologies “unit”, “logic”, “logical block”, “component”, or “circuit”, and the like. The “module” may be a minimum unit of an integrated component or a part thereof. The “module” may be a minimum unit performing one or more functions or a part thereof. The “module” may be mechanically or electronically implemented. For example, the “module” may include at least one of an application-specific integrated circuit (ASIC) chip, field-programmable gate arrays (FPGAs), or a programmable-logic device, which is well known or will be developed in the future, for performing certain operations.

According to various embodiments of the present disclosure, at least part of a device (e.g., modules or the functions) or a method (e.g., operations) may be implemented with, for example, instructions stored in computer-readable storage media which have a program module. When the instructions are executed by a processor, one or more processors may perform functions corresponding to the instructions. The computer-readable storage media may be, for example, a memory.

The computer-readable storage media may include a hard disc, a floppy disk, magnetic media (e.g., a magnetic tape), optical media (e.g., a compact disc read only memory (CD-ROM) and a digital versatile disc (DVD)), magneto-optical media (e.g., a floptical disk), a hardware device (e.g., a ROM, a random access memory (RAM), or a flash memory, and the like), and the like. Also, the program instructions may include not only mechanical codes compiled by a compiler but also high-level language codes which may be executed by a computer using an interpreter and the like. The above-mentioned hardware device may be configured to operate as one or more software modules to perform operations according to various embodiments of the present disclosure, and vice versa.

Modules or program modules according to various embodiments of the present disclosure may include at least one or more of the above-mentioned components, some of the above-mentioned components may be omitted, or other additional components may be further included. Operations executed by modules, program modules, or other components may be executed by a successive method, a parallel method, a repeated method, or a heuristic method. Also, some operations may be executed in a different order or may be omitted, and other operations may be added.

Embodiments of the present disclosure described and shown in the drawings are provided as examples to describe technical content and help understanding but do not limit the present disclosure. Accordingly, it should be interpreted that besides the embodiments listed herein, all modifications or modified forms derived based on the technical ideas of the present disclosure are included in the present disclosure as defined in the claims, and their equivalents.

The above-described embodiments of the present disclosure can be implemented in hardware, firmware or via the execution of software or computer code that can be stored in a recording medium such as a CD ROM, a Digital Versatile Disc (DVD), a magnetic tape, a RAM, a floppy disk, a hard disk, or a magneto-optical disk or computer code downloaded over a network originally stored on a remote recording medium or a non-transitory machine readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein.

The control unit may include a microprocessor or any suitable type of processing circuitry, such as one or more general-purpose processors (e.g., ARM-based processors), a Digital Signal Processor (DSP), a Programmable Logic Device (PLD), an Application-Specific Integrated Circuit (ASIC), a Field-Programmable Gate Array (FPGA), a Graphical Processing Unit (GPU), a video card controller, etc. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”. In addition, an artisan understands and appreciates that a “processor” or “microprocessor” may be hardware in the claimed disclosure. Under the broadest reasonable interpretation, the appended claims are statutory subject matter in compliance with 35 U.S.C. §101.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An electronic device, comprising:
a memory configured to store a usage policy with respect to at least one resource of the electronic device, the usage policy associated with at least one of the electronic device or a first user related to the electronic device;
a communication circuit configured to communicate with an external electronic device; and
a processor configured to:
receive user information about a second user corresponding to the external electronic device from the external electronic device using the communication circuit;
change at least part of the usage policy based on at least part of the received user information; and
adjust a use level of the electronic device or the first user with respect to the at least one resource based on the at least changed part of the usage policy.

2. The electronic device of claim 1, wherein the processor is configured to:
obtain information of a relationship between the first user and the second user based on at least part of the user information, and change the at least part of the usage policy based on at least part of the relationship; or
determine the relationship based on at least in part on a location the first user and the second user visit in common within a period of time, a web site the first user and the second user access in common within the period of time, or a product or service the first user and the second user purchase in common within the period of time.

3. The electronic device of claim 2, wherein:
the memory comprises other user information corresponding to the first user, and
wherein the processor is configured to obtain information of the relationship based on at least part of a result of comparing the user information with the other user information.

4. The electronic device of claim 1, wherein:
the user information comprises biometric related information corresponding to the second user,
the biometric related information comprises at least one of at least one biometric signal corresponding to the second user or an authentication result indicating an authentication level for the second user, the authentication result performed based on the at least one biometric signal corresponding to the second user, and
the processor is configured to:
change the at least part of the usage policy to a first user policy or first information, if the biometric related information meets a first condition;
change the at least part of the usage policy to a second user policy or second information, if the biometric related information meets a second condition;
determine that the first condition is met, if a number of the at least one biometric signal, a type of the at least one biometric signal, a measurement time, a measurement time interval, a measurement location, or a measurement frequency corresponds to a corresponding value among a first number, a first type, a first measurement time, a first measurement time interval, a first measurement location, or a first measurement frequency; and
determine that the second condition is met, if the number of the at least one biometric signal, the type of the at least one biometric signal, the measurement time, the measurement time interval, the measurement location, or the measurement frequency corresponds to a corresponding value among a second number, a second type, a second measurement time, a second measurement time interval, a second measurement location, or a second measurement frequency.

5. The electronic device of claim 4, wherein the processor is configured to:
determine that the first condition is met, if the authentication level is a first authentication level; and
determine that the second condition is met, if the authentication level is a second authentication level.

6. The electronic device of claim 1, wherein:
the usage policy comprises:
a type of a security method corresponding to the electronic device;
a strength of the security method;
a number of security methods;
a right to use the at least one resource; and
a right to execute functions executed by the electronic device, and
the processor is configured to:
change at least one of the type of the security method, the strength of the security method, the number of the security methods, the right to use the at least one resource, and the right to execute the functions executed by the electronic device.

7. The electronic device of claim 1, wherein the processor is configured to:
obtain information of a distance between the electronic device and the external electronic device;
change the at least part of the usage policy further based on the distance;
obtain information of a change in distance between the electronic device and the external electronic device; and
change the at least part of the usage policy further based on a lapse of a specified time after the distance is changed, and
wherein the processor is further configured to:
obtain information of occurrence of an event on the electronic device while a distance between the electronic device and the external electronic device departs from a range; or
change of the at least part of the usage policy further based on the occurrence of the event.

8. The electronic device of claim 7, wherein the processor is configured to send notification information corresponding to the event to the external electronic device using the communication circuit.

9. The electronic device of claim 1, wherein the processor is configured to:
obtain information of a first location corresponding to the electronic device or a second location corresponding to the external electronic device;
change the at least part of the usage policy further based on the first location or the second location;
obtain information of a relationship between the first user and the second user, a distance between the electronic device and the external electronic device, a first location corresponding to the electronic device, or a second location corresponding to the external electronic device; and
change of the at least part of the usage policy further based on the relationship, the distance, the first location, or the second location, and
wherein the processor is further configured to:
receive a usage right of the second user for the at least one resource from the external electronic device using the communication circuit; or
change at least part of the usage policy further based on the usage right.

10. The electronic device of claim 9, wherein the processor is configured to:
change the at least part of the usage policy to a first usage policy or first information, if the usage right has a first level; and
change the at least part of the usage policy to a second usage policy or second information, if the usage right has a second level.

11. The electronic device of claim 1, further comprising a display configured to display notification information indicating the changed usage policy.

12. An electronic device, comprising:
at least one sensor;
a communication circuit; and
a processor configured to:
obtain context information corresponding to a user corresponding to the electronic device using the at least one sensor; and
determine a usage right associated with the electronic device or the user with respect to at least one resource of an external electronic device based on at least part of the context information.

13. The electronic device of claim 12, wherein the processor is configured to:
determine the usage right as a first usage right, if the context information meets a first condition; and
determine the usage right as a second usage right, if the context information meets a second condition.

14. The electronic device of claim 13, wherein the context information comprises:
at least one biometric signal corresponding to the user; or
an authentication result indicating an authentication level for the user, the authentication result performed based on the biometric signal.

15. The electronic device of claim 14, wherein the processor is configured to:
determine that the first condition is met, if the authentication level is a first authentication level; and
determine that the second condition is met, if the authentication level is a second authentication level.

16. The electronic device of claim 12, wherein:
the usage policy comprises:
a type of a security method corresponding to the external electronic device;
a strength of the security method;
a number of security methods;
a right to access the at least one resource; and
a right to execute functions executed by the external electronic device, and
the processor is configured to:
change the type of the security method, the strength of the security method, the number of the security methods, the right to access the at least one resource, and the right to execute the functions executed by the external electronic device; and
determine of the usage policy.

17. The electronic device of claim 12, wherein the processor is configured to:
obtain information of a distance between the electronic device and the external electronic device, and determine of the usage right further based on the distance;
obtain information of location information corresponding to the electronic device, and adjust a method of performing an authentication, a type of performing an authentication, a number of performing an authentication, strength of performing an authentication, or a period of performing an authentication, based on at least part of the location information;
obtain information of a relationship between the user and a user corresponding to the external electronic device, a distance between the electronic device and the external electronic device, a first location corresponding to the electronic device, or a second location corresponding to the external electronic device, and determine of the usage right further based on the relation, the distance, the first location, or the second location; or
send the usage right or the context information to the external electronic device using the communication circuit.

18. The electronic device of claim 12, further comprising a memory configured to store the usage right.

19. A machine-readable storage device having instructions stored thereon, the instructions, when executed by a processor, cause the processor to:
receive user information about a first user corresponding to an external electronic device from the external electronic device using a communication circuit operatively connected with the storage device;
change at least part of a usage policy with respect to at least one resource of the storage device based on at least part of the received user information, the usage policy associated with at least one of the storage device or a second user corresponding to the storage device; and
adjust a use level of the storage device or the second user with respect to the at least one resource based on the at least changed part of the usage policy.
